(19) United States
(12) Patent Application Publication
(10) Pub. No.: US 2014/0030608 A1
(43) Pub. Date: Jan. 30, 2014

(54) HIGH TEMPERATURE MELT INTEGRITY SEPARATOR

(71) Applicant: SABIC Innovative Plastics IP B.V., Bergen op Zoom (NL)

(72) Inventors: Roy Martinus Adrianus l'Abee, Veldhoven (NL); Anne Helene Gelebart, Treouelan in Ploudalmezeau (FR); Soma Guhathakurta, West Bengal (IN); Huiqing Wu, Shanghai (CN); Jie Gao, Shanghai (CN); Qunjian Huang, Shanghai (CN)

(73) Assignee: SABIC Innovative Plastics IP B.V., Bergen op Zoom (NL)

(21) Appl. No.: 13/953,039

(22) Filed: Jul. 29, 2013

Related U.S. Application Data
(60) Provisional application No. 61/677,373, filed on Jul. 30, 2012.
(60) Provisional application No. 61/738,800, filed on Dec. 18, 2012.
(60) Provisional application No. 61/738,805, filed on Dec. 18, 2012.

(51) Int. Cl. H01G 9/02; H01M 2/16

(52) U.S. Cl. CPC H01G 9/02; H01M 2/1653
USPC 429/326; 429/254; 361/504; 264/41; 264/167

(57) ABSTRACT

A heat-resistant material based on an amorphous thermoplastic polymer that is resistant to, but highly compatible with electrolyte solutions is disclosed. In an aspect, the heat-resistant material is used to form a separator for a battery cell and/or an electrolytic capacitor cell.

### CROSS REFERENCE TO RELATED PATENT APPLICATION

This application claims priority to U.S. Patent Application No. 61/677,373 filed Jul. 30, 2012, U.S. Patent Application No. 61/738,800 filed Dec. 18, 2012, and U.S. Patent Application No. 61/738,805 filed Dec. 18, 2012, each of which are hereby incorporated herein by reference in its entirety.

### BACKGROUND

Battery cells and electrolytic capacitor cells typically include a positive and negative electrode (cathode and anode) and an electrolyte solution. The electrodes are separated by a thin, porous film known as a separator. Separators play a key role in batteries/capacitors. One function of the separator is to keep the two electrodes physically apart from each other to prevent electrical short circuits and the separator should, therefore, be electrically insulating. At the same time, the separator should allow rapid transport of charge carriers that are needed to complete the circuit during cell charging and discharging. Accordingly, battery separators should have the capability of conducting ions by either being an intrinsic ionic conductor (such as solid electrolytes) or by soaking with an ion-conducting liquid electrolyte.

High temperature melt integrity (HTMI) of battery separators is a key property to ensure safety of the individual cell, as well as the full battery pack. In case of internal heat build-up due to overcharging or internal short-circuiting, or any other event that leads to an increase of the internal cell temperature, high temperature melt integrity can provide an extra margin of safety, as the separator will maintain its integrity (shape and mechanical) and thereby prevents the electrodes from contacting one another at high temperatures.

Typical separators for lithium-ion batteries are based on polymers and, more specifically, on polyethylene (PE) and polypropylene (PP), which are produced via melt processing techniques. These types of separators typically have poor melt integrity at high temperatures (<160° C.) and have low wettability with the electrolyte solutions. Therefore, a need exists for alternative separators with improved HTMI and electrolyte wettability that can be produced via a melt or solution process.

Porosity of lithium-ion battery, polymeric separator films is typically induced by (uniaxial) stretching of extruded films, which process is known as the “dry process” and is based on a complex interplay between extrusion, annealing, and stretching of the film (see e.g. U.S. Pat. Nos. 3,558,764 and 5,385,777). The dry process typically leads to an open pore structure and a relatively uniform pore size. However, inherent to the stretching process, the dry process leads to non-spherical pores and to residual stresses in the material. The latter typically leads to deformation (shrinkage) of the films in time, especially at elevated temperatures. Since crystallization/crystallinity is required during the stretching process in order to develop a porous structure, the preparation of porous films by the dry process is limited to semi-crystalline polymers only. Although this process allows for a reasonably high porosity (30-50%), the actual accessible porosity (as measured e.g. by air permeability) is often significantly lower, since not all pores are interconnected with each other.

Alternatively, porosity can be induced by pre-mixing the polymer with a low molecular weight extractable, which forms a specific structure upon cooling from the melt and, after removal of the low molecular weight species, leaves a porous structure (see e.g. U.S. Pat. No. 7,618,743 and JP Pat. No. 1988273651, 1996064194 and 1997259858). This process is known as the “wet process”, and typically uses a polymer/extractable combination that is miscible during the extrusion process, but phase separates upon cooling. The extractable is typically a low molecular weight species such as a hydrocarbon liquid, for example a paraffin oil. Removal of the low molecular weight species can be achieved by evaporation or extraction. Extraction is typically achieved by using an organic, volatile solvent, such as methylene chloride. An additional stretching (uniaxial or biaxial) step is typically used to create the desired pore structure. The wet process typically leads to a highly tortuous, interconnected porous structure. The preparation of porous films by the wet process is typically limited to polymers with a relatively high melt strength (e.g. ultra-high molecular weight polyethylene). The actual accessible porosity (as measured e.g. by air permeability) is often significantly lower than the total porosity, since not all pores are interconnected with each other, similar to the dry process.

High porosity in separator films is beneficial for the charging and discharging characteristics of batteries, since the volume resistivity of the cell typically scales inversely with the accessible separator porosity. Additionally, separator pore sizes need to be smaller than the particle size of the anode and cathode active material (typically 2-3 micrometer). Also, the pore size distribution should be narrow and the pores uniformly distributed. Preferably, all pores would in some way be connected from the front to the backside of the film or, in other words, the actual accessible porosity should equal the total porosity. This means that all pores are accessible for the electrolyte solution and contribute to ion transport through the separator. In the case of Li-ion batteries, high tortuosity and an interconnected pore structure is beneficial for long life batteries, since it suppresses the growth of lithium crystals on the graphite anode during fast charging or low temperature charging. On the other hand, an open (low tortuosity) and uniform pore size structure is beneficial for applications where fast charging and discharging is required, e.g. high power density batteries.

Separator films in non-aqueous batteries are mostly based on polymers and, more specifically, on polyethylene (PE) and polypropylene (PP). Both PE and PP are used because of their known solvent resistance towards the electrolyte solution, which enables long-term performance of the separator in the battery cell. A distinct disadvantage of these types of separators is their low High Temperature Melt Integrity (HTMI) and poor interaction with the electrolyte solution (i.e. wettability and electrolyte retention).

Efforts have been enacted to develop separator films with improved HTMI performance (>180° C.). Two technical approaches are typically used to achieve HTMI >180° C. The first one uses a ceramic coating or filler to reinforce the porous polymer matrix. Examples include:
The Mitsubishi Chemical Company prepared hybrid separators based on alumina (Al₂O₃) and PVdF binders [See Technologies and Market Forecast of Separators for Rechargeable Lithium Ion Batteries, September 2010, Solar&Energy Co., Ltd.]
Degussa developed a hybrid separator that consists of bonded ceramic particles onto a polyester nonwoven. [See S. Zhang, A review on the separators of liquid electrolyte Li-ion batteries, J Power Sources (2007) 164:351-364]
LG Chemical has developed so-called “SRS” (Safety-reinforcing separators) by using polyolefin separators that are coated with a ceramic layer. Because of the ceramic layer, the thermal stability and the mechanical strength of the separator improve. [See X. Huang, Separator technologies for lithium-ion batteries, J Solid State Electrochem (2011) 15:649-662, US Patent App. No. 20100255382]
Sony Corp [US Patent App. No. 20090092900] and Panasonic [US Patent App. Nos. 20100151325, 20080070107] developed polymeric separators coated with a heat-resistant inorganic layer.
Samsung [US Patent App. No. 20090155677] has developed polymeric separators filled with inorganic particles.
GM [US Patent App. No. 20110200863] has developed an oxygen plasma process to coat porous polymer membranes with electrically resistive ceramic materials.
Teijin [WO Patent App. No. 2008062727] has developed a microporous polyethylene film with a heat-resistant porous layer consisting of fine inorganic particles.
Asahi [WO Patent App. No. 2008093575] has developed a multilayer porous membrane which comprises a polyolefin resin porous membrane, an inorganic filler and a resin binder.

Applying a ceramic layer to the polymeric membrane typically deteriorates mechanical properties (e.g. tensile strength and flexibility), which is a concern for the integrity of the separator during the cell manufacturing process, as well as for safety during the actual application of the cell. Additionally, applying a ceramic layer to a polymeric separator is undesirable as it includes a secondary processing step. A very stringent control of this secondary process is required, as events like coating/matrix debonding and/or particle shedding needs to be prevented, leading to significant additional cost. Additionally, the applied inorganic coating needs to be porous to allow ionic transport through the separator during cell charging and discharging.

Another approach to improve separator HTMI is to replace the polyethylene or polypropylene polymer matrix by heat resistant polymers. Examples of such high heat resistant polymers include poly(4-methyl pentene) (PMP) [EP Patent No. 2308924, US Patent App. No. 20060073389] and cross-linked polymers [U.S. Pat. No. 4,522,902]. Disadvantages of these approaches are the poor wettability with the electrolyte and difficult processing, respectively. US20130125358A1, CN102251307A, US20110143217A1 and US20110143207A1 describe the use of fully aromatic polyimides for battery separator applications, yet processing of fully aromatic polyimides into porous films is difficult, as fully aromatic polyimides are thermosets and are, therefore, typically not melt processable. The application of melt and solution processable, thermoplastic polyetherimides (PEI) for battery separator applications in various structural forms has been described in e.g. CA2468218A1, DE102010024479A1, U.S. Pat. No. 7,892,672B2, U.S. Pat. No. 7,214,444B2, U.S. Pat. No. 7,087,343B2 and US20110171514A1, US20110165459A1, US20120308872A1, US20120309860A1, US20120156569, US8470898B2, JP2005209570A, JP2009231281A, JP2009231281A. However, polyetherimides typically do not have the solvent resistance required for application in battery environments, leading to significant dissolution and/or swelling of the separator, which causes the separator to (partially) loose its capability to physically separate the electrodes while allowing for ionic transport through the pores. Polyetherimides with improved solvent resistance are known, e.g. polyetherimides comprising structural units derived from para-phenylene diamine. However, these types of solvent resistant polyetherimides are typically considered not to be solution processable. To the best of our knowledge, solvent resistant polyetherimides comprising structural units derived from para-phenylene diamine have, therefore, never been applied as battery separators.

There remains, therefore, a need for polymeric separator films with a melt integrity exceeding 180° C. that have an intrinsically good compatibility with, yet are resistant to non-aqueous electrolyte solutions, where the separator is based on a thermoplastic polymer and can be produced by a single-step process such as a melt or solution approach.

For the application of lithium-ion batteries, the separator should meet a series of characteristics, such as ion conductivity and elastic modulus, which are especially driven by the micro-porous morphology. Conventional PP and PE separators are prepared by so-called dry or wet processes, which both rely on stretching, crystallization and annealing of the polymers to generate the desired pore structure. Since polyetherimides are typically amorphous resins, these two conventional approaches are not suitable to produce polyetherimide-based separators. Therefore, there exists a need for a separator preparation process suitable for polyetherimides based on para-phenylene diamines, where the process allows the preparation of porous structures meeting the requirements of battery separators.

### SUMMARY

Disclosed are materials that provide high temperature melt integrity and improved electrolyte wettability for environments such as a battery or electrolytic capacitor cell. As an example, separators for battery cells and/or capacitor cells can be formed from the disclosed materials. As a further example, other structures and systems can implement the disclosed materials.

In an aspect, separator films can be formed from thermoplastics such as amorphous thermoplastics (e.g., polyetherimides (PEI)). As an example, separator films formed from polyetherimides (PEI) based on para-phenylene diamines (SABIC's ULTEM™ CRS 5000 series) provide a combination of outstanding performance characteristics, such as high compatibility with electrolyte, high solvent resistance and a high melt integrity temperature exceeding 180° C. Polyetherimides (PEI) based on para-phenylene diamines fulfill the critical requirement of being resistant to the electrolyte solutions, even at elevated temperatures of 55° C. Additionally, polyetherimides show an extremely low contact angle (e.g., <30°) to the electrolyte solution, which favors separator wettability and electrolyte retention, allowing for a reduced electrolyte filling time during cell production. Surprisingly, separators produced out of polyetherimides based on para-phenylene diamines lead to a significant improvement of the operating cell performance, such as cycle life of the battery. Separators from PEI based on para-phenylene diamines have very high melt integrity (exceeding 180° C.) and have a high elastic modulus (stiffness) over the whole range of cell operation (i.e. no physical polymer transitions occur in the cell operation temperature window, such as a glass transition or crystal melting). The proposed materials can both be melt and solution processed into porous films with specific ionic conductivities that are equal to or superior than typical commercial polyolefin-based separators.

In an aspect, a system can comprise an anode, a cathode, and a separator disposed between the anode and the cathode, the separator formed from a thermoplastic polymer having a glass transition temperature equal to or higher than 180° C.

In an aspect, a system can comprise an anode, a cathode, a separator disposed between the anode and the cathode, the separator formed from an amorphous thermoplastic polymer, and an electrolyte disposed adjacent (e.g., in close proximity, integrated, to wet, to soak, immersing, etc.) the separator, wherein the amorphous thermoplastic polymer has an electrolyte (1:1:1 ratio of DMC:EMC:EC with 1 mol/L LiPF₆) contact angle equal to or lower than 30°.

In an aspect, a method can comprise forming a separator from a thermoplastic polymer using either a melt process or a solution process, disposing the separator between an anode and a cathode, and disposing an electrolyte adjacent the separator.

In an aspect, separators can be made from a resin, so transforming the material into a porous membrane. As an example, the separator can be formed by stretching of extruded films or washing out solutes in an extruded film. Other methods can be used to form the separator.

In an aspect, a method for preparing a solvent resistant polymeric membrane can comprise providing a pourable, polymer solution comprising a chemical resistant polymer in a solvent and forming a membrane from the polymer solution.

A method for preparing a porous film can comprise providing a pourable, polymer solution comprising a chemical resistant polymer in a solvent and forming a porous film from the polymer solution.

In an aspect, a phase separation process based on SABIC's ULTEM™ CRS 5000 resins can be used to produce lithium ion battery separators. The phase separation can be induced by exposing the polymer solution to a non-solvent in either the liquid state (liquid-induced phase separation, LIPS) or the vapor state (vapor-induced phase separation, VIPS). Key factors including composition of dope (polymer) solution, coagulation bath and temperature were studied to achieve the desired morphology and properties. It is demonstrated that both LIPS and VIPS are suitable to prepare ULTEM™ CRS 5000 porous separator films with tunable pore structures, which are very suitable for battery separator applications. Separators were prepared that meet the typical separator requirements on porosity, pore size, thickness, conductivity and Young's modulus. The process is versatile in terms of the obtained porosity, pore size and thickness and, therefore, in the final performance of the separator in an actual electrochemical cell environment. The separators show an unexpected, significant improvement in cycle life of the battery as compared to commercially available polyolefin-based separators. To our best knowledge, this is the first example where ULTEM™ CRS 5000 separators were prepared via a LIPS or VIPS process, and where the formed separators were successfully applied into a lithium-ion battery.

Phase separation of a polymer in solution is a well-known process to prepare micro-porous membranes, e.g. for filtration applications, typically in the form of a hollow fiber. In an aspect, the phase separation can be induced by various means, including temperature, a chemical reaction, a liquid non-solvent and a vapor non-solvent. For example, U.S. Pat. No. 5,181,940 describes the use of such a phase separation approach to make asymmetric, hollow fiber membranes for gas separation applications. Typically, the use of such a phase separation approach leads to a thin, dense skin layer at the outside surface of the membrane. Such a dense skin layer is typically required for e.g. gas separation applications, but is highly undesired for battery separator applications, as such as dense skin layer will prevent ion transport through the membrane, thereby making the membrane unsuitable for battery separator applications. Various approaches have been described to make porous membranes out of solvent-resistant polymers like poly(ether ether ketone) (PEEK), polyether imide (PEI) and polyphenylene sulphide (PPS), e.g. in German Pat. No. 3,321,860, EU Pat. No. 182506, U.S. Pat. Nos. 4,755,540, 4,957,817, 4,992,485, 5,227,101, 6,017,455 and 5,997,741. These methods typically use either acidic solvents and/or high temperature processes. Alternatively, U.S. Pat. Nos. 3,925,211 and 4,071,590 describe the preparation of membranes via the formation of a soluble film pre-polymer that is converted into the final, porous membrane via a chemical reaction. It would be more advantageous to make porous films out of a polymer solution directly, without the need for elevated temperatures, acidic solvents or chemical reactions. A liquid-induced phase separation (LIPS) process to produce flat-sheet membranes based on solvent-resistant PEI, PI, PEEK and PPS has been reported previously (See U.S. Pat. Appl. Nos. 2007/0056901 and 2007/0060688; and U.S. Pat. No. 7,439,291), where the polymer is at least partially crystalline. Because these polymer classes are generally known as being solvent resistant, a co-solvent system is reported in order to dissolve the solvent-resistant polymer at elevated temperature and to keep it in solution at room temperature. The described solvent systems are based on p-chloro-2-methyl-phenol combined with (para-, meta-, ortho- and chloro-)cresols. However, the claimed process, and more specifically the described solvent/anti-solvent combinations, enable the production of porous structures, but do not typically lead to membranes suitable for battery separator applications. We have found that by using the LIPS or VIPS process based on solvent-resistant, amorphous polyetherimide grades and optimized solvent systems, the morphology of the separator (such as thickness, porosity, mechanical properties and the porous structure) can be controlled, leading to porous films suitable for the application as battery separators with excellent high temperature melt integrity, electrolyte wettability and battery cell performance. Additionally, we have found a method to dissolve solvent-resistant polyetherimides in solvents with reduced toxicity (e.g., lower Health Rating on the National Fire Protection Association (NFPA) fire diamond according to the Centers for Disease Control and Prevention—http://www.cdc.gov).

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a schematic diagram of an exemplary battery cell;

FIG. 2 shows a representative morphology (cross-section) of the solvent casted ULTEM™ CRS 5001 separator;

FIG. 3 is a graph illustrating the discharge capacity retention of a plurality of separators.

FIG. 4 is a representation of a morphology obtained when preparing a porous film according to Example 1;

FIG. 5 is a representation of a morphology obtained when preparing a porous film according to Example 2;

FIG. 6 is a representation of a morphology obtained when preparing a porous film according to Example 3;

FIG. 7 is a representation of a morphology obtained when preparing a porous film according to Example 4;

FIG. 8 is a representation of a morphology obtained when preparing a porous film according to Example 5;

FIG. 9 is a representation of a morphology obtained when preparing a porous film according to Example 6;

FIG. 10 is a representation of a morphology obtained when preparing a porous film according to Example 7;

FIG. 11 is a representation of a morphology obtained when preparing a porous film according to Example 8;

FIG. 12 is a representation of a morphology obtained when preparing a porous film according to Example 9;

FIG. 13 is a representation of a morphology obtained when preparing a porous film according to Example 10;

FIG. 14 is a representation of a morphology obtained when preparing a porous film according to Example 11;

FIG. 15 is a representation of a morphology obtained when preparing a porous film according to Example 12;

FIG. 16 is a representation of a morphology obtained when preparing a porous film according to Example 13;

FIG. 17 is a representation of a morphology obtained when preparing a porous film according to Example 14;

FIG. 18 is a representation of a morphology obtained when preparing a porous film according to Example 16;

FIG. 19 is a representation of a morphology obtained when preparing a porous film according to Example 17;

FIG. 20 is a representation of a morphology obtained when preparing a porous film according to Example 18;

FIG. 21 is a representation of a morphology obtained when preparing a porous film according to Example 19;

FIG. 22 is a representation of a morphology obtained when preparing a porous film according to Example 20;

FIG. 23 is a representation of a morphology obtained when preparing a porous film according to Example 21;

FIG. 24 is a representation of a morphology obtained when preparing a porous film according to Example 22;

FIG. 25 is a representation of a morphology obtained when preparing a porous film according to Example 23;

FIG. 26 is a representation of a morphology obtained when preparing a porous film according to Example 4;

FIG. 27 is a representation of a morphology obtained when preparing a porous film according to Example 5;

FIG. 28 is a representation of a morphology obtained when preparing a porous film according to Example 7;

FIG. 29 is a representation of a morphology obtained when preparing a porous film according to Example 11;

FIG. 30 is a representation of a morphology obtained when preparing a porous film according to Example 16;

FIG. 31 is a representation of a morphology obtained when preparing a porous film according to Example 17;

FIG. 32 is a representation of a morphology obtained when preparing a porous film according to Example 18;

FIG. 33 is a representation of a morphology obtained when preparing a porous film according to Example 19;

FIG. 34 is a representation of a morphology obtained when preparing a porous film according to Example 20;

FIG. 35 is a representation of a morphology obtained when preparing a porous film according to Example 21;

FIG. 36 is a representation of a morphology obtained when preparing a porous film according to Example 22;

FIG. 37 is a representation of a morphology obtained when preparing a porous film according to Example 23;

FIG. 38 is a graph representing apparent porosity of select samples;

FIG. 39 is a graph representing conductivity of select samples;

FIG. 40 is a graph representing stress at 2% offset of select samples;

FIG. 41 is a graph representing temperature melt integrity of select samples;

FIG. 42 is a graph representing the discharge capacity retention of Example 20 as compared to a commercial separator (Celgard® 2320)

FIG. 43 is a representation of a morphology obtained when preparing a porous film according to Example 24;

FIG. 44 is a representation of a morphology obtained when preparing a porous film according to Example 25;

FIG. 45 is a representation of a morphology obtained when preparing a porous film according to Example 26;

FIG. 46 is a graph illustrating dissolution temperature of ULTEM™ CRS 5001K and ULTEM™ CRS 5011K in NMP as function of concentration;

FIG. 47 is a graph illustrating “steady-state” phase separation temperature;

FIG. 48A is a representation of an example morphology obtained when casting according to Example 30;

FIG. 48B is a magnified representation of an example morphology obtained when casting according to Example 30;

FIG. 49A is a representation of an example morphology obtained when casting according to Example 31;

FIG. 49B is a magnified representation of an example morphology obtained when casting according to Example 31;

FIG. 50A is a representation of an example morphology obtained when casting according to Example 32;

FIG. 50B is a magnified representation of an example morphology obtained when casting according to Example 32;

FIG. 51A is a representation of an example morphology obtained when casting according to Example 33;

FIG. 51B is a magnified representation of an example morphology obtained when casting according to Example 33;

FIG. 52A is a bottom side representation of an example morphology obtained when casting according to Example 34;

FIG. 52B is a cross-sectional representation of an example morphology obtained when casting according to Example 34;

FIG. 53A is a bottom side representation of an example morphology obtained when casting according to Example 35;

FIG. 53B is a cross-sectional representation of an example morphology obtained when casting according to Example 35.

FIG. 54 is a cross-sectional representation of an example morphology obtained when casting according to Example 36;

FIG. 55 is a cross-sectional representation of an example morphology obtained when casting according to Example 37;

FIG. 56 is a representation of an example morphology obtained according to Example 38;

FIG. 57 is a representation of an example morphology obtained according to Example 39;

FIG. 58 is a representation of an example morphology obtained according to Example 40;

FIG. 59 is a representation of an example morphology obtained according to Example 41;

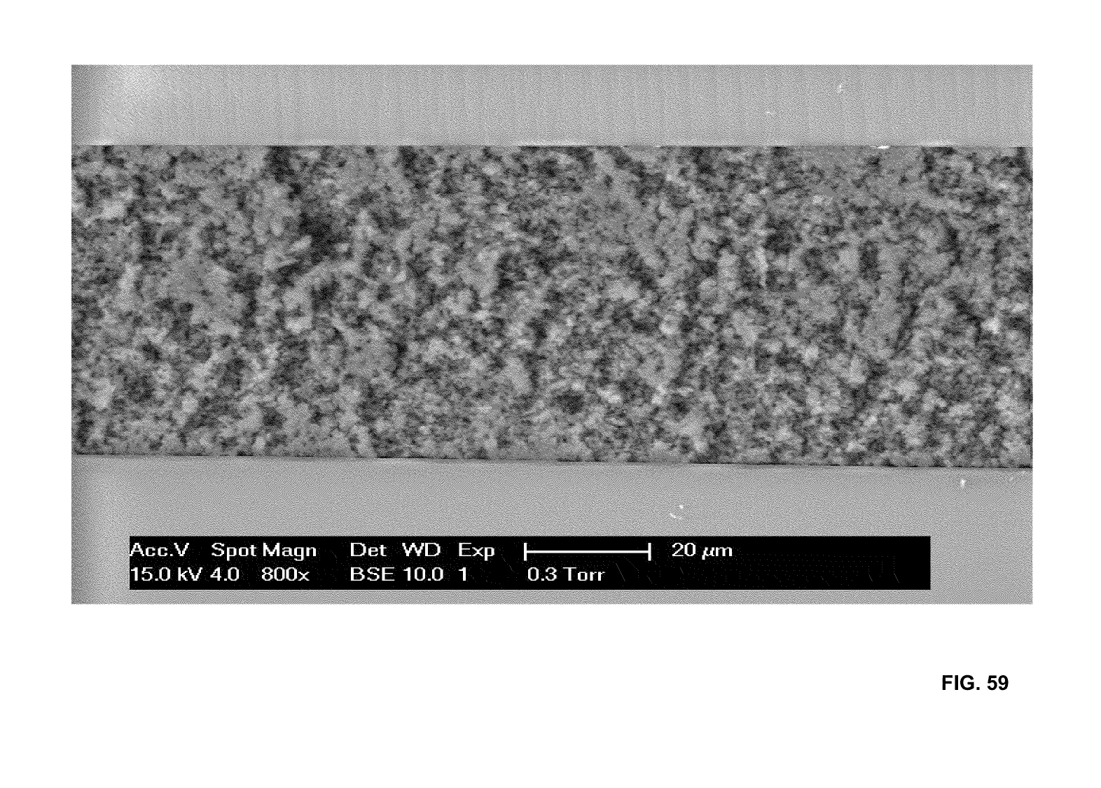

FIG. 60 is a representation of an example morphology obtained according to Example 42;

FIG. 61 is a representation of an example morphology obtained according to Example 43;

FIG. 62 is a representation of an example morphology obtained according to Example 44;

FIG. 63 is a representation of an example morphology obtained according to Example 45; and

FIG. 64 is a representation of an example morphology obtained according to Example 46.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

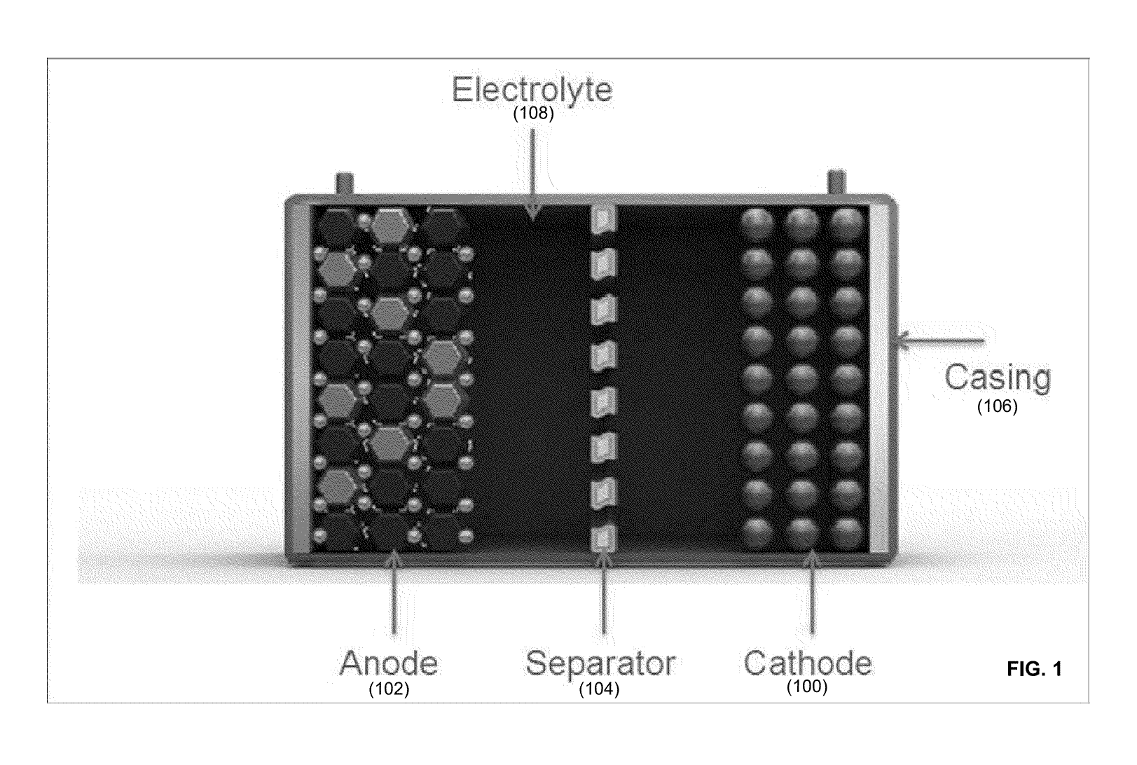

FIG. 1 illustrates an exemplary non-aqueous electrolyte battery. It would be understood by one skilled in the art that an electrolytic capacitor cell can have a similar configuration as the battery shown and described in reference with FIG. 1. In an aspect, the battery comprises a positive electrode 100 (cathode), a negative electrode 102 (anode), and a separator 104 disposed between the positive electrode 100 and the negative electrode 102. As an example, one or more of the positive electrode 100, the negative electrode 102, and the separator 104 is received in a battery vessel or casing 106. As a further example, a non-aqueous electrolyte 108 can be disposed in the casing 106 (e.g., adjacent one or more of the positive electrode 100, the negative electrode 102, and the separator 104, soaking the separator 104, immersing the separator 104, and the like).

In an aspect, the positive electrode 100 can comprise a positive active material incorporated therein and may further contain an electrically conductive material such as carbon and/or a binder for helping sheet or pelletize the positive active material. The positive electrode 100 can be used in contact with an electronically conductive substrate such as metal as a collector. As an example, the binder can be formed from a polytetrafluoroethylene (PTFE), a polyvinylidene fluoride (PVdF), an ethylene-propylene-diene copolymer, a styrene-butadiene rubber or the like. As another example, the collector can be formed from a foil, thin sheet, mesh or gauze of metal such as aluminum, stainless steel and titanium. As a further example, the positive active material and/or the conductive material may be pelletized or sheeted with the aforementioned binder by kneading/rolling. Alternatively, these materials may be dissolved and suspended in a solvent such as toluene and N-methylpyrrolidone (NMP) to form slurry which is then spread over the aforementioned collector and dried to form a sheet. Other materials and forming processes can be used.

In an aspect, the positive electrode 100 can comprise a lithium composite oxide containing at least one of iron, cobalt, manganese and nickel incorporated therein as a positive active material and is capable of insertion/releasing lithium ion. Various oxides such as chalcogen compound, e.g., lithium-containing iron composite oxide, lithium-containing cobalt composite oxide, lithium-containing nickel-cobalt composite oxide, lithium-containing nickel composite oxide and lithium-manganese composite oxide may be used as positive active material. Other materials and forming processes can be used.

In an aspect, negative electrode 102 can comprise a negative active material incorporated therein. As an example, the negative electrode 102 can be formed by pelletizing, tabulating or sheeting the negative active material with a conductive material, a binder, etc. In an aspect, the conductive material can be formed from an electronically conducting material such as carbon or metal. As an example, the binder can be formed from polytetrafluoroethylene, polyvinylidene fluoride, styrene-butadiene rubber, carboxymethyl cellulose or the like. As another example, the collector can be formed from a foil, thin plate, mesh or gauze of copper, stainless steel, nickel or the like. As a further example, the negative active material and/or the conductive material may be pelletized or sheeted with the aforementioned binder by kneading/rolling. Alternatively, these materials may be dissolved and suspended in a solvent such as water and N-methylpyrrolidone to form slurry which is then spread over the aforementioned collector and dried to obtain a sheet. Other materials and forming processes can be used.

In an aspect, the negative electrode 102 is capable of containing lithium (or lithium ion) or capable of occluding/releasing lithium (or lithium ion) similarly to the aforementioned positive electrode. As an example, the negative electrode 102 can comprise a negative active material incorporated therein capable of containing lithium ion or insertion/releasing lithium ion at a more negative potential than that of the positive electrode 100 combined with the negative electrode 102. Examples of negative active materials having such characteristics include: lithium metal; carbonaceous materials (carbon-based materials) such as artificial graphite, natural graphite, non-graphitizable carbon and graphitizable carbon; graphene; carbon nanotubes; lithium titanate; iron sulfide; cobalt oxide; lithium-aluminum alloy; silicon; and tinoxide. Other materials and forming processes can be used.

In an aspect, the separator 104 can be formed from polyetherimides (PEI) based on para-phenylene diamines (e.g., ULTEM™ CRS 5000 series). As an example, battery separator films (e.g., separator 104) formed from polyetherimides (PEI) based on para-phenylene diamines provide a combination of outstanding performance characteristics, such as high compatibility with electrolyte, high solvent resistance and a high melt integrity temperature exceeding 180° C. Polyetherimides (PEI) based on para-phenylene diamine can fulfill the critical requirement to be resistant to the battery electrolyte solution, even at elevated temperatures of 55° C. Additionally, these materials show an extremely low contact angle to the electrolyte solution over the whole compositional range typically used for electrolytes, which favors separator wettability and electrolyte retention, allowing for a reduced electrolyte filling time during cell production. Separators from PEI based on para-phenylene diamines have very high melt integrity (exceeding 180° C.) and have a high elastic modulus (stiffness) over the whole range of cell operation. Separators from PEI based on para-phenylene diamines provide a significant improvement of the cycle life of batteries. The proposed thermoplastic materials can be both melt and solution processed into porous films with specific ionic conductivities that are equal to or superior than typical commercial polyolefin-based separators. Other materials and forming processes can be used. In an aspect, the electrolyte comprises one of about 0 wt % to about 50 wt % ethyl carbonate of the total solvent composition; about 0 wt % to about 80 wt % dimethyl carbonate of the total solvent composition; and about 0 wt % to about 80 wt % ethyl methyl carbonate of the total solvent composition.

In an aspect, the separator 104 can be prepared by dissolving solvent-resistant polyetherimides in phenolic solvents at elevated temperatures (120° C.), followed by casting at reduced temperature (20-50° C.) and coagulating in a bath containing a non-solvent to the polymer. As an example, membranes can be prepared using the materials and processes disclosed herein for environments such as battery cells and/or capacitor cells, electrolytic energy storage devices, a dialysis membrane, a water filtration membrane, a desalination membrane, a gas separation membrane, and the like.

In an aspect, the separator 104 can be prepared by dissolving solvent-resistant polyetherimides in N-methylpyrrolidone (NMP) at elevated temperatures (140-202° C., see FIG. 1) in a closed system (i.e. no direct contact between the solution and the air atmosphere) or open system, followed by casting at reduced temperature (30-140° C.) and coagulating in a water or other material bath. As an example, membranes can be prepared using the materials and processes disclosed herein for environments such as battery cells and/or capacitor cells, electrolytic energy storage devices, a dialysis membrane, a water filtration membrane, a desalination membrane, a gas separation membrane, and the like.

In an aspect, polyetherimides can comprise polyetherimides homopolymers (e.g., polyetherimidesulfones) and polyetherimides copolymers. The polyetherimide can be selected from (i) polyetherimidehomopolymers, e.g., polyetherimides, (ii) polyetherimide co-polymers, and (iii) combinations thereof. Polyetherimides are known polymers and are sold by SABIC Innovative Plastics under the ULTEM®*, EXTEM®*, and Siltem* brands (Trademark of SABIC Innovative Plastics IP B.V.).

In an aspect, the polyetherimides can be of formula (1):

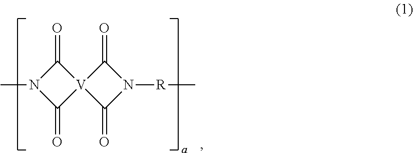

wherein a is more than 1, for example 10 to 1,000 or more, or more specifically 10 to 500.

The group V in formula (1) is a tetravalent linker containing an ether group (a “polyetherimide” as used herein) or a combination of an ether groups and arylenesulfone groups (a “polyetherimidesulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups; and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

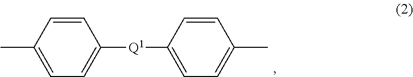

wherein Q1 includes but is not limited to a divalent moiety such as —O—, —S—, —C(O)—, —SO2—, —SO—, —CyH2y- (y being an integer from 1 to 5), and halogenated derivatives thereof, including perfluoroalkylene groups.

In an embodiment, linkers V include but are not limited to tetravalent aromatic groups of formula (3):

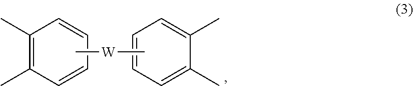

wherein W is a divalent moiety including —O—, —SO2-, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (4):

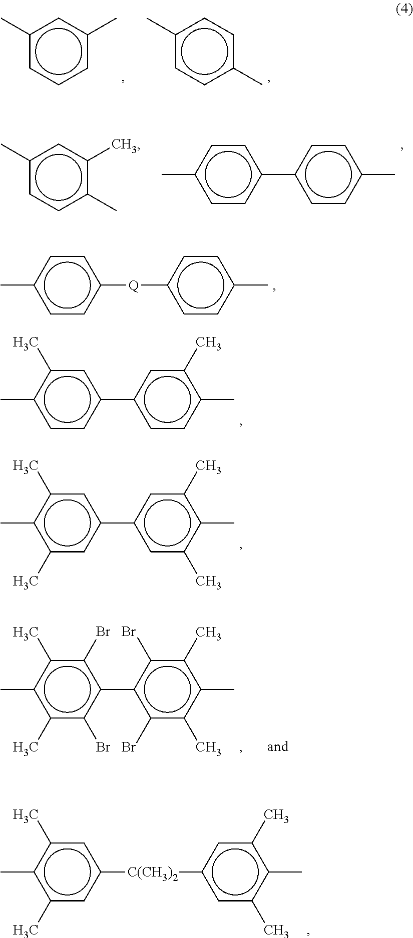

wherein Q includes, but is not limited to a divalent moiety including —O—, —S—, —C(O), —SO₂—, —SO—, —C_{y}H_{2y}— (y being an integer from 1 to 5), and halogenated derivatives thereof, including perfluoroalkylene groups.

In an aspect, the polyetherimide comprise more than 1, specifically 10 to 1,000, or more specifically, 10 to 500 structural units, of formula (5):

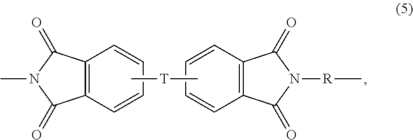

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (3) as defined above; and R is a divalent group of formula (2) as defined above.

In another aspect, the polyetherimidesulfones are polyetherimides comprising ether groups and sulfone groups wherein at least 50 mole % of the linkers V and the groups R in formula (1) comprise a divalent arylenesulfone group. For example, all linkers V, but no groups R, can contain an arylenesulfone group; or all groups R but no linkers V can contain an arylenesulfone group; or an arylenesulfone can be present in some fraction of the linkers V and R groups, provided that the total mole fraction of V and R groups containing an aryl sulfone group is greater than or equal to 50 mole %.

Even more specifically, polyetherimidesulfones can comprise more than 1, specifically 10 to 1,000, or more specifically, 10 to 500 structural units of formula (6):

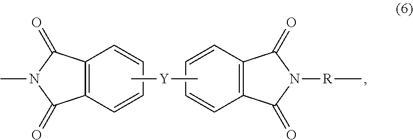

wherein Y is —O—, —SO2-, or a group of the formula —O—Z—O— wherein the divalent bonds of the —O—, SO2-, or the —O—Z—O— group are in the 3,3′, 3,4′, 4,3′, or the 4,4′ positions, wherein Z is a divalent group of formula (3) as defined above and R is a divalent group of formula (2) as defined above, provided that greater than 50 mole % of the sum of moles Y+moles R in formula (2) contain —SO2- groups.

It is to be understood that the polyetherimides and polyetherimidesulfones can optionally comprise linkers V that do not contain ether or ether and sulfone groups, for example linkers of formula (7):

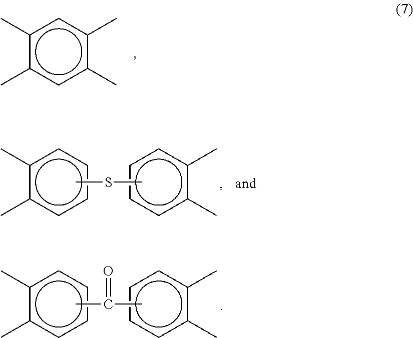

Imide units containing such linkers are generally be present in amounts ranging from 0 to 10 mole % of the total number of units, specifically 0 to 5 mole %. In one embodiment no additional linkers V are present in the polyetherimides and polyetherimidesulfones.

In another aspect, the polyetherimide comprises 10 to 500 structural units of formula (5) and the polyetherimidesulfone contains 10 to 500 structural units of formula (6).

Polyetherimides and polyetherimidesulfones can be prepared by any suitable process. In one embodiment, polyetherimides and polyetherimide copolymers include polycondensation polymerization processes and halo-displacement polymerization processes.

Polycondensation methods can include a method for the preparation of polyetherimides having structure (1) is referred to as the nitro-displacement process (X is nitro in formula (8)). In one example of the nitro-displacement process, N-methyl phthalimide is nitrated with 99% nitric acid to yield a mixture of N-methyl-4-nitrophthalimide (4-NPI) and N-methyl-3-nitrophthalimide (3-NPI). After purification, the mixture, containing approximately 95 parts of 4-NPI and 5 parts of 3-NPI, is reacted in toluene with the disodium salt of bisphenol-A (BPA) in the presence of a phase transfer catalyst. This reaction yields BPA-bisimide and NaNO2 in what is known as the nitro-displacement step. After purification, the BPA-bisimide is reacted with phthalic anhydride in an imide exchange reaction to afford BPA-dianhydride (BPADA), which in turn is reacted with a diamine such as meta-phenylene diamine (MPD) in ortho-dichlorobenzene in an imidization-polymerization step to afford the product polyetherimide.

Other diamines are also possible. Examples of suitable diamines include: m-phenylenediamine; p-phenylenediamine; 2,4-diaminotoluene; 2,6-diaminotoluene; m-xylylenediamine; p-xylylenediamine; benzidine; 3,3′-dimethylbenzidine; 3,3′-dimethoxybenzidine; 1,5-diaminonaphthalene; bis(4-aminophenyl)methane; bis(4-aminophenyl)propane; bis(4-aminophenyl)sulfide; bis(4-aminophenyl)sulfone; bis(4-aminophenyl)ether; 4,4′-diaminodiphenylpropane; 4,4′-diaminodiphenylmethane(4,4′-methylenedianiline); 4,4′-diaminodiphenylsulfide; 4,4′-diaminodiphenylsulfone; 4,4′-diaminodiphenylether(4,4′-oxydianiline); 1,5-diaminonaphthalene; 3,3′dimethylbenzidine; 3-methylheptamethylenediamine; 4,4-dimethylheptamethylenediamine; 2,2′,3,3′-tetrahydro-3,3,3′,3′-tetramethyl-1,1′-spirobi[1H-indene]-6,6′-diamine; 3,3′,4,4′-tetrahydro-4,4,4′,4′-tetramethyl-2,2′-spirobi[2H-1-benzo-pyran]-7,7′-diamine; 1,1′-bis[1-amino-2-methyl-4-phenyl]cyclohexane, and isomers thereof as well as mixtures and blends comprising at least one of the foregoing. In one embodiment, the diamines are specifically aromatic diamines, especially m- and p-phenylenediamine and mixtures comprising at least one of the foregoing.

Suitable dianhydrides that can be used with the diamines include and are not limited to 2,2-bis[4-(3,4-dicarboxyphenoxy)phenyl]propane dianhydride; 4,4′-bis(3,4-dicarboxyphenoxy)diphenyletherdianhydride; 4,4′-bis(3,4-dicarboxyphenoxy)diphenylsulfidedianhydride; 4,4′-bis(3,4-dicarboxyphenoxy)benzophenonedianhydride; 4,4′-bis(3,4-dicarboxyphenoxy)diphenylsulfonedianhydride; 2,2-bis[4-(2,3-dicarboxyphenoxy)phenyl]propane dianhydride; 4,4′-bis(2,3-dicarboxyphenoxy)diphenyletherdianhydride; 4,4′-bis(2,3-dicarboxyphenoxy)diphenylsulfidedianhydride; 4,4′-bis(2,3-dicarboxyphenoxy)benzophenonedianhydride; 4,4′-bis(2,3-dicarboxyphenoxy)diphenylsulfonedianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyletherdianhydride; 4-(2,3-dicarboxyphenoxy)-4′-(3,4-dicarboxyphenoxy)diphenylsulfide dianhydride; 4-(2,3-dicarboxyphenoxy)-4′-(3,4-dicarboxyphenoxy)benzophenonedianhydride; 4-(2,3-dicarboxyphenoxy)-4′-(3,4-dicarboxyphenoxy)diphenylsulfone dianhydride; 1,3-bis(2,3-dicarboxyphenoxy)benzene dianhydride; 1,4-bis(2,3-dicarboxyphenoxy)benzene dianhydride; 1,3-bis(3,4-dicarboxyphenoxy)benzene dianhydride; 1,4-bis(3,4-dicarboxyphenoxy)benzene dianhydride; 3,3′,4,4′-diphenyl tetracarboxylicdianhydride; 3,3′,4,4′-benzophenonetetracarboxylic dianhydride; naphthalicdianhydrides, such as 2,3,6,7-naphthalic dianhydride, etc.; 3,3′,4,4′-biphenylsulphonictetracarboxylic dianhydride; 3,3′,4,4′-biphenylethertetracarboxylic dianhydride; 3,3′,4,4′-dimethyldiphenylsilanetetracarboxylic dianhydride; 4,4′-bis(3,4-dicarboxyphenoxy)diphenylsulfidedianhydride; 4,4′-bis(3,4-dicarboxyphenoxy)diphenylsulphonedianhydride; 4,4′-bis(3,4-dicarboxyphenoxy)diphenylpropanedianhydride; 3,3′,4,4′-biphenyltetracarboxylic dianhydride; bis(phthalic)phenylsulphineoxidedianhydride; p-phenylene-bis(triphenylphthalic)dianhydride; m-phenylene-bis(triphenylphthalic)dianhydride; bis(triphenylphthalic)-4,4′-diphenylether dianhydride; bis(triphenylphthalic)-4,4′-diphenylmethane dianhydride; 2,2′-bis(3,4-dicarboxyphenyl)hexafluoropropanedianhydride; 4,4′-oxydiphthalic dianhydride; pyromelliticdianhydride; 3,3′,4,4′-diphenylsulfonetetracarboxylic dianhydride; 4′,4′-bisphenol A dianhydride; hydroquinone diphthalic dianhydride; 6,6′-bis(3,4-dicarboxyphenoxy)-2,2′,3,3′-tetrahydro-3,3,3′,3′-tetramethyl-1-1,1′-spirobi[1H-indene]dianhydride; 7,7′-bis(3,4-dicarboxyphenoxy)-3,3′,4,4′-tetrahydro-4,4,4′,4′-tetramethyl-1-2,2′-spirobi[2H-1-benzopyran]dianhydride; 1,1′-bis[1-(3,4-dicarboxyphenoxy)-2-methyl-4-phenyl]cyclohexane dianhydride; 3,3′,4,4′-diphenylsulfonetetracarboxylic dianhydride; 3,3′,4,4′-diphenylsulfidetetracarboxylic dianhydride; 3,3′,4,4′-diphenylsulfoxidetetracarboxylic dianhydride; 4,4′-oxydiphthalic dianhydride; 3,4′-oxydiphthalic dianhydride; 3,3′-oxydiphthalic dianhydride; 3,3′-benzophenonetetracarboxylic dianhydride; 4,4′-carbonyldiphthalic dianhydride; 3,3′,4,4′-diphenylmethanetetracarboxylic dianhydride; 2,2-bis(4-(3,3-dicarboxyphenyl)propane dianhydride; 2,2-bis(4-(3,3-dicarboxyphenyl)hexafluoropropanedianhydride; (3,3′,4,4′-diphenyl)phenylphosphinetetracarboxylicdianhydride; (3,3′,4,4′-diphenyl)phenylphosphineoxidetetracarboxylicdianhydride; 2,2′-dichloro-3,3′,4,4′-biphenyltetracarboxylic dianhydride; 2,2′-dimethyl-3,3′,4,4′-biphenyltetracarboxylic dianhydride; 2,2′-dicyano-3,3′,4,4′-biphenyltetracarboxylic dianhydride; 2,2′-dibromo-3,3′,4,4′-biphenyltetracarboxylic dianhydride; 2,2′-diiodo-3,3′,4,4′-biphenyltetracarboxylic dianhydride; 2,2′-ditrifluoromethyl-3,3′,4,4′-biphenyltetracarboxylic dianhydride; 2,2′-bis(1-methyl-4-phenyl)-3,3′,4,4′-biphenyltetracarboxylic dianhydride; 2,2′-bis(1-trifluoromethyl-2-phenyl)-3,3′,4,4′-biphenyltetracarboxylic dianhydride; 2,2′-bis(1-trifluoromethyl-3-phenyl)-3,3′,4,4′-biphenyltetracarboxylic dianhydride; 2,2′-bis(1-trifluoromethyl-4-phenyl)-3,3′,4,4′-biphenyltetracarboxylic dianhydride; 2,2′-bis(1-phenyl-4-phenyl)-3,3′,4,4′-biphenyltetracarboxylic dianhydride; 4,4′-bisphenol A dianhydride; 3,4′-bisphenol A dianhydride; 3,3′-bisphenol A dianhydride; 3,3′,4,4′-diphenylsulfoxidetetracarboxylic dianhydride; 4,4′-carbonyldiphthalic dianhydride; 3,3′,4,4′-diphenylmethanetetracarboxylic dianhydride; 2,2′-bis(1,3-trifluoromethyl-4-phenyl)-3,3′,4,4′-biphenyltetracarboxylic dianhydride, and all isomers thereof, as well as combinations of the foregoing.

Halo-displacement polymerization methods for making polyetherimides and polyetherimidesulfones include and are not limited to, the reaction of a bis(phthalimide) for formula (8):

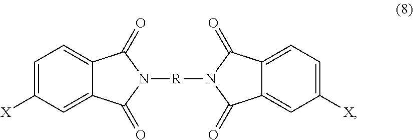

wherein R is as described above and X is a nitro group or a halogen. Bis-phthalimides (8) can be formed, for example, by the condensation of the corresponding anhydride of formula (9):

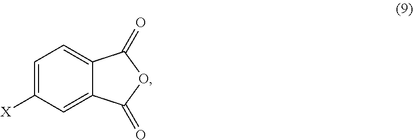

wherein X is a nitro group or halogen, with an organic diamine of the formula (10):

H₂N—R—NH₂ (10),

wherein R is as described above.

Illustrative examples of amine compounds of formula (10) include: ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl)ether, bis(p-b-methyl-o-aminophenyl)benzene, bis(p-b-methyl-o-aminopentyl)benzene, 1,3-diamino-4-isopropylbenzene, bis(4-aminophenyl)ether and 1,3-bis(3-aminopropyl)tetramethyldisiloxane. Mixtures of these amines can be used. Illustrative examples of amine compounds of formula (10) containing sulfone groups include but are not limited to, diaminodiphenylsulfone (DDS) and bis(aminophenoxy phenyl) sulfones (BAPS). Combinations comprising any of the foregoing amines can be used.

The polyetherimides can be synthesized by the reaction of the bis(phthalimide) (8) with an alkali metal salt of a dihydroxy substituted aromatic hydrocarbon of the formula HO—V—OH wherein V is as described above, in the presence or absence of phase transfer catalyst. Suitable phase transfer catalysts are disclosed in U.S. Pat. No. 5,229,482. Specifically, the dihydroxy substituted aromatic hydrocarbon a bisphenol such as bisphenol A, or a combination of an alkali metal salt of a bisphenol and an alkali metal salt of another dihydroxy substituted aromatic hydrocarbon can be used.

In one embodiment, the polyetherimide comprises structural units of formula (5) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is 2,2-diphenylenepropane group (a bisphenol A group). Further, the polyetherimidesulfone comprises structural units of formula (6) wherein at least 50 mole % of the R groups are of formula (4) wherein Q is —SO2- and the remaining R groups are independently p-phenylene or m-phenylene or a combination comprising at least one of the foregoing; and T is group of the formula —O—Z—O— wherein the divalent bonds of the —O—Z—O— group are in the 3,3′ positions, and Z is a 2,2-diphenylenepropane group.

The polyetherimide and polyetherimidesulfone can be used alone or in combination with each other and/or other of the disclosed polymeric materials in fabricating the polymeric components of the invention. In one embodiment, only the polyetherimide is used. In another embodiment, the weight ratio of polyetherimide: polyetherimidesulfone can be from 99:1 to 50:50.

The polyetherimides can have a weight average molecular weight (Mw) of 5,000 to 100,000 grams per mole (g/mole) as measured by gel permeation chromatography (GPC). In some embodiments the Mw can be 10,000 to 80,000. The molecular weights as used herein refer to the absolute weight averaged molecular weight (Mw).

The polyetherimides can have an intrinsic viscosity greater than or equal to 0.2 deciliters per gram (dl/g) as measured in m-cresol at 25° C. Within this range the intrinsic viscosity can be 0.35 to 1.0 dl/g, as measured in m-cresol at 25° C.

The polyetherimides can have a glass transition temperature of greater than 180° C., specifically of 200° C. to 500° C., as measured using differential scanning calorimetry (DSC) per ASTM test D3418. In some embodiments, the polyetherimide and, in particular, a polyetherimide has a glass transition temperature of 240 to 350° C.

The polyetherimides can have a melt index of 0.1 to 10 grams per minute (g/min), as measured by American Society for Testing Materials (ASTM) DI 238 at 340 to 370° C., using a 6.7 kilogram (kg) weight.

An alternative halo-displacement polymerization process for making polyetherimides, e.g., polyetherimides having structure (1) is a process referred to as the chloro-displacement process (X is Cl in formula (8)). The chloro-displacement process is illustrated as follows: 4-chloro phthalic anhydride and meta-phenylene diamine are reacted in the presence of a catalytic amount of sodium phenyl phosphinate catalyst to produce the bischlorophthalimide of meta-phenylene diamine (CAS No. 148935-94-8). The bischlorophthalimide is then subjected to polymerization by chloro-displacement reaction with the disodium salt of BPA in the presence of a catalyst in ortho-dichlorobenzene or anisole solvent. Alternatively, mixtures of 3-chloro- and 4-chlorophthalic anhydride may be employed to provide a mixture of isomeric bischlorophthalimides which may be polymerized by chloro-displacement with BPA disodium salt as described above.

Siloxane polyetherimides can include polysiloxane/polyetherimide block or random copolymers having a siloxane content of greater than 0 and less than 40 weight percent (wt %) based on the total weight of the block copolymer. The block copolymer comprises a siloxane block of Formula (I):

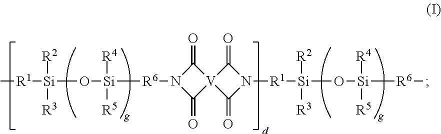

wherein R¹⁻⁶ are independently at each occurrence selected from the group consisting of substituted or unsubstituted, saturated, unsaturated, or aromatic monocyclic groups having 5 to 30 carbon atoms, substituted or unsubstituted, saturated, unsaturated, or aromatic polycyclic groups having 5 to 30 carbon atoms, substituted or unsubstituted alkyl groups having 1 to 30 carbon atoms and substituted or unsubstitutedalkenyl groups having 2 to 30 carbon atoms, V is a tetravalent linker selected from the group consisting of substituted or unsubstituted, saturated, unsaturated, or aromatic monocyclic and polycyclic groups having 5 to 50 carbon atoms, substituted or unsubstituted alkyl groups having 1 to 30 carbon atoms, substituted or unsubstitutedalkenyl groups having 2 to 30 carbon atoms and combinations comprising at least one of the foregoing linkers, g equals 1 to 30, and d is 2 to 20. Commercially available siloxane polyetherimides can be obtained from SABIC Innovative Plastics under the brand name SILTEM* (*Trademark of SABIC Innovative Plastics IP B.V.)

The polyetherimide resin can have a weight average molecular weight (Mw) within a range having a lower limit and/or an upper limit. The range can include or exclude the lower limit and/or the upper limit. The lower limit and/or upper limit can be selected from 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 101000, 102000, 103000, 104000, 105000, 106000, 107000, 108000, 109000, and 110000 daltons. For example, the polyetherimide resin can have a weight average molecular weight (Mw) from 5,000 to 100,000 daltons, from 5,000 to 80,000 daltons, or from 5,000 to 70,000 daltons. The primary alkyl amine modified polyetherimide will have lower molecular weight and higher melt flow than the starting, unmodified, polyetherimide.

The polyetherimide resin can be selected from the group consisting of a polyetherimide, for example as described in U.S. Pat. Nos. 3,875,116; 6,919,422 and 6,355,723 a silicone polyetherimide, for example as described in U.S. Pat. Nos. 4,690,997; 4,808,686 a polyetherimidesulfone resin, as described in U.S. Pat. No. 7,041,773 and combinations thereof, each of these patents are incorporated herein their entirety.

The polyetherimide resin can have a glass transition temperature within a range having a lower limit and/or an upper limit. The range can include or exclude the lower limit and/or the upper limit. The lower limit and/or upper limit can be selected from 100, 110, 120, 130, 140, 150, 160, 170, 180, 190, 200, 210, 220, 230, 240, 250, 260, 270, 280, 290, 300 and 310 degrees Celsius. For example, the polyetherimide resin can have a glass transition temperature (Tg) greater than about 200 degrees Celsius.

The polyetherimide resin can be substantially free (less than 100 ppm) of benzylic protons. The polyetherimide resin can be free of benzylic protons. The polyetherimide resin can have an amount of benzylic protons below 100 ppm. In one embodiment, the amount of benzylic protons ranges from more than 0 to below 100 ppm. In another embodiment, the amount of benzylic protons is not detectable.

The polyetherimide resin can be substantially free (less than 100 ppm) of halogen atoms. The polyetherimide resin can be free of halogen atoms. The polyetherimide resin can have an amount of halogen atoms below 100 ppm. In one embodiment, the amount of halogen atoms range from more than 0 to below 100 ppm. In another embodiment, the amount of halogen atoms is not detectable.

In an aspect, the electrolyte 108 can comprise a molten salt and/or a lithium salt. As an example, the lithium battery electrolyte can have a high lithium ionic conductivity and so low viscosity as to give a high infiltration into the electrode or separator. In an aspect, the electrolyte 108 can comprise one or more of lithium tetrafluoroborate (abbreviated as “LiBF4”), lithium hexafluorophosphate (abbreviated as “LiPF6”), lithium hexafluoromethanesulfonate, lithium bis(trifluoromethane sulfonyl) amide (abbreviated as “LiTFSI”), lithium dicyanamide (abbreviated as “LiDCA”), lithium trifluoromethanesulfonate (abbreviated as “LiTFS”) and lithium bis(pentafluoroethanesulonyl)amide (abbreviated as “LiBETI”). Other materials and forming processes can be used.

The cation contained in the aforementioned molten salt is not specifically limited but may be one or more selected from the group consisting of aromatic quaternary ammonium ions such as 1-ethyl-3-methyl imidazolium, 1-methyl-3-propylimidazolium, 1-methyl-3-isopropylimidazolium, 1-butyl-3-methylimidazolium, 1-ethyl-2,3-dimethyl imidazolium, 1-ethyl-3,4-dimethylimidazolium, N-propylpyridinium, N-butylpyridinium, N-tert-butyl pyridinium and N-tert-pentylpyridinium, and aliphatic quaternary ammonium ions such as N-butyl-N,N,N-trimethylammonium, N-ethyl-N,N-dimethyl-N-propyl ammonium, N-butyl-N-ethyl-N,N-dimethylammonium, N-butyl-N,N-dimethyl-N-propylammonium, N-methyl-N-propylpyrrolidinium, N-butyl-N-methylpyrrolidinium, N-methyl-N-pentylpyrrolidinium, N-propoxyethyl-N-methylpyrrolidinium, N-methyl-N-propyl piperidinium, N-methyl-N-isopropylpiperidinium, N-butyl-N-methylpiperidinium, N-isobutyl-N-methyl piperidinium, N-sec-butyl-N-methyl piperidinium, N-methoxyethyl-N-methylpiperidinium and N-ethoxyethyl-N-methylpiperidinium. Among these aliphatic quaternary ammonium ions, pyrrolidinium ions as nitrogen-containing 5-membered ring or piperidinium ions as nitrogen-containing 6-membered ring are desirable because they have a high reduction resistance that inhibits side reaction to enhance storage properties or cycle performances. Other materials and forming processes can be used.

The anion contained in the aforementioned molten salt is not specifically limited but may be one or more selected from the group consisting of PF6-, (PF3(C2F5)3)-, (PF3(CF3)3)-, BF4-, (BF2(CF3)2)-, (BF2(C2F5)2)-, (BF3(CF3))-, (BF3(C2F5))-, (B(COOCOO)2)- (abbreviated as “BOB-”), CF3SO3- (abbreviated as “Tf-”), C4F9SO3- (abbreviated as “Nf-”), ((CF3SO2)2N)— (abbreviated as “TFSI-”), ((C2F5SO2)2N)— (abbreviated as “BETI-”), ((CF3SO2) (C4F9SO2)N)—, ((CN)2N)— (abbreviated as “DCA-”) and ((CF3SO2)3C)— and ((CN)3C)—. Among these there may be desirably used at least one of PF6-, (PF3(C2F5)3)-, (PF3(CF3)3)-, BF4-, (BF2(CF3)2)-, (BF2(C2F5)2)-, (BF3(CF3))-, (BF3(C2F5))-, Tf-, Nf-, TFSI-, BETI- and ((CF3SO2) (C4F9SO2)N), which include F, in view of excellent cycle performances. In an aspect, the electrolyte comprises one of about 0 wt % to about 50 wt % ethyl carbonate of the total solvent composition; about 0 wt % to about 80 wt % dimethyl carbonate of the total solvent composition; and about 0 wt % to about 80 wt % ethyl methyl carbonate of the total solvent composition.

In use, the positive electrode and the negative electrode are separated from each other by a separator and are electrically connected to each other by ion movement through the aforementioned electrolyte. In order to form a battery including an electrolyte having the aforementioned constitution, the separator can be formed from a thermoplastic polymer.

In one aspect, the thermoplastic polymer phase comprises a thermoplastic resin and a flow modifier. The thermoplastic resin can comprise one or more thermoplastic polymer resins including, but are not limited to, polyphenylene sulfides and polyimides. In a further aspect, the polyimides used in the disclosed composites include polyamideimides, polyetherimides and polybenzimidazoles. In a further aspect, polyetherimides comprise melt processable polyetherimides.

Suitable polyetherimides that can be used in the disclosed composites include, but are not limited to, ULTEM™. ULTEM™ is a polymer from the family of polyetherimides (PEI) sold by Saudi Basic Industries Corporation (SABIC). ULTEM™ can have elevated thermal resistance, high strength and stiffness, and broad chemical resistance. ULTEM™ as used herein refers to any or all ULTEM™ polymers included in the family unless otherwise specified. In a further aspect, the ULTEM™ is ULTEM™ 1000. In one aspect, a polyetherimide can comprise any polycarbonate material or mixture of materials, for example, as recited in U.S. Pat. No. 4,548,997; U.S. Pat. No. 4,629,759; U.S. Pat. No. 4,816,527; U.S. Pat. No. 6,310,145; and U.S. Pat. No. 7,230,066, all of which are hereby incorporated in its entirety for the specific purpose of disclosing various polyetherimide compositions and methods.

In certain aspects, the thermoplastic polymer is a polyetherimide polymer having a structure comprising structural units represented by a organic radical of formula (I):

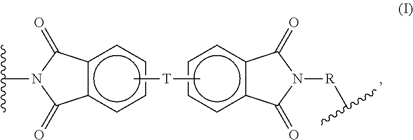

wherein R in formula (I) includes substituted or unsubstituted divalent organic radicals such as (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (II):

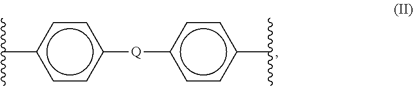

wherein Q includes a divalent moiety selected from the group consisting of a single bond, —O—, —S—, —C(O)—, —SO2—, —SO—, —CyH2y- (y being an integer from 1 to 5), and halogenated derivatives thereof, including perfluoroalkylene groups; wherein T is —O— or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III):

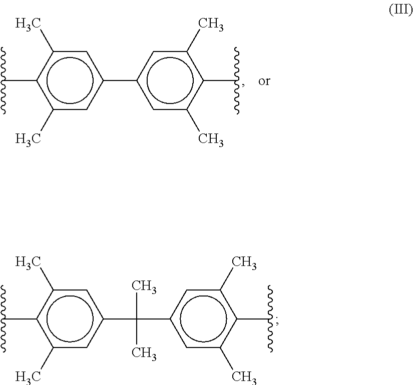

and wherein the polyetherimides which are included by formula (I) have a Mw of at least about 40,000.

In a further aspect, the polyetherimide polymer may be a copolymer, which, in addition to the etherimide units described above, further contains polyimide structural units of the formula (IV):

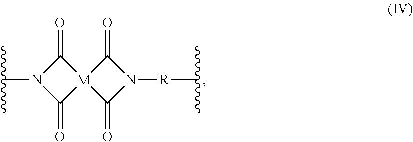

wherein R is as previously defined for formula (I) and M includes, but is not limited to, radicals of formula (V):

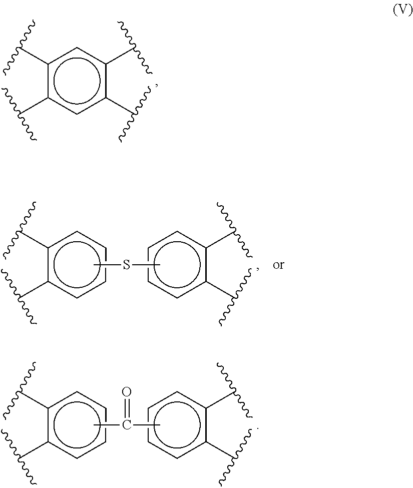

In a further aspect, the thermoplastic resin is a polyetherimide polymer having structure represented by a formula:

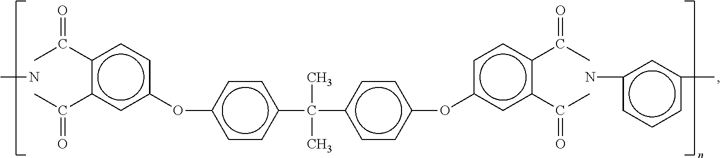

wherein the polyetherimide polymer has a molecular weight of at least 40,000 Daltons, 50,000 Daltons, 60,000 Daltons, 80,000 Daltons, or 100,000 Daltons.

The polyetherimide polymer can be prepared by methods known to one skilled in the art, including the reaction of an aromatic bis(ether anhydride) of the formula (VI):

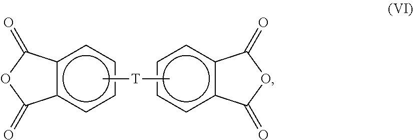

with an organic diamine of the formula (IX):

H2N—R—NH2 (VII),

wherein T and R are defined as described above in formula (I).

Illustrative, non-limiting examples of aromatic bis(ether anhydride)s of formula (VI) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A useful class of aromatic bis(ether anhydride)s included by formula (VI) above includes, but is not limited to, compounds wherein T is of the formula (VIII):

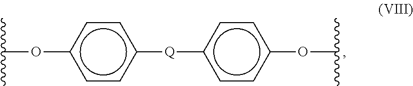

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Illustrative, non-limiting examples of suitable diamino compounds of formula (VII) include ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecane diamine, 1,18-octadecanediamine, 3-methylheptamethylenediamine, 4,4-dimethylheptamethylenediamine, 4-methylnonamethylenediamine, 5-methylnonamethylene diamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylene diamine, 1,2-bis(3-aminopropoxy)ethane, bis(3-aminopropyl)sulfide, 1,4-cyclohexane diamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl)propane, 2,4-bis(b-amino-t-butyl)toluene, bis(p-b-amino-t-butylphenyl)ether, bis(p-b-methyl-o-aminophenyl)benzene, bis(p-b-methyl-o-aminopentyl)benzene, 1,3-diamino-4-isopropyl benzene, bis(4-aminophenyl)sulfide, bis(4-aminophenyl)sulfone, bis(4-aminophenyl)ether and 1,3-bis(3-aminopropyl)tetramethyldisiloxane. Mixtures of these compounds may also be present. Beneficial diamino compounds are aromatic diamines, especially m- and p-phenylenediamine and mixtures thereof.

In a further aspect, the polyetherimide resin includes structural units according to formula (I) wherein each R is independently p-phenylene or m-phenylene or a mixture thereof and T is a divalent radical of the formula (IX):

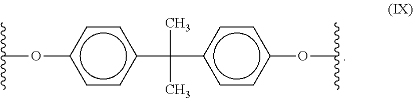

In various aspects, the reactions can be carried out employing solvents such as o-dichlorobenzene, m-cresol/toluene, or the like, to effect a reaction between the anhydride of formula (VI) and the diamine of formula (VII), at temperatures of about 100° C. to about 250° C. Alternatively, the polyetherimide can be prepared by melt polymerization of aromatic bis(ether anhydride)s of formula (VI) and diamines of formula (VII) by heating a mixture of the starting materials to elevated temperatures with concurrent stirring. Melt polymerizations can employ temperatures of about 200° C. to about 400° C. Chain stoppers and branching agents can also be employed in the reaction. The polyetherimide polymers can optionally be prepared from reaction of an aromatic bis(ether anhydride) with an organic diamine in which the diamine is present in the reaction mixture at no more than about 0.2 molar excess, and beneficially less than about 0.2 molar excess. Under such conditions the polyetherimide resin has less than about 15 microequivalents per gram (μeq/g) acid titratable groups in one embodiment, and less than about 10 μeq/g acid titratable groups in an alternative embodiment, as shown by titration with chloroform solution with a solution of 33 weight percent (wt %) hydrobromic acid in glacial acetic acid. Acid-titratable groups are essentially due to amine end-groups in the polyetherimide resin.

In a further aspect, the polyetherimide resin has a weight average molecular weight (Mw) of at least about 24,000 to about 150,000 grams per mole (g/mole), as measured by gel permeation chromatography, using a polystyrene standard. In a still further aspect, the thermoplastic resin can have a molecular weight of at least 20,000 Daltons, 40,000 Daltons, 50,000 Daltons, 60,000 Daltons, 80,000 Daltons, 100,000 Daltons, or 120,000 Daltons. In a yet further aspect, the thermoplastic resin can have a molecular weight of at least 40,000 Daltons. In an even further aspect, the thermoplastic resin can have a molecular weight of at least 45,000 Daltons. In a still further aspect, the thermoplastic resin can have a molecular weight of at least 50,000 Daltons. In a yet further aspect, the thermoplastic resin can have a molecular weight of at least 60,000 Daltons. In an even further aspect, the thermoplastic resin can have a molecular weight of at least 70,000 Daltons. In a still further aspect, the thermoplastic resin can have a molecular weight of at least 100,000 Daltons.

In a further aspect, the thermoplastic resin can comprise a polyetherimide polymer having a molecular weight of at least 40,000 Daltons, 50,000 Daltons, 60,000 Daltons, 80,000 Daltons, or 100,000 Daltons. In a yet further aspect, polyetherimide polymer has a molecular weight of at least Daltons, 40,000 Daltons or 50,000 Daltons. In a still further aspect, the polyetherimide polymer has a molecular weight of at least 40,000 Daltons. In a yet further aspect, the polyetherimide polymer has a molecular weight of at least 50,000 Daltons. In an even further aspect, the polyetherimide polymer has a molecular weight of at least 60,000 Daltons. In a still further aspect, the polyetherimide polymer has a molecular weight of at least 70,000 Daltons. In a yet further aspect, the polyetherimide polymer has a molecular weight of at least 100,000 Daltons.

In an aspect, a liquid induce phase separation (LIPS) or a vapor induced phase separation (VIPS) process based on SABIC's ULTEM™ CRS 5000 resins can be used to prepare one or more lithium ion battery separators. As an example, LIPS or VIPS can be used to prepare ULTEM™ CRS 5000 porous separator films with tunable pore structures, which are very suitable for battery separator applications. The process is versatile in terms of the obtained porosity, pore size and thickness and, therefore, in the final performance of the separator in an actual electrochemical cell environment.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Exemplary Testing Procedure

Solvent resistance tests quantified the degree of swelling and/or dissolving of polymer films in the electrolyte solution (1:1:1 ratio of DMC:EMC:EC and 1 mol/L LiPF₆) or individual electrolyte solvents, being dimethyl carbonate (DMC), diethyl carbonate (DEC) and ethylene carbonate (EC). All the tested samples were thin solid films with a thickness between 50 and 100 micron. Commercial Celgard® 2500 (polypropylene-based) and Tonen V25CGD (polyethylene-based) separators were used as control samples. The detailed procedure for the solvent resistance tests with the electrolyte solutions is as follows:
1. Prepare nine replicate samples (thin films) for each material type;
2. Dry all the samples under vacuum according to the typical drying process as suggested by the material supplier;
3. Record the starting weight of the dry samples. The resolution of the electronic balance is 0.00001 gram and the weight of each individual sample exceeds 0.02 gram, so the accuracy is at least ±0.05%.
4. Immerse each individual sample in an excess of electrolyte solution (full sample coverage) in a separate, sealed glass vessel. This procedure takes place in a glove-box under argon atmosphere to protect the electrolyte solution
5. Store all vessels in heating mantles at 55±2° C. in a glove-box (argon atmosphere); take out the samples after 21 days.
6. After taking out the sample from the solution, rinse the sample according to the procedure below to remove any residual solvent and salt residues on the sample surface:
   Ultrasonic rinse in DMC for two minutes, and rinse in DMC twice
   Rinse in ethanol (3 times)
   Wash with running DI water
      The rinse process was validated by evaluating commercial separators; it successfully removed all the organic solvent and lithium salt.
7. Wipe the wet samples dry with a cloth or tissue to remove any residual electrolyte at the surface of the sample, and record the weight as wet weight;
8. Vacuum dry the sample at 110° C. for 48 hours. The PP and PE samples were dried at 60° C. for 24 hours. The ULTEM™ CRS 5001 film samples still showed a weight gain after drying at 110° C. for 48 hours, indicating a strong interaction with the electrolyte solvents. The ULTEM™ CRS 5001 samples were, therefore, dried an additional 24 hours at 200° C. and no further weight change was observed. The other film samples were dried at 110° C. for 48 hours.
9. Record the weight of the samples as the dry weight right directly after removal from the drying oven.
10. The normalized dry weight was calculated as the dry weight divided by the starting weight. The normalized wet weight was calculated as the wet weight divided by the starting weight.
   The detailed procedure for the solvent resistance tests with the individual electrolyte solvents is as follows:
1. Prepare nine replicate samples (thin films) for each material type;
2. Dry all the samples under vacuum according to the typical drying process as suggested by the material supplier;
3. Record the starting weight of the dry samples. The resolution of the electronic balance is 0.00001 gram and the weight of each individual sample exceeds 0.02 gram, so the accuracy is at least ±0.05%.
4. Immerse each individual sample in an excess of solvent (full sample coverage) in a separate, sealed glass vessel.
5. Store all vessels in a water bath at 55±2° C.; take out the samples after 21 days.
6. Wipe the wet samples dry with a cloth or tissue to remove any residual solvent at the surface of the sample, and record the weight as wet weight;
7. Vacuum dry the sample at 110° C. for 48 hours. The PP and PE samples were dried at 60° C. for 24 hours. The other samples were dried for 3 days at 110° C. under vacuum and 1 day at 150° C. under vacuum.
8. The normalized dry weight was calculated as the dry weight divided by the starting weight. The normalized wet weight was calculated as the wet weight divided by the starting weight.

The wettability of different polymers was evaluated by contact angle measurements using the electrolyte solution (1:1:1 ratio of DMC:EMC:EC and 1 mol/L LiPF₆) or individual alkyl carbonate solvents. Contact angle was measured according to a standard procedure (e.g., via the Young equation or similar), where a mathematical expression was fitted to the shape of the drop and the slope of the tangent to the drop at the liquid-solid-vapor (LSV) interface line was calculated. Each sample was measured at least five times and the contact angle was recorded 5 seconds after dispensing the droplet onto the surface, unless stated otherwise.

Thermal mechanical analysis (TMA) is typically used to characterize the high-temperature melt integrity (HTMI) of separators according to the NASA/TM—2010-216099 Test Method. Utilizing TMA, the separator is held under a constant, small load and the degree of deformation (elongation) is measured as a function of temperature. At the temperature where the separator loses its mechanical integrity, the elongation increases dramatically. Typically, the shrinkage onset (temperature at 2% shrinkage), the deformation temperature (temperature at 5% deformation) and the rupture temperature (the temperature at which the material breaks) are reported, and the high-temperature melt integrity is defined as the deformation temperature. The high-temperature melt integrity (HTMI) of separators is defined here as the 5% deformation temperature. A TA Instruments Q800 DMA was used with a film tension setup. Films of about 10 mm long and about 3 mm wide were tested. The sample is held with a constant 0.02 N load while the temperature is ramped at 5° C./min up to failure of the sample. The experimental parameters as follows:
a. Test: Temp Ramp/Controlled Force
b. Preload Force: 0.02 N
c. Start Temperature: 30° C.
d. Final Temperature: 300° C. (or rupture of sample)
e. Ramp rate: 5° C./min

In an aspect, 2016 Coin cells were used as the test vehicle for the determination of ionic conductivity [according to “Battery Separator Characterization and Evaluation Procedures for NASA's Advanced Lithium-Ion Batteries”, NASA/TM—2010-216099]. Lithium metal slices (pure lithium metal (99.9%) from WISDOM OPTOELECTRONIC TECHNOLOGY CO., LTD] were used as electrodes. Electrochemical impedance spectroscopy (EIS) was used to test the cell resistance, using a VMP2 MultiPotentiostat from BioLogic Science Instruments. The specific conductivity is calculated according to Ohmic Law:

Specific conductivity=Film Thickness/(Separator resistance*tested area)

wherein the film thickness was measured by a micrometer, the separator resistance was read from the EIS Nyquist plot and the tested area was determined by the size of the electrodes (the diameter is 15.6 mm).

For cycling tests, LiFePO₄ cathodes were obtained from BYD and graphite anodes from MTI Co. Ltd. The 2016 coin cell components were obtained from Shenzhen Kejingstar Tech Co., Ltd. The electrolyte used was LBC3015B from Shenzhen Capchem Tech Co. Ltd. The test procedure for the LiFePO₄ 2016 coin cells is:
1. Formation cycle: Constant current charge at 0.3 mA until the voltage hits 3.8V; Constant voltage charge at 3.8V until the current trip to 0.075 mA; Open circuit for 1 minute; Constant current discharge at −0.3 mA until the voltage hits 2.5V; Constant current charge at 1.5 mA until the voltage hits 3.8V; Constant voltage charge at 3.8V until the current trip to 0.075 mA; monitor open circuit voltage for 24 h and record the capacity as 100%.
2. Charge and discharge cycles: Constant current charge at 1.5 mA until the voltage hits 3.8V; Constant voltage charge at 3.8V until the current trip to 0.075 mA; Open circuit for 1 minute; Constant current discharge at −1.5 mA until the voltage hits 2.5V; Open circuit for 1 minute; Repeat the cycle procedure for 1200 subsequent cycles. Record the discharged capacity. Its ratio to the discharged capacity during the formation cycle is recorded as capacity retention in the unit of percentage.

### Materials

In an aspect, a plurality of materials was tested, as illustrated below:

| Material | Chemical name | Supplier |
|---|---|---|
| Celgard ® 2500 | Polypropylene | Celgard |
| Celgard ® 2340 | Polyethylene and | Celgard |
| | polypropylene | |
| Celgard ® 2320 | Polyethylene and | Celgard |
| | polypropylene | |
| Tonen V25CGD | Polyethylene | Tonen |
| PP 621P | Polypropylene | SABIC |
| Lexan ™ 105 | Polycarbonate | SABIC IP |
| Ultrason S3010 | Polysulfone | BASF |
| Radel R5000 | Polyphenylsulfone | Solvay |
| | | Specialty Polymers |
| Styron 686E | Polystyrene | Styron |
| ULTEM ™ 1010 | Polyetherimide | SABIC IP |
| ULTEM ™ CRS 5001 | Polyetherimide | SABIC IP |
| ULTEM ™ CRS 5011 | Polyetherimide | SABIC IP |

The electrolyte used in this study is LBC3015B from Capchem. It's a mixture of ethylene carbonate (EC), dimethyl carbonate (DMC), ethyl methyl carbonate (EMC) and LiPF₆. The EC, DMC and EMC ratio is 1:1:1, and the concentration of LiPF₆ is 1 mol/L.

### Solid Film Characterization

TABLE A
Solvent resistance in electrolyte solution

| | | | |
|---|---|---|---|
| | Normalized wet | Normalized dry | |
| | weight after | weight after | |
| | 21 days at | 21 days at | |
| Material | 55° C. (%) | 55° C. (%) | Comment |

Comparative examples

| | | | |
|---|---|---|---|
| Celgard ^{®} 2500 | 100% | 100% | Porous film |
| Tonen V25CGD | 100% | 100% | Porous film |

| | |
|---|---|
| Lexan ™ 105 | Significant dissolution |
| Ultrason S3010 | Significant dissolution |
| Radel R5000 | Significant dissolution |
| Styron 686E | Significant dissolution |
| ULTEM ™ 1010 | Significant dissolution |

Examples

| | | | |
|---|---|---|---|
| ULTEM ™ CRS 5001 | 110% | 101% | Solid film |

The data in Table A show that the polyethylene and polypropylene separator films have excellent solvent resistance again the electrolyte solution (1:1:1 EC:DMC:EMC and 1 mol/L LiPF₆), indicated by a normalized dry weight >90% (e.g., 90%-101%, 91%-101%, 92%-101%, 93%-101%, 94%-101%, 95%-101%, 96%-101%, 97%-101%, 98%-101%, 99%-101%, 100%-101%). The normalized dry weight was calculated as the dry weight, i.e. the weight of the sample after soaking for 21 days in the solution at 55° C. and subsequent drying to remove all solvent, divided by the starting weight, i.e. the initial weight of the sample prior to soaking in the solution. Additionally, these materials have a low degree of swelling (normalized wet weight ˜100%). The normalized wet weight was calculated as the wet weight, i.e. the weight of the sample after soaking for 21 days in the solution at 55° C. without drying the sample, divided by the starting weight, i.e. the initial weight of the sample prior to soaking in the solution.

The comparative examples of amorphous resins demonstrate significant dissolution of the polymer in the electrolyte solution (normalized dry weight <90%, mostly even complete dissolution).

The obtained data for the ULTEM™ CRS 5001 resin shows that the ULTEM™ CRS 5001 resin does not significantly dissolve in the electrolyte solution as proven by a normalized dry weight >90%, which means that the ULTEM™ CRS 5001 resin has excellent solvent resistance to the electrolyte solution. This is important for the application of ULTEM™ CRS 5001 in the application of a battery separator, as dissolution of the polymer in the electrolyte would significant change the physical structure of the separator, such as pore size and thickness. Significant dissolution of the separator in the electrolyte solution would also change the ionic transport properties through the separator and electrolyte, e.g. by changing the porous structure of the separator and/or changing the viscosity of the electrolyte solutions. Additionally, the ULTEM™ CRS 5001 resin shows limited swelling (normalized wet weight 110%). Limited swelling of the separator in the electrolyte solution is important, as significant swelling of the separator by the electrolyte solution may significantly change the physical performance of the separator, e.g. changing the mechanical stiffness and the temperature of deformation.

Solvent resistance of polymers is typically related to the relative solubility parameter (δ) difference [See C. M. Hansen, Hansen Solubility Parameters—A User's Handbook, 2nd edition]. A small difference in solubility parameter of polymer and solvent (Δδ) will typically lead to dissolution of the polymer in the solvent. Table B shows the total (δt), dispersive (δd), polar (δp) and hydrogen (δh) solubility parameters of typical electrolyte constituents.

TABLE B
Solubility parameters of carbonate solvents
often used in electrolyte compositions

| | Solubility parameters | | | |
|---|---|---|---|---|
| | δt | δd | δp | δh |
| Material | (MPa^{1/2}) | (MPa^{1/2}) | (MPa^{1/2}) | (MPa^{1/2}) |
| Ethyl carbonate^{a} | 29.6 | 19.4 | 21.7 | 5.1 |
| Dimethyl carbonate^{a} | 18.7 | 15.5 | 3.9 | 9.7 |
| Diethyl carbonate^{a} | 18.0 | 16.6 | 3.1 | 6.1 |
| Propyl carbonate^{a} | 27.2 | 20.0 | 18.0 | 4.1 |
| Ethyl methyl carbonate^{b} | 25.1 | 21.7 | 7.2 | 10.5 |
| 2,3-Butylene carbonate^{a} | 24.8 | 18.0 | 16.8 | 3.1 |
| Vinylene carbonate^{a} | 26.8 | 17.3 | 18.1 | 9.6 |

^{a}Data from C. M. Hansen, Hansen Solubility Parameters - A User's Handbook, 2^{nd} edition, Appendix, Table A. 1
^{b}Data from D. W. van Krevelen, Properties of Polymers, Elsevier, 2009

The solvent resistance of the ULTEM™ 1010, ULTEM™ CRS 5011 and ULTEM™ CRS 5001 polymer films was also tested against individual electrolyte solvents. Based on Table B, dimethyl carbonate (DMC), diethyl carbonate (DEC) and ethyl carbonate (EC) were used, as this covers the broadest range of solvent solubility parameters (18.0 to 29.6 MPa^{1/2}).

TABLE C
Solvent resistance in individual electrolyte solvents

| | Normalized dry weights after | | |
|---|---|---|---|
| | 21 days at 55° C. (%) | | |
| Material | EC | DMC | DEC |

Comparative example

| | |
|---|---|
| ULTEM ™ 1010 | Significant dissolution/ |
| | deformation in all solvents |

Examples

| | | | |
|---|---|---|---|
| ULTEM ™ CRS 5001 | 100 | 99 | 101 |
| ULTEM ™ CRS 5011 | 100 | 99 | 100 |

The data in Table C show that the solvent resistance of ULTEM™ CRS 5001 and ULTEM™ CRS 5011 is excellent (100+/−1% normalized dry weight) for all individual electrolyte solvents, suggesting an excellent solvent resistance (i.e. normalized dry weight >90%) of ULTEM™ CRS 5001 and ULTEM™ CRS 5011 over the whole electrolyte composition range (e.g. upon mixing EC, DMC and DEC in various ratios). The ULTEM™ 1010 shows significant dissolution/deformation in the solvents, quantitative weight analysis was not possible in this case.

TABLE D
High Temperature Melt Integrity

| | | | | |
|---|---|---|---|---|
| | Shrinkage | Deformation | Rupture | |
| | onset | temperature | temperature | |
| Material | (° C.) | (° C.) | (° C.) | Comment |

Examples

| | | | | |
|---|---|---|---|---|
| ULTEM ™ 1010 | 233 | 253 | 242 | Solvent casted |
| | | | | solid film |
| ULTEM ™ CRS 5001 | No | 237 | 252 | Melt extruded |
| | shrinkage | | | solid film |

Table D shows that the solid ULTEM™ 1010 and ULTEM™ CRS 5001 films provide excellent High Temperature Melt Integrity (HTMI) performance, with a very high 5% deformation temperature exceeding 230° C.

TABLE E
Contact Angle (measured with electrolyte solution)

| | |
|---|---|
| | Contact angle after |
| Material | 5 sec (°) |

Comparative examples

| | |
|---|---|
| PP 621P | 37.6 |
| UHMWPE | 49.0 |

Examples

| | |
|---|---|
| ULTEM ™ 1010 | 19.3 |
| ULTEM ™ CRS 5001 | 19.8 |

Table E shows that the solid ULTEM™ 1010 and ULTEM™ CRS 5001 films provide excellent wettability with the electrolyte solution (1:1:1 EC:DMC:EMC and 1 mol/L LiPF₆) as indicated by extremely low contact angle values (<20°). These contact angle values are significantly lower than the values obtained for solid PP and UHMWPE films (typically >35°).

TABLE F
Contact Angle (measured with individual solvents)

| | Contact angle after 5 sec (°) | | |
|---|---|---|---|
| | Composition and weight ratio of the solvent mixture | | |
| | DMC/EMC/EC | DMC/EMC/EC | DMC/EMC/EC |
| Material | 27/37/36 | 33/33/33 | 40/50/10 |

Comparative example

| | | | |
|---|---|---|---|
| PP 621P | 40.3 | 37.6 | 30.1 |

Examples

| | | | |
|---|---|---|---|
| ULTEM ™ 1010 | 11.2 | <10 | <10 |
| ULTEM ™ | 12.9 | 16.1 | <10 |
| CRS 5001 | | | |

Table F shows that the contact angle of solid PP film is relatively high over the whole range of solvent compositions tested (typically >30°). In contrast, the ULTEM™ 1010 and ULTEM™ CRS 5001 solid films show an extremely low contact angle (typically <15°) over a very broad composition range of solvents, indicating an outstanding wettability of the film by the solutions. The ULTEM™ 1010 and ULTEM™ CRS 5001 films show contact angles of less than about 30°, which is clearly below the comparative example of PP 621P.

### Porous Film Characterization

Porous membranes can be prepared using various methods. As an example, a porous membrane can be formed by solvent casting methods, stretching of extruded films and/or washing out solutes in an extruded film. Other methods can be used to form the separator. As a further example, porous membranes can be prepared having a total porosity ranging from 45-75%. Other ranges and porosity can be used.

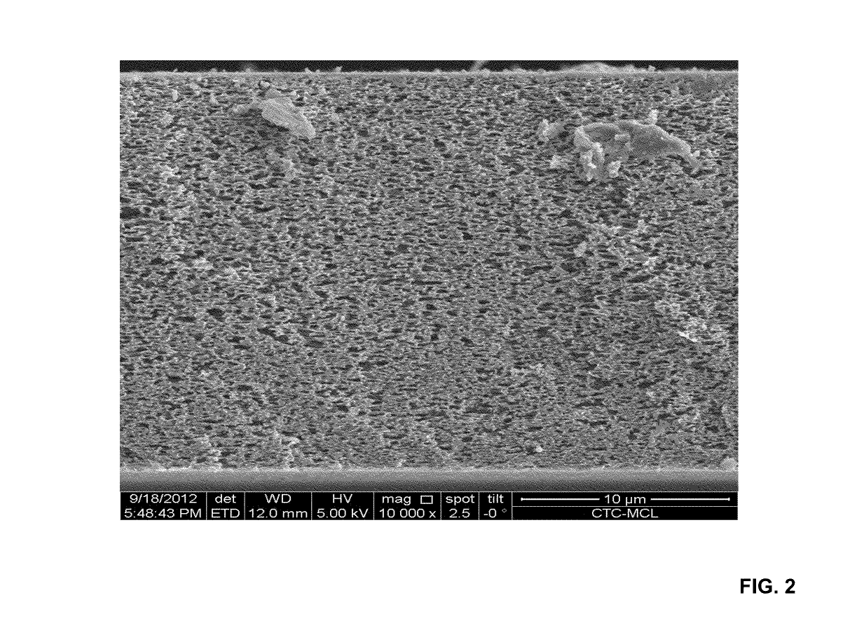

A porous ULTEM™ CRS 5001 separator was prepared via a solvent casting method. ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in a tetrahydrofuran (THF) bath overnight, and then dried at 120° C. under vacuum. FIG. 2 shows a representative morphology (cross-section) of the solvent casted ULTEM™ CRS 5001 separator (See Example 20).

TABLE G
Contact Angle (measured with electrolyte solution)

| | | |
|---|---|---|
| | Contact angle | Contact angle |
| | after 5 sec | after 30 sec |
| Material | (°) | (°) |

Comparative examples

| | | |
|---|---|---|
| Celgard ® 2500 | 51.3 | 41.9 |
| Celgard ® 2340 | 42.7 | 35.6 |
| Tonen V25CGD | 39.9 | 34.4 |

Example

| | | |
|---|---|---|
| ULTEM ™ CRS 5001 | 16.6 | <10 |
| (solvent casted) | | |

Table G shows that the contact angle of the Celgard and Tonen separators is high, typically 40 to 50° after 5 seconds. Even after the electrolyte droplet has been in contact with the separator for 30 seconds, the contact angle remains 35° or higher, indicating poor wettability of the Celgard and Tonen separators by the electrolyte solution. However, the as-prepared ULTEM™ CRS 5001 separator shows extremely low contact angle values of <10° after 30 seconds. Even after the short contact time of 5 seconds, the contact angle is already below about 20°, which means an almost instantaneous wetting of the separator by the electrolyte solution.

TABLE H
Contact Angle (measured with individual solvents)

| | Contact angle after 5 sec (°) | | |
|---|---|---|---|
| | Composition and ratio (wt %) | | |
| | of the solvent mixture | | |
| | DMC/EMC/EC | DMC/EMC/EC | DMC/EMC/EC |
| Material | 27/37/36 | 33/33/33 | 40/50/10 |

Comparative examples

| | | | |
|---|---|---|---|
| Celgard ® 2500 | 34.3 | 38.1 | 25.7 |
| Celgard ® 2340 | 39.6 | 39.2 | 23.0 |
| Tonen V25CGD | 26.6 | 23.4 | 18.8 |

Examples

| | | | |
|---|---|---|---|
| ULTEM ™ CRS 5001 | <10 | <10 | <10 |
| (solvent casted) | | | |

Table H shows that the contact angle of the Celgard and Tonen separators is relatively high over the whole range of solvent compositions tested (typically >25°). In contrast, the ULTEM™ CRS 5001 separator shows an extremely low contact angle (<10°) over a very broad composition range of solvents, indicating an outstanding and instantaneous wettability of the separator by the solvent mixtures.

TABLE I
High Temperature Melt Integrity

| | | | |
|---|---|---|---|
| | Shrinkage | Deformation | Rupture |
| | onset | temperature | temperature |
| Material | (° C.) | (° C.) | (° C.) |

Comparative examples

| | | | |
|---|---|---|---|
| Celgard ® 2500 (TD) | 157 | 160 | 169 |
| Celgard ® 2500 (MD) | 141 | 151 | N.A. |
| Celgard ® 2340 (TD) | 131 | 151 | 152 |
| Celgard ® 2340 (MD) | 109 | 119 | N.A. |
| Tonen V25CGD (TD) | 118 | 122 | 141 |
| Tonen V25CGD (MD) | 119 | 132 | 152 |

Examples

| | | | |
|---|---|---|---|
| ULTEM ™ CRS 5001 | 211 | 241 | 257 |
| (solvent casted) | | | |

Table I compares the HTMI performance of the ULTEM™ CRS 5001 separators to the Celgard and Tonen separators and shows an outstanding performance of the ULTEM™ CRS 5001 separator with a deformation temperature far exceeding 200° C., whereas the Celgard and Tonen separators already deform at temperatures ranging from 119-160° C. Additionally, the rupture temperature of the ULTEM™ CRS 5001 separator exceeds 200° C., which is a significant improvement as compared to the rupture temperatures of the Celgard and Tonen separators, which is <170° C.

Table J illustrates a comparison of the ionic conductivities of the ULTEM™ CRS 5001 separator to that of the commercial polyolefin separators (Celgard and Tonen). It is clearly seen that the ULTEM™ CRS 5001 separator comprises an ionic conductivity similar to or higher than the commercial polyolefin separator films. The number in parenthesis indicates the standard deviation based on 3 measurements.

TABLE J
Ionic conductivity of separators

| Sample | Ionic conductivity (mS/cm) |
|---|---|
| Celgard ® 2500 | 1.58 (0.14) |
| Celgard ® 2340 | 0.93 (0.05) |
| Celgard ® 2320 | 1.00 (0.05) |
| Tonen V25CGD | 0.88 (0.08) |
| ULTEM ™ CRS 5001 | 1.54 (0.08) |
| (solvent casted) | |

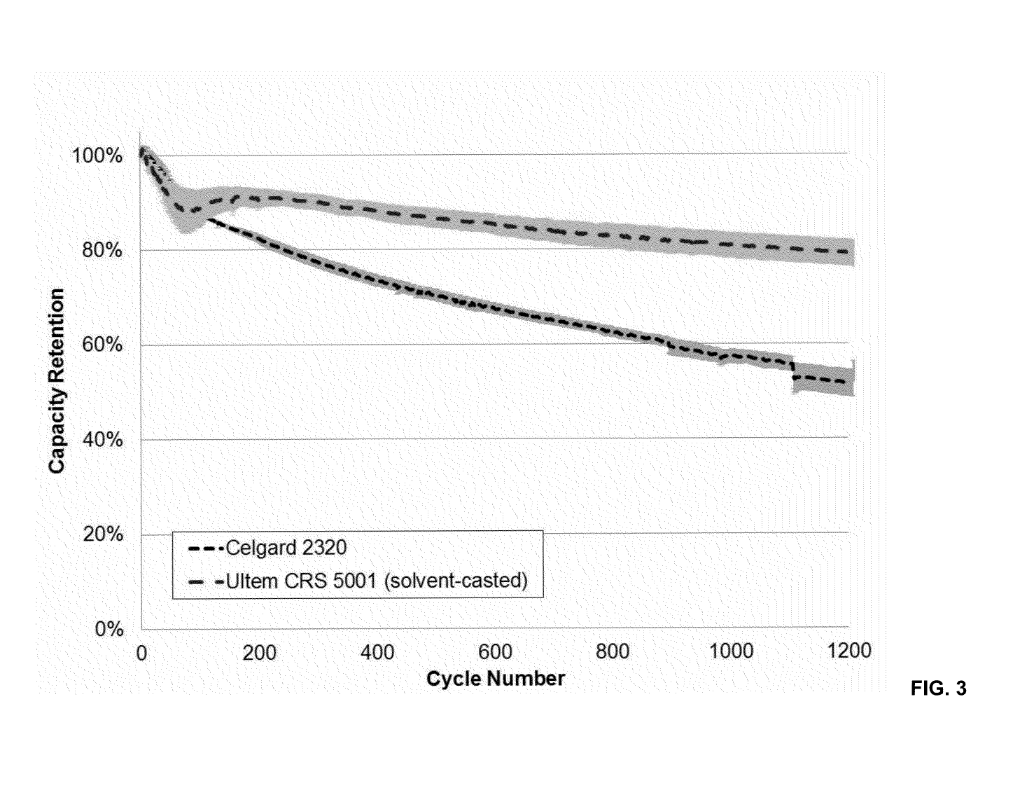

The ULTEM™ CRS 5001 separator and the Celgard 2320 separator were both tested in a 2016 coin cell. The cathode is LiFePO₄ and the anode is a lithium metal slice. The above-described electrolyte was used. The cycle life was tested at constant charge and discharge rates of about 0.5 C. The cycle life over 1200 cycles for the 2 separators is presented in FIG. 3.

FIG. 3 shows the discharge capacity retention averaged over 3 cells per separator type, using Celgard® 2320 and the ULTEM™ CRS 5001 separator. Each of the 3 cells tested per separator type is a full replicate. The vertical error bars in FIG. 3 represent the standard deviation on the capacity retention of the 3 cells. Celgard® 2320 is chosen as the commercial comparative separator, but a similar capacity retention profile was observed for e.g. Celgard® 2500. Surprisingly, when comparing the capacity retention data, the ULTEM™ CRS 5001 separator demonstrates a significantly better cycle performance as compared to the Celgard® 2320 separator. As an example, the capacity retention at 1200 cycles for the Celgard® 2320 is 52%, while that of the solvent-casted ULTEM™ CRS 5001 is 79%. Generally, the battery industry uses 80% capacity retention as a distinct marker to evaluate battery life. For these LiFePO₄/graphite coin cells with the Celgard® 2320 separator, the cycle life under these test conditions would equal ˜250 cycles. Surprisingly, the cells with the ULTEM™ CRS 5001 separator shows a significantly higher cycle life of ˜1100 cycles.

As shown and described herein, polyetherimides (PEI) based on para-phenylene diamines (SABIC's ULTEM™ CRS 5000 series) are excellent materials for battery separator films with a combination of outstanding performance characteristics, such as high compatibility with electrolyte, high solvent resistance and a high melt integrity temperature exceeding 180° C. PEI fulfill the critical requirement to be resistant to the battery electrolyte solution, also at elevated temperatures of 55° C. Additionally, PEI show an extremely low contact angle to the electrolyte solution, which favors separator wettability and electrolyte retention, allowing for a reduced electrolyte filling time during cell production and improved operating cell performance. Separators from PEI based on para-phenylene diamines have very high melt integrity (exceeding 180° C.) and have a high elastic modulus over the whole range of cell operation. The proposed materials can both be melt and solution processed into porous films with specific ionic conductivities that are equal to or superior than typical commercial polyolefin-based separators. Additionally, these PEI separators show a surprising improvement in cycle life of batteries.

### Liquid-Induced Phase Separation (LIPS) Process

In an aspect, solvent resistant ULTEM™ CRS 5000 polymers can be dissolved in a phenolic solvent (such as 2-chloro-phenol) at elevated temperature. A co-solvent, which forms a minimum melting point solvent mixture with solvent, can be added to keep the dope solution fluid for casting at room temperature. Porous structures can be formed by immersion of the casted, wet film in the coagulation bath comprising the non-solvent for the polymer, and removing the solvent at 120° C. under vacuum.

In an aspect, a method for preparing a porous material (e.g., film, separator, etc.) can comprise providing a pourable, polymer solution comprising a chemical resistant polymer in a solvent and forming a porous film from the polymer solution. As an example, forming a porous film from the polymer solution can comprise casting a wet, thin film from the polymer solution. As another example, forming a porous film from the polymer solution can comprise immersing the polymer solution in a coagulation bath comprising a non-solvent to the polymer. In an aspect, the non-solvent can comprise water, a pyrrolidone-based solvent, acetone, isopropanol, tetrahydrofuran, dichloromethane, dimethyl acetate, EDC, DMSO, anisole, ODCB, or a combination thereof.

In another aspect, the polymer can comprise a polyetherimide, polyimide, polyketone, or a polyphenylene sulfide, or a combination thereof. As an example, the polymer comprises a polyetherimide based on para-phenylene diamines.

In an aspect, the solvent can comprise a phenolic solvent. As an example, the solvent can comprise 4-chloro-3-methyl-phenol, 4-chloro-2-methyl-phenol, 2,4-dichloro-6-methyl-phenol, 2,4-dichloro-phenol, 2,6-dichloro-phenol, 4-chloro-phenol, 2-chloro-phenol, o-cresol, m-cresol, p-cresol, 4-methoxy-phenol, catechol, benzoquinone, 2,3-xylenol, 2,6-xylenol, or resorcinol, or a combination thereof. As a further example, the polymer solution can comprise inorganic particles.

In an aspect, the porosity of the porous film can be tuned in the range of from about 10% to about 90%. As an example, the average pour size of the porous film can be tuned from about 0.01 μm to about 10 gm. In another aspect, the stress at 2% strain offset of the porous film can be modified ranging from about 200 to about 3000 psi. In a further aspect, the MacMullin number of the porous film is equal to or lower than 15.

In an aspect, the porous film can be implemented as a separator. As an example, the separator can exhibit 5% deformation at temperatures equal to or exceeding 180° C. As another example, the separator can have an electrolyte contact angle equal to or lower than 30°. As a further example, the separator can be resistant to, but highly compatible with electrolyte solutions.

In an aspect, the porous film can be used as a substrate for further coating (polymer, ceramics) or as a component for a more complex separator construction (multilayer).

In an aspect, an energy storage device can comprise the porous film. As an example, the porous film can be disposed as a separator in an electrochemical cell. As another example, the electrochemical cell is a lithium ion battery. As a further example, the electrochemical cell is an electrolytic capacitor.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Materials

In an aspect, ULTEM™ CRS 5001 polymer was dissolved in a phenolic solvent (such as 4-chloro-2-methyl-phenol or p-cresol) at elevated temperature, then a co-solvent which forms a minimum melting point solvent mixture with solvent was added to keep the dope solution fluid for casting at room temperature. In another aspect, ULTEM™ CRS 5001 polymer was dissolved in a phenolic solvent (such as 2-chloro-phenol) at elevated temperature. Porous structures were formed by casting a wet, thin film on a glass plate, immersion of the casted, wet film in the coagulation bath comprising the non-solvent for the polymer, and removing any residual solvent in the membrane at about 120° C. under vacuum. Alternatively, multilayer porous structures were formed by casting a wet, thin film on a porous polyethylene film (PE, 8 micron thick, apparent porosity 24%), immersion of the casted, wet film on top of the porous substrate in the coagulation bath comprising the non-solvent for the polymer, and removing any residual solvent in the membrane at about 60° C. under vacuum.

The apparent porosity of the separators was calculated. Films were cut to a round slice with 19 mm diameter by a die; sample thickness is measure by a spiral micrometer (Mitutoyo) and its weight is measured by an electric balance with ±0.05% variance. The apparent porosity is then calculated by the following formula:

$$Apparent porosity = 1 - \frac{Sample Total Weight}{Resin density \times Sample Thickness \times Sample area }$$

The tensile strength was measured by TA Instrument's Q800 DMA on rectangular (3×20 mm) film samples. The methods for tensile strength utilize a film tension clamp on a Dynamic Mechanical Analyzer (DMA) using a strain ramp. The following experimental parameters were used:
a. Test: Strain Ramp
b. Preload Force: 0.001 N
c. Initial Strain: 0.5%
d. Isothermal Temperature: 30° C.
e. Final Strain: 250%
f. Ramp rate: 5%/min
g. Ensure that the sample is properly loaded into the film tension clamp and that all required measurements have been made and are accurate.

### Results

Lithium ion battery separators require a specific micro-structure to meet the balance between mechanical stiffness/strength and ionic conductivity. The conditions used during the phase separation process influence the pore structure and, therefore, the final separator performance. The examples below show how the final structure and properties of the separators depend on solvent system, polymer concentration and coagulation bath used for the phase separation process, using ULTEM™ CRS 5001 (SABIC) as the base resin. The separators' Young's modulus (stiffness), ionic conductivity, high temperature melt integrity (HTMI) and electrolyte wettability were measured.

Table AA lists the LIPS process parameters, which are shown to be the most important key factors affecting the final structures of the formed separators. Because of its molecular structure, ULTEM™ CRS 5001 has exceptional solvent resistance and its solubility in most common solvents is, therefore, low. For that reason, a mixture of solvent systems of chloro-2-methyl-phenol, 2-chloro-phenol and/or p-cresol is used in order to achieve the required pourable polymer system at room temperature at polymer concentrations of 15-20 wt %. Note that the used solvents and mixtures thereof in the examples in Table AA are all liquids at room temperature. The coagulation bath (in terms of composition and temperature) plays a key role to control the final structures and to achieve the desired separator performance. As shown in Table AA, 7 types of coagulation solvents were used, either at 22 or 40° C.

TABLE AA
LIPS process parameters

| | | ULTEM ™ | | |
|---|---|---|---|---|
| | | CRS 5001 | | |
| Example | | Concentration | Coagulation bath | |
| ID | Solvent system | (wt %) | composition | Temperature |
| Ex. 1 | 1:1 (w/w) of 4- | 15% | Methanol | 22 ± 2° C. |
| | chloro-2-methyl- | | | |
| | phenol/p-cresol | | | |
| Ex. 2 | 1:1 (w/w) of 4- | 15% | Ethanol | 22 ± 2° C. |
| | chloro-2-methyl- | | | |
| | phenol/p-cresol | | | |
| Ex. 3 | 1:1 (w/w) of 4- | 15% | Butanol | 22 ± 2° C. |
| | chloro-2-methyl- | | | |
| | phenol/p-cresol | | | |
| Ex. 4 | 5:1 (w/w) of 4- | 15% | Isopropanol | 22 ± 2° C. |
| | chloro-2-methyl- | | | |
| | phenol/p-cresol | | | |
| Ex. 5 | 5:1 (w/w) of 4- | 15% | 3:1 (v/v) of | 22 ± 2° C. |
| | chloro-2-methyl- | | Isopropanol/ | |
| | phenol/p-cresol | | p-Cresol | |
| Ex. 6 | 5:1 (w/w) of 4- | 20% | Isopropanol | 22 ± 2° C. |
| | chloro-2-methyl- | | | |
| | phenol/p-cresol | | | |
| Ex. 7 | 5:1 (w/w) of 4- | 20% | 3:1 (v/v) of | 22 ± 2° C. |
| | chloro-2-methyl- | | Isopropanol/ | |
| | phenol/p-cresol | | p-Cresol | |
| Ex. 8 | 1:1 (w/w) of 4- | 15% | Isopropanol | 22 ± 2° C. |
| | chloro-2-methyl- | | | |
| | phenol/p-cresol | | | |
| Ex. 9 | 1:1 (w/w) of 4- | 15% | 3:1 (v/v) of | 22 ± 2° C. |
| | chloro-2-methyl- | | Isopropanol/ | |
| | phenol/p-cresol | | p-Cresol | |
| Ex. 10 | 1:1 (w/w) of 4- | 17% | Isopropanol | 22 ± 2° C. |
| | chloro-2-methyl- | | | |
| | phenol/p-cresol | | | |
| Ex. 11 | 1:1 (w/w) of 4- | 17% | 3:1 (v/v) of | 22 ± 2° C. |
| | chloro-2-methyl- | | Isopropanol/ | |
| | phenol/p-cresol | | p-Cresol | |
| Ex. 12 | 1:1 (w/w) of 4- | 17% | Ethyl acetate | 22 ± 2° C. |
| | chloro-2-methyl- | | | |
| | phenol/p-cresol | | | |
| Ex. 13 | 1:1 (w/w) of 4- | 17% | Acetone | 22 ± 2° C. |
| | chloro-2-methyl- | | | |
| | phenol/p-cresol | | | |
| Ex. 14 | 1:1 (w/w) of 4- | 17% | Heptane | 22 ± 2° C. |
| | chloro-2-methyl- | | | |
| | phenol/p-cresol | | | |
| Ex. 15 | 1:1 (w/w) of 4- | 17% | 1-Methyl-2- | 22 ± 2° C. |
| | chloro-2-methyl- | | pyrrolidone (NMP) | |
| | phenol/p-cresol | | | |
| Ex. 16 | 2-chloro-phenol | 13% | Tetrahydrofuran | 22 ± 2° C. |
| Ex. 17 | 2-chloro-phenol | 13% | Tetrahydrofuran | 40 ± 1° C. |
| Ex. 18 | 2-chloro-phenol | 13% | 3:1 (v/v) of | 22 ± 2° C. |
| | | | Tetrahydrofuran/ | |
| | | | 2-chloro-phenol | |
| Ex. 19 | 2-chloro-phenol | 13% | 3:1 (v/v) of | 40 ± 1° C. |
| | | | Tetrahydrofuran/ | |
| | | | 2-chloro-phenol | |
| Ex. 20 | 1:1 (w/w) of 4- | 17% | Tetrahydrofuran | 22 ± 2° C. |
| | chloro-2-methyl- | | | |
| | phenol/p-cresol | | | |
| Ex. 21 | 1:1 (w/w) of 4- | 17% | Tetrahydrofuran | 40 ± 1° C. |
| | chloro-2-methyl- | | | |
| | phenol/p-cresol | | | |
| Ex. 22 | 1:1 (w/w) of 4- | 17% | 3:1 (v/v) of | 22 ± 2° C. |
| | chloro-2-methyl- | | Tetrahydrofuran/ | |
| | phenol/p-cresol | | p-cresol | |
| Ex. 23 | 1:1 (w/w) of 4- | 17% | 3:1 (v/v) of | 40 ± 1° C. |
| | chloro-2-methyl- | | Tetrahydrofuran/ | |
| | phenol/p-cresol | | p-cresol | |
| Ex. 24 | 1:1 (w/w) of 4- | 17% | Ethyl acetate | 21 ± 2° C. |
| | chloro-2-methyl- | | (EA) | |
| | phenol/p-cresol | | | |
| Ex. 25 | 1:1 (w/w) of 4- | 17% | Acetone | 21 ± 2° C. |
| | chloro-2-methyl- | | | |
| | phenol/p-cresol | | | |
| Ex. 26 | 1:1 (w/w) of 4- | 17% | THF | 21 ± 2° C. |
| | chloro-2-methyl- | | | |
| | phenol/p-cresol | | | |
| Ex. 27 | 2-chloro-phenol | 13% | 3:1 (v/v) of | 40 ± 1° C. |
| | | | THF/2-chloro- | |
| | | | phenol | |
| Ex. 28 | 2-chloro-phenol | 13% | 3:1 (v/v) of | 40 ± 1° C. |
| | | | THF/2-chloro- | |
| | | | phenol | |
| Ex. 29 | 2-chloro-phenol | 13% | 3:1 (v/v) of | 40 ± 1° C. |
| | | | THF/2-chloro- | |
| | | | phenol | |

In Example 1, ULTEM™ CRS 5001 polymer was dissolved in 4-chloro-2-methyl-phenol/p-cresol (1:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in a methanol bath overnight, and then dried at 120° C. under vacuum.

In Example 2, ULTEM™ CRS 5001 polymer was dissolved in 4-chloro-2-methyl-phenol/p-cresol (1:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in an ethanol bath overnight, and then dried at 120° C. under vacuum.

In Example 3, ULTEM™ CRS 5001 polymer was dissolved in 4-chloro-2-methyl-phenol/p-cresol (1:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in a butanol bath overnight, and then dried at 120° C. under vacuum.

In Example 4, ULTEM™ CRS 5001 polymer was dissolved in 4-chloro-2-methyl-phenol/p-cresol (5:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in an isopropanol bath overnight, and then dried at 120° C. under vacuum.

In Example 5, ULTEM™ CRS 5001 polymer was dissolved in 4-chloro-2-methyl-phenol/p-cresol (5:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in an isopropanol/p-cresol (in 3:1 ratio) as coagulation bath overnight. After rinsing the formed membrane with isopropanol several times, the sample was dried at 120° C. under vacuum.

In Example 6, ULTEM™ CRS 5001 polymer was dissolved in 4-chloro-2-methyl-phenol/p-cresol (5:1 w/w) solvent mixture at 120° C. The polymer concentration in the dope solution was 20%. The dope solution was cooled down to room temperature and was then casted on a glass substrate with a bird applicator (slot size: 100 μm) at room temperature. The casted film was immersed in an isopropanol bath overnight, and then dried at 120° C. under vacuum.

In Example 7, ULTEM™ CRS 5001 polymer was dissolved in 4-chloro-2-methyl-phenol/p-cresol (5:1 w/w) solvent mixture at 120° C. The polymer concentration in the dope solution was 20%. The dope solution was cooled down to room temperature and was then casted on a glass substrate with a bird applicator (slot size: 100 μm) at room temperature. The casted film was immersed in an isopropanol/p-cresol (in 3:1 ratio) as coagulation bath overnight. After rinsing the formed membrane with isopropanol several times, the sample was dried at 120° C. under vacuum.

In Example 8, ULTEM™ CRS 5001 polymer was dissolved in 4-chloro-2-methyl-phenol/p-cresol (1:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in an isopropanol bath overnight, and then dried at 120° C. under vacuum.

In Example 9, ULTEM™ CRS 5001 polymer was dissolved in 4-chloro-2-methyl-phenol/p-cresol (1:1 w/w) solvent mixture at 120° C. The polymer concentration in the dope solution was 15%. The dope solution was cooled down to room temperature and was then casted on a glass substrate with a bird applicator (slot size: 100 μm) at room temperature. The casted film was immersed in an isopropanol/p-cresol (in 3:1 ratio) as coagulation bath overnight. After rinsing the formed membrane with isopropanol several times, the sample was dried at 120° C. under vacuum.

In Example 10, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 100 μm) at room temperature. The casted film was immersed in an isopropanol bath overnight, and then dried at 120° C. under vacuum.

In Example 11, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 100 μm) at room temperature. The casted film was immersed in an isopropanol/p-cresol (in 3:1 ratio) as coagulation bath overnight. After rinsing the formed membrane with isopropanol several times, the sample was dried at 120° C. under vacuum.

In Example 12, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in an ethyl acetate bath overnight, and then dried at 120° C. under vacuum.

In Example 13, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in an acetone bath overnight, and then dried at 120° C. under vacuum.

In Example 14, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in a heptane bath overnight, and then dried at 120° C. under vacuum.

In Example 15, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in a 1-methyl-2-pyrrolidone (NMP) bath overnight, and then dried at 120° C. under vacuum.

In Example 16, ULTEM™ CRS 5001 polymer was dissolved in 2-Cl-phenol at 120° C. The polymer concentration in the dope solution was 13%. The dope solution was cooled down to room temperature and was then casted on a glass substrate with a bird applicator (slot size: 50 μm) at room temperature. The casted film was immersed in a tetrahydrofuran bath overnight, and then dried at 120° C. under vacuum.

In Example 17, ULTEM™ CRS 5001 polymer was dissolved in 2-Cl-phenol at 120° C. The polymer concentration in the dope solution was 13%. The dope solution was cooled down to 40° C. and was then casted on a glass substrate with a bird applicator (slot size: 50 μm). The casted film was immersed in a tetrahydrofuran bath overnight. Both of the dope/coagulation baths and the glass substrate were kept at 40° C. during the processing. The sample was dried at 120° C. under vacuum.

In Example 18, ULTEM™ CRS 5001 polymer was dissolved in 2-Cl-phenol at 120° C. The polymer concentration in the dope solution was 13%. The dope solution was cooled down to room temperature and was then casted on a glass substrate with a bird applicator (slot size: 50 μm) at room temperature. The casted film was immersed in a tetrahydrofuran/2-Cl-phenol mixture bath (3:1 v/v) overnight. After rinsing the formed membrane with THF several times, the sample was dried at 120° C. under vacuum.

In Example 19, ULTEM™ CRS 5001 polymer was dissolved in 2-Cl-phenol at 120° C. The polymer concentration in the dope solution was 13%. The dope solution was cooled down to 40° C. and was then casted on a glass substrate with a bird applicator (slot size: 50 μm). The casted film was immersed in a tetrahydrofuran/2-Cl-phenol mixture bath (3:1 v/v) overnight. Both of the dope/coagulation baths and the glass substrate were kept at 40° C. during the processing. After rinsing the formed membrane with THF several times, the sample was dried at 120° C. under vacuum.

In Example 20, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in a tetrahydrofuran bath overnight, and then dried at 120° C. under vacuum.

In Example 21, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to 40° C. and was then casted on a glass substrate with a bird applicator (slot size: 50 μm). The casted film was immersed in a tetrahydrofuran bath overnight. Both of the dope/coagulation baths and the glass substrate were kept at 40° C. during the processing. The sample was dried at 120° C. under vacuum.

In Example 22, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a glass substrate with a bird applicator (slot size: 50 μm) at room temperature. The casted film was immersed in a tetrahydrofuran/p-cresol mixture bath (3:1 v/v) overnight After rinsing the formed membrane with THF several times, the sample was dried at 120° C. under vacuum.

In Example 23, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to 40° C. and was then casted on a glass substrate with a bird applicator (slot size: 50 μm). The casted film was immersed in a tetrahydrofuran/p-cresol mixture bath (3:1 v/v) overnight. Both of the dope/coagulation baths and the glass substrate were kept at 40° C. during the processing. After rinsing the formed membrane with THF several times, the sample was dried at 120° C. under vacuum.

In Example 24, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a porous polyethylene substrate (8 micron thick) with a bird applicator (slot size: 50 μm). The casted film was immersed in an ethyl acetate bath overnight and then dried at 60° C. under vacuum.

In Example 25, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a porous polyethylene substrate (8 micron thick) with a bird applicator (slot size: 50 μm). The casted film was immersed in an acetone bath overnight and then dried at 60° C. under vacuum.

In Example 26, ULTEM™ CRS 5001 polymer was dissolved in 4-chloro-2-methyl-phenol/p-cresol (1:1 w/w) solvent mixture at 120° C. The polymer concentration in the dope solution was 17%. The dope solution was cooled down to room temperature and was then casted on a porous polyethylene substrate (8 micron thick) with a bird applicator (slot size: 50 μm). The casted film was immersed in a THF bath overnight and then dried at 60° C. under vacuum.

In Example 27, ULTEM™ CRS 5001 polymer was dissolved in 2-Cl-phenol at 120° C. The polymer concentration in the dope solution was 13%. The dope solution was cooled down to 40° C. and was then casted on a porous polyethylene substrate (8 micron thick) with a bird applicator (slot size: 25 μm). The casted film was immersed in a tetrahydrofuran/2-Cl-phenol 3:1 (v/v) bath overnight. Both of the dope/coagulation baths and the glass substrate were kept at 40° C. during the processing. After rinsing the formed membrane with THF several times, the sample was dried at 60° C. under vacuum.

In Example 28, ULTEM™ CRS 5001 polymer was dissolved in 2-Cl-phenol at 120° C. The polymer concentration in the dope solution was 13%. The dope solution was cooled down to 40° C. and was then casted on a porous polyethylene substrate (8 micron thick) with a bird applicator (slot size: 50 μm). The casted film was immersed in a tetrahydrofuran/2-Cl-phenol 3:1 (v/v) bath overnight. Both of the dope/coagulation baths and the glass substrate were kept at 40° C. during the processing. After rinsing the formed membrane with THF several times, the sample was dried at 60° C. under vacuum.

In Example 29, ULTEM™ CRS 5001 polymer was dissolved in 2-Cl-phenol at 120° C. The polymer concentration in the dope solution was 13%. The dope solution was cooled down to 40° C. and was then casted on a porous polyethylene substrate (8 micron thick) with a bird applicator (slot size: 75 μm). The casted film was immersed in a tetrahydrofuran/2-Cl-phenol 3:1 (v/v) bath overnight. Both of the dope/coagulation baths and the glass substrate were kept at 40° C. during the processing. After rinsing the formed membrane with THF several times, the sample was dried at 60° C. under vacuum.

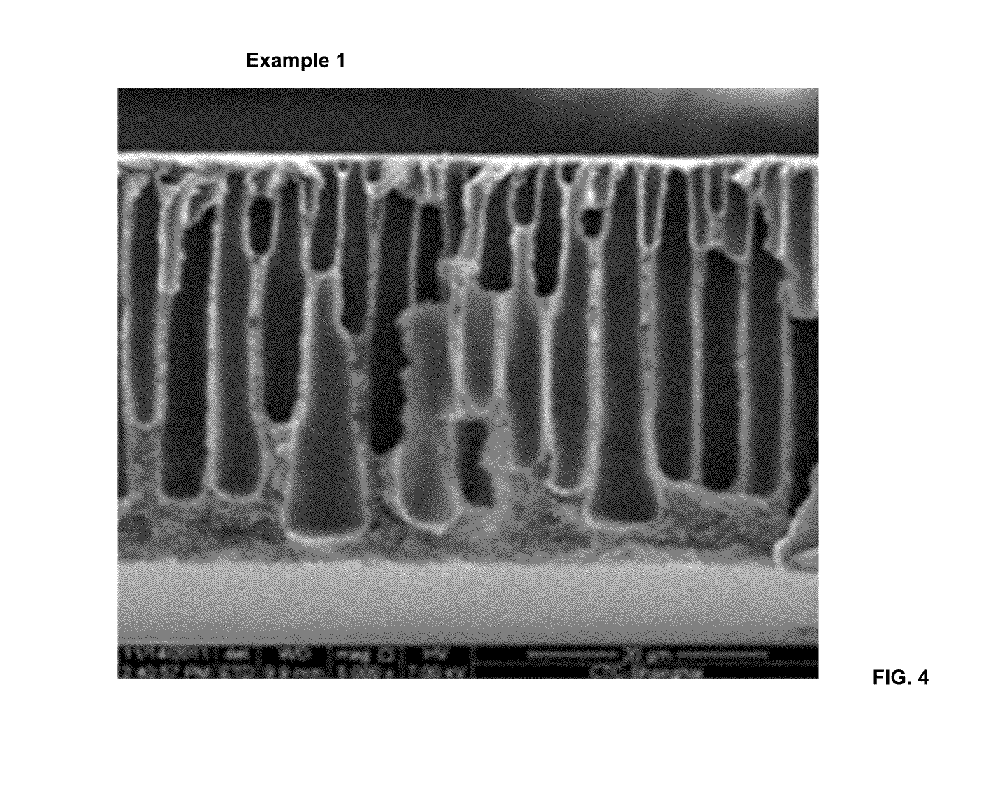

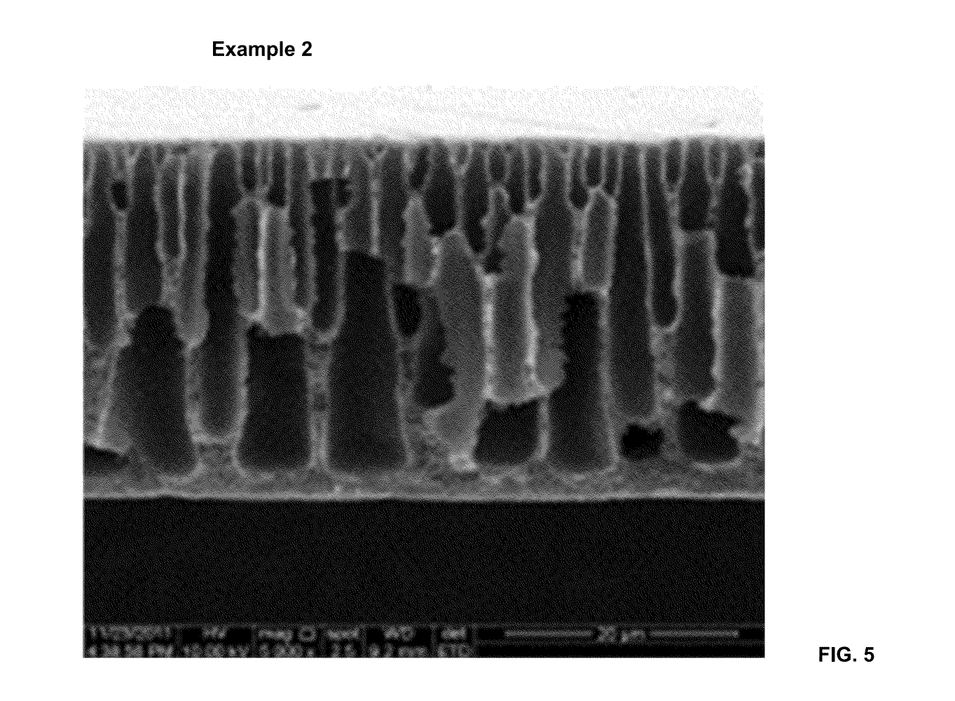

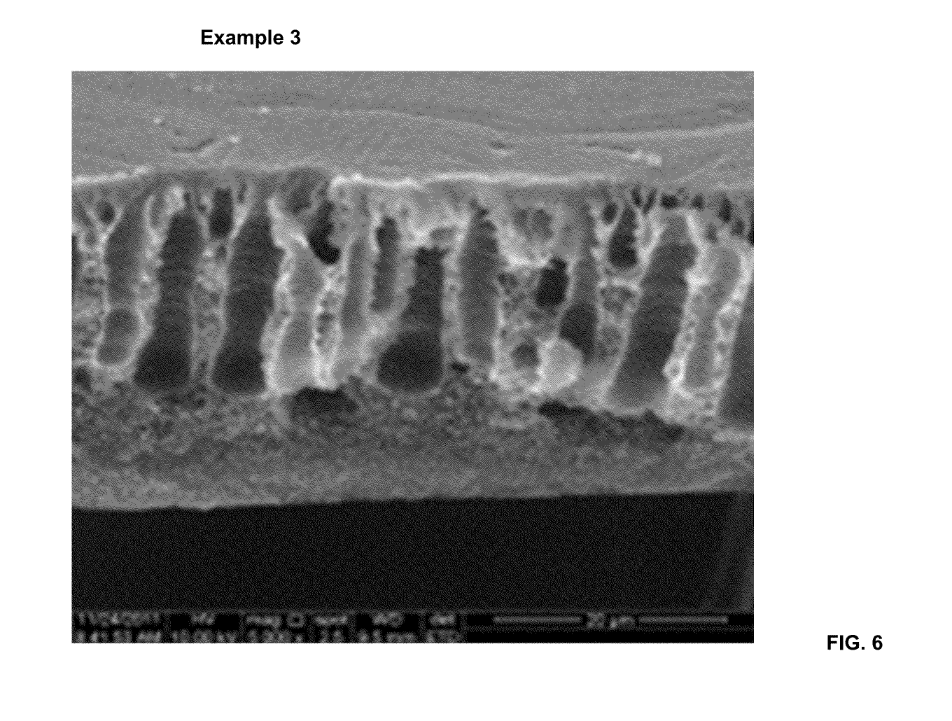

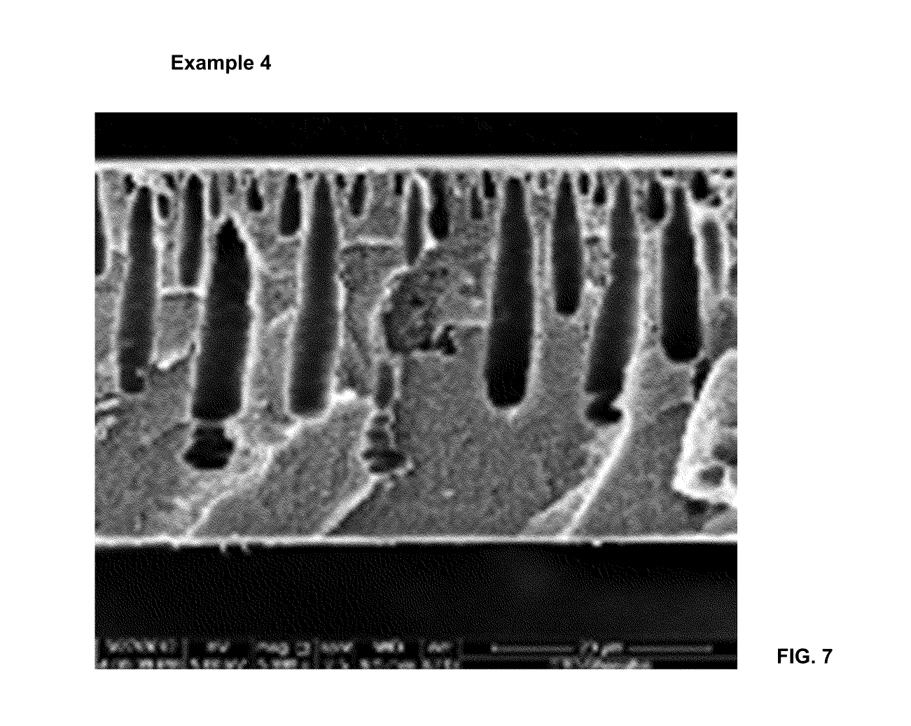

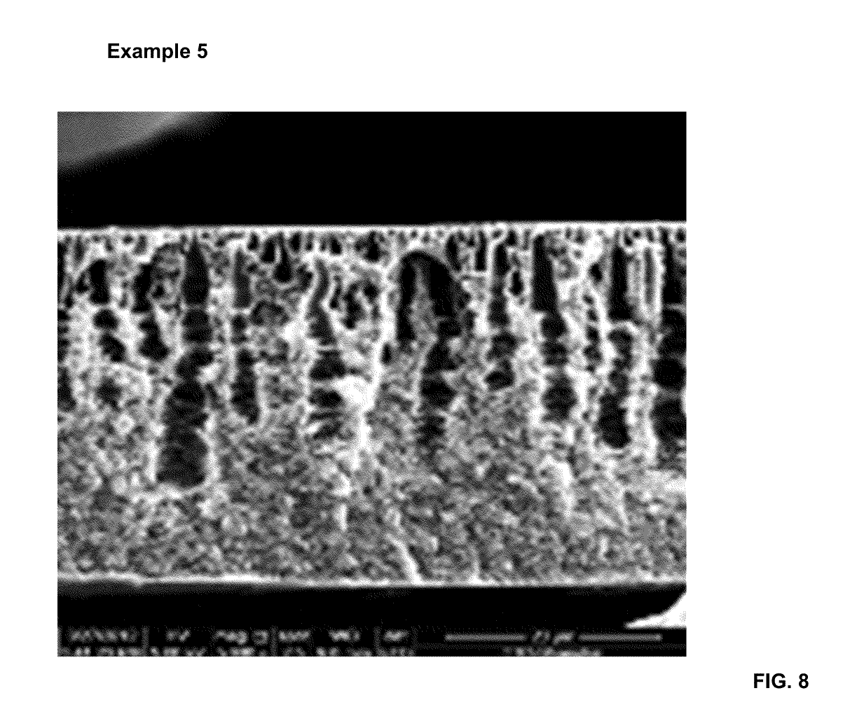

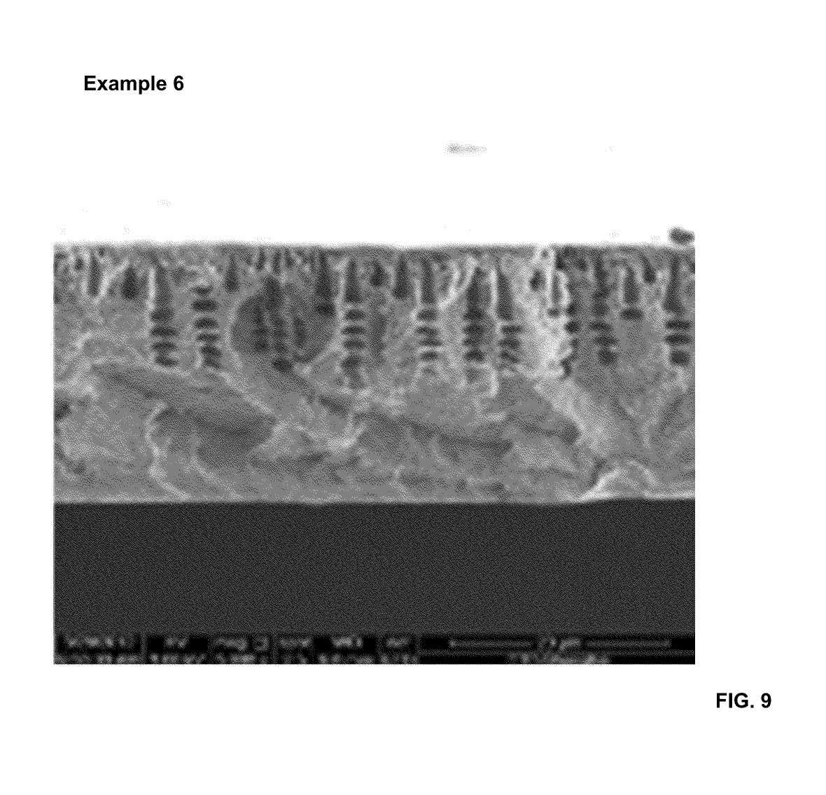

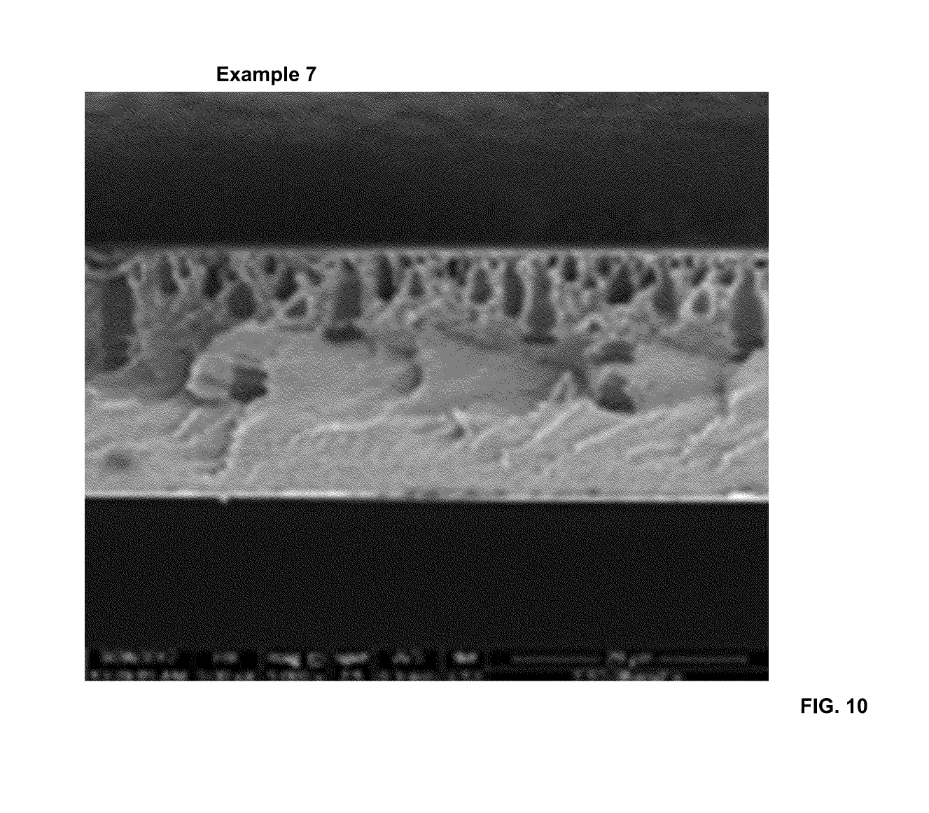

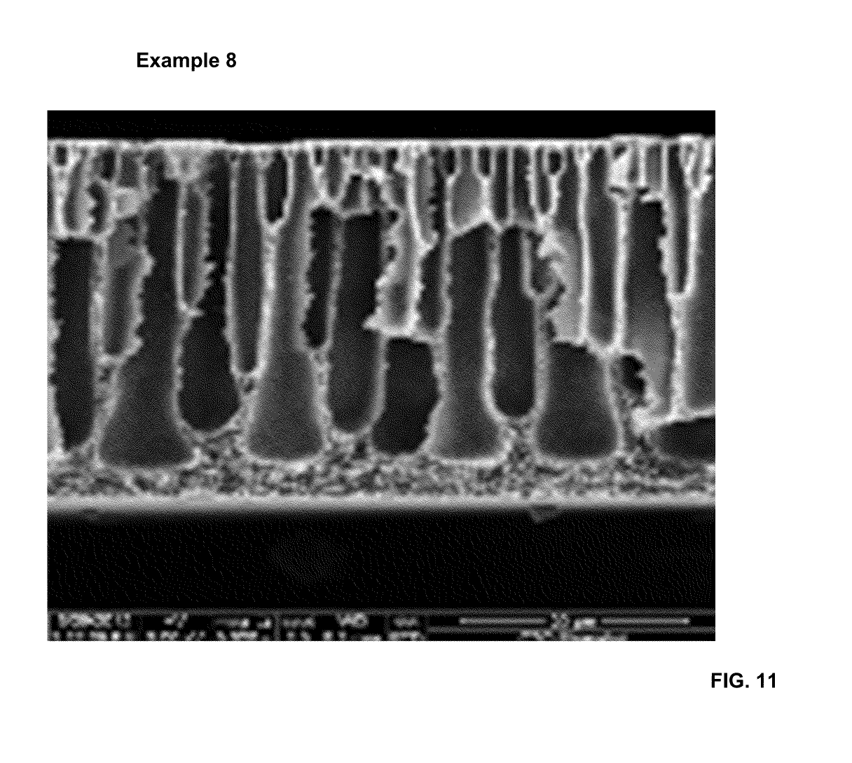

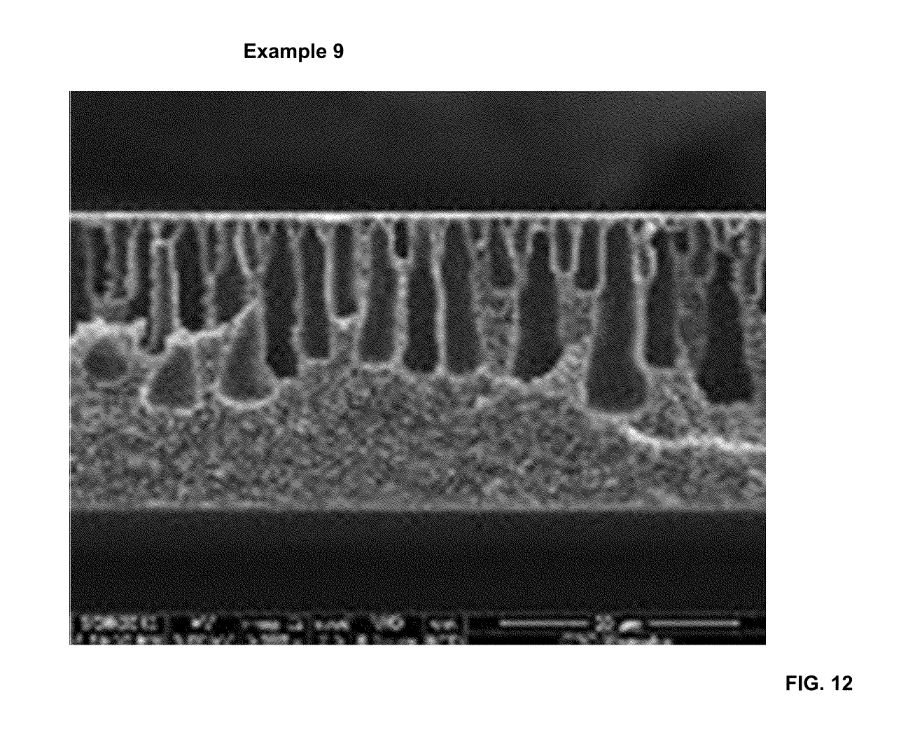

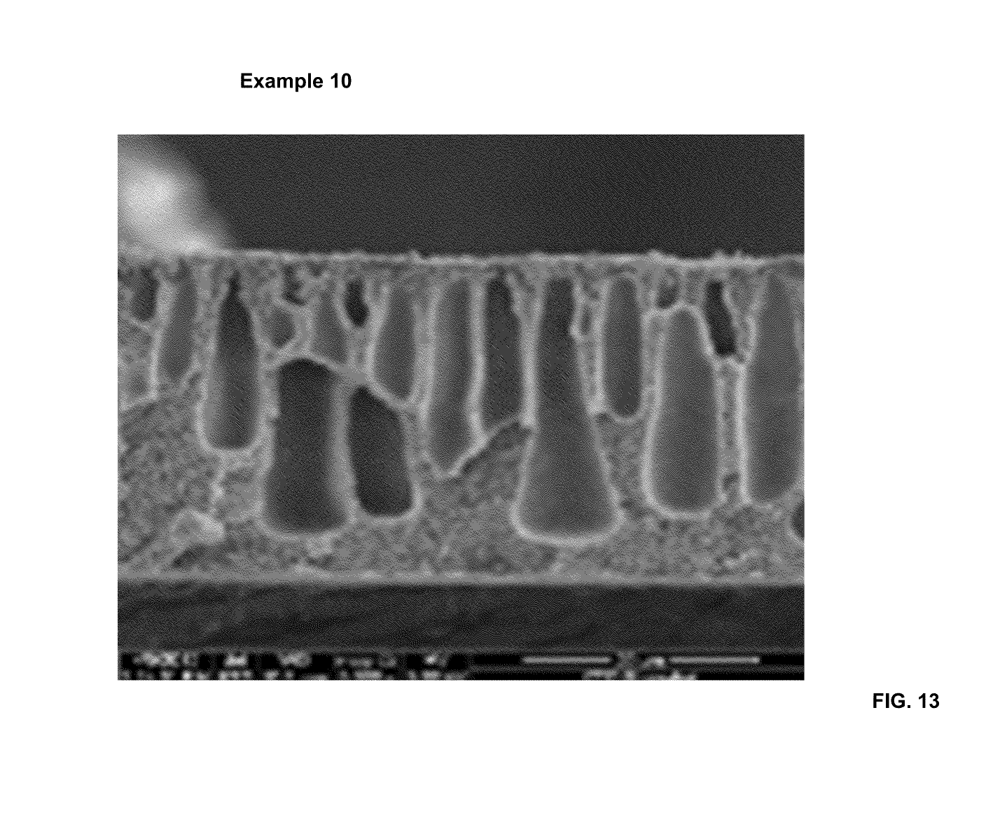

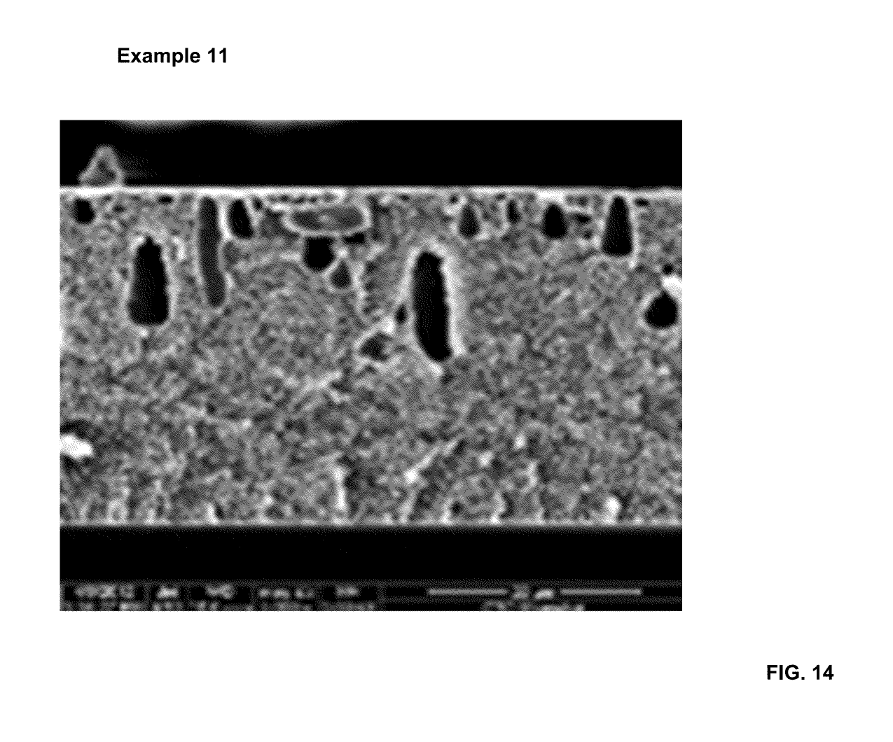

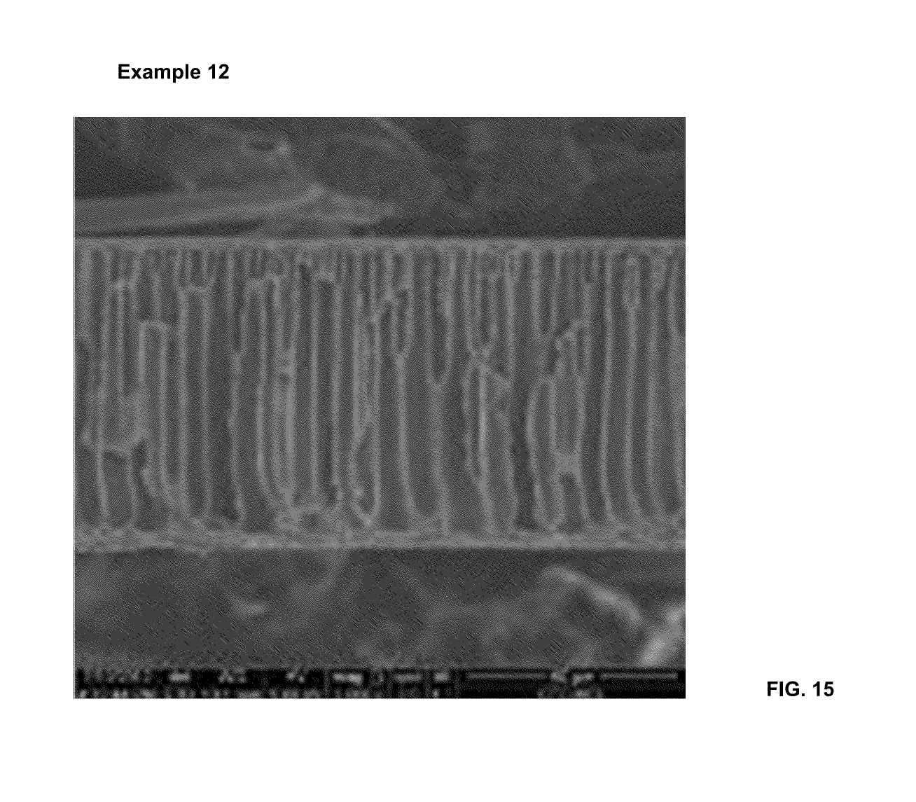

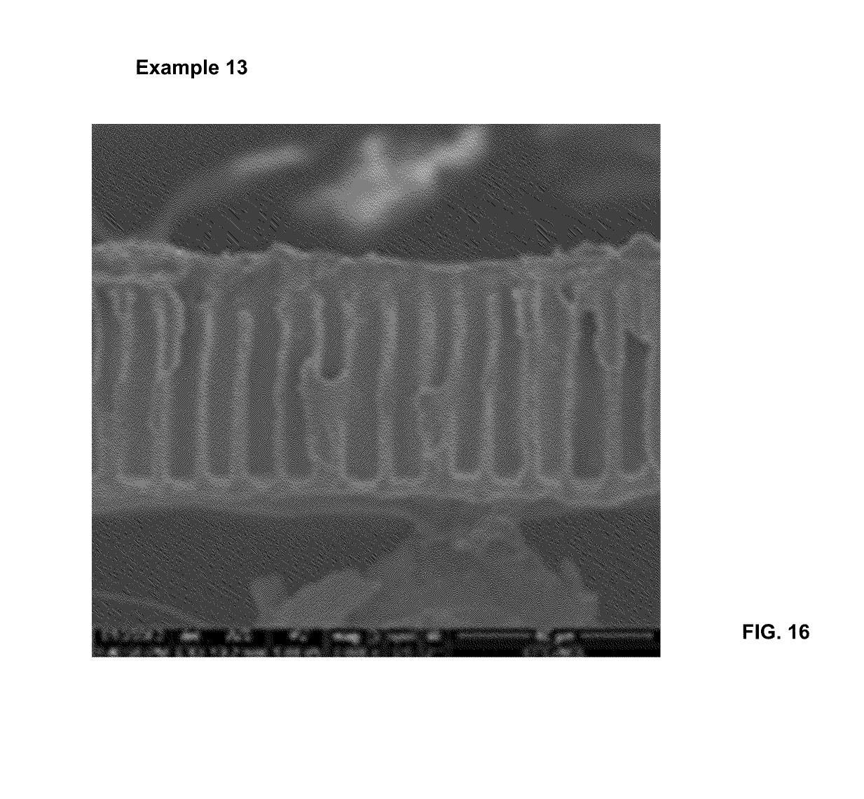

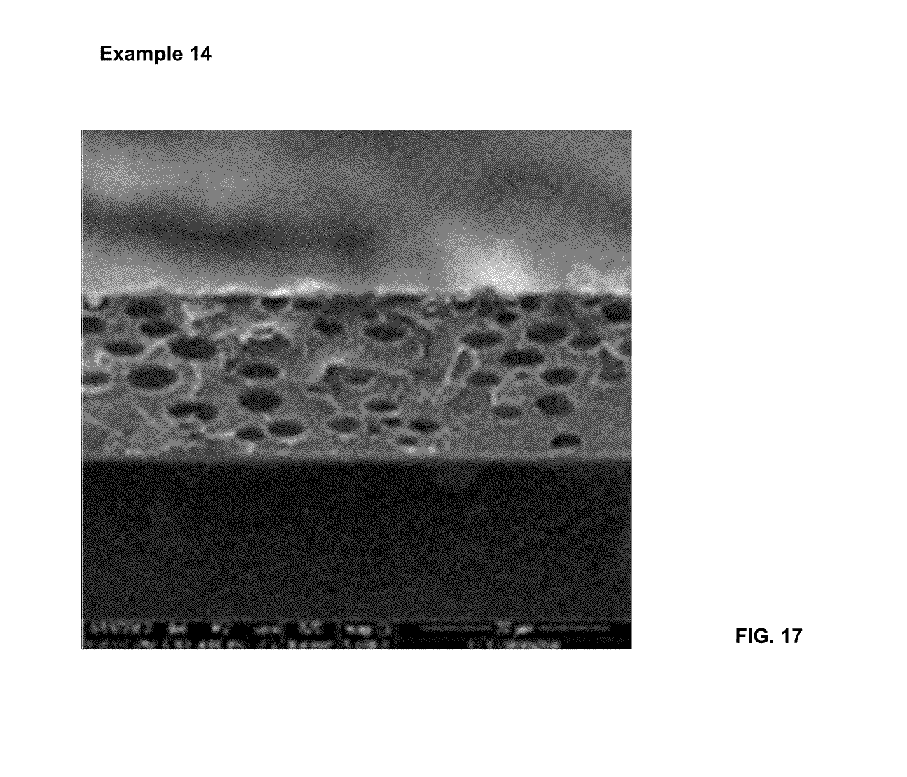

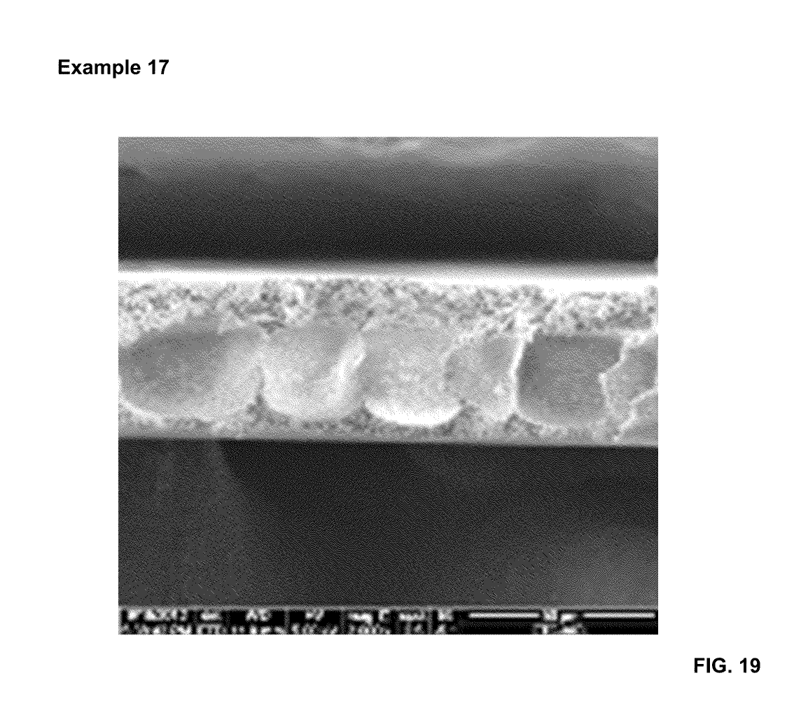

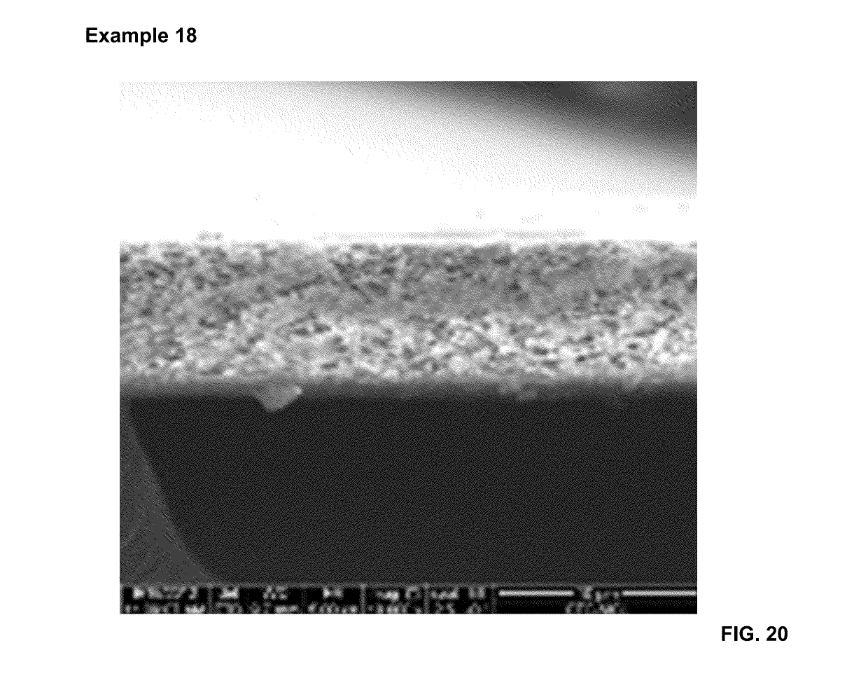

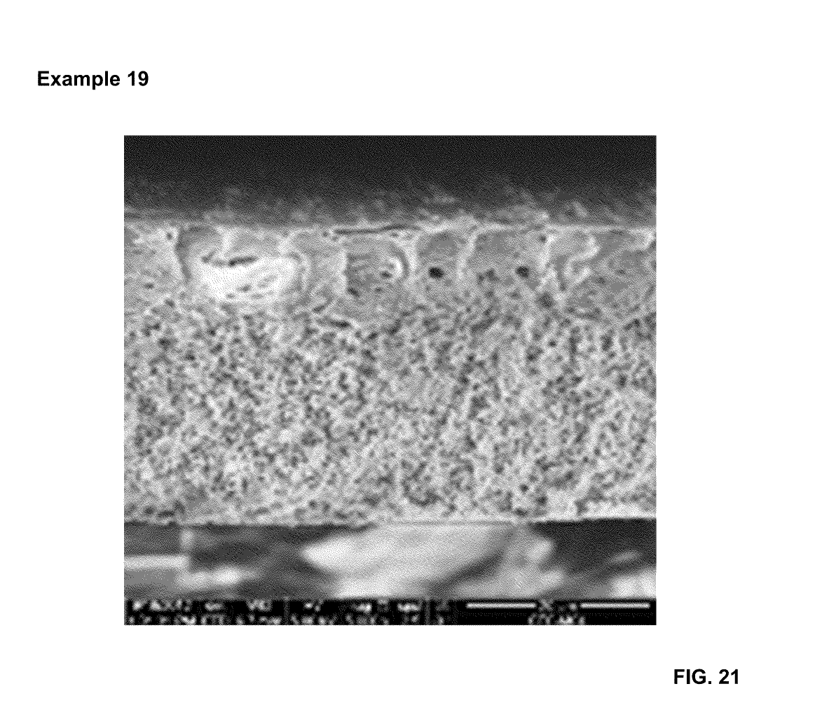

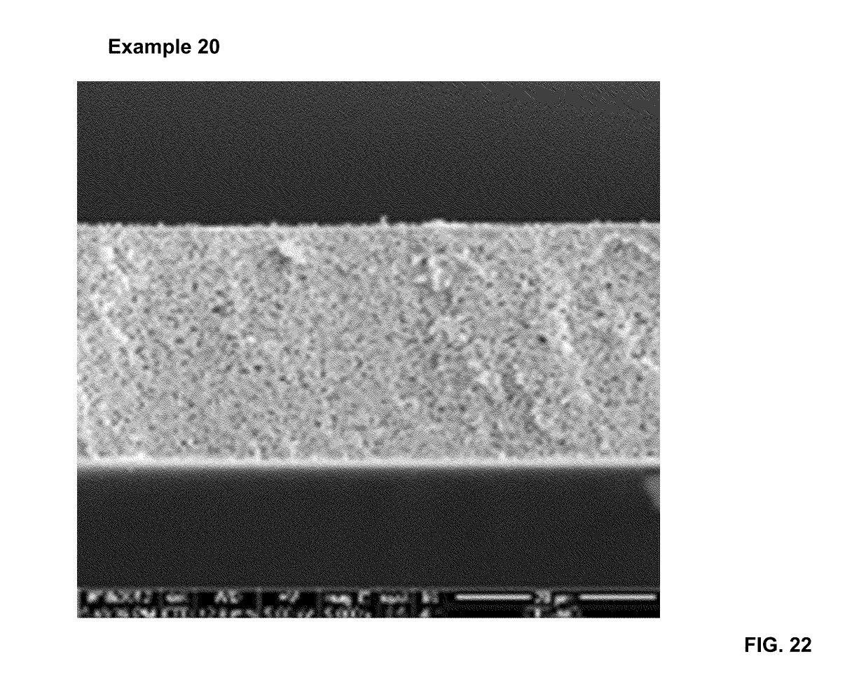

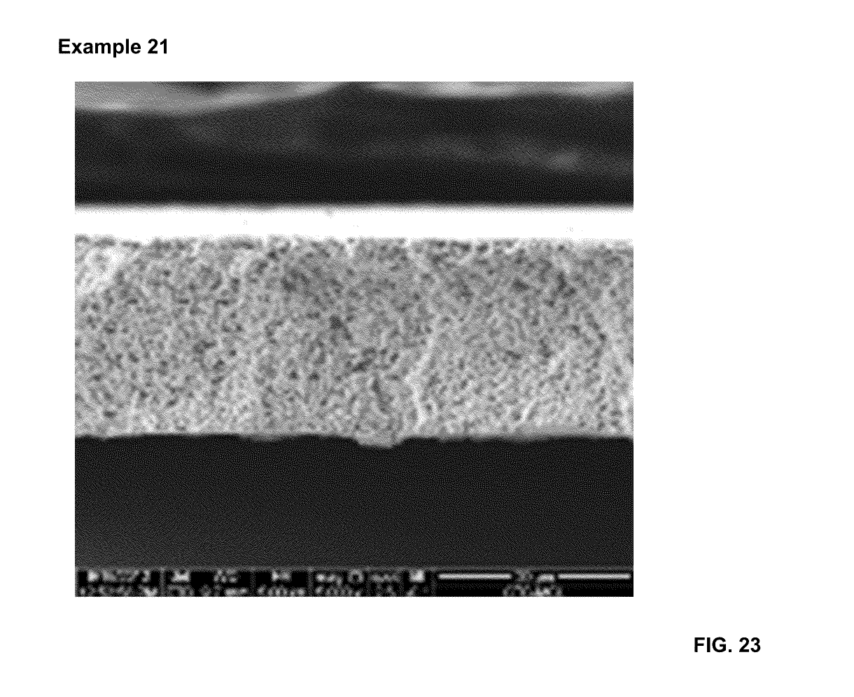

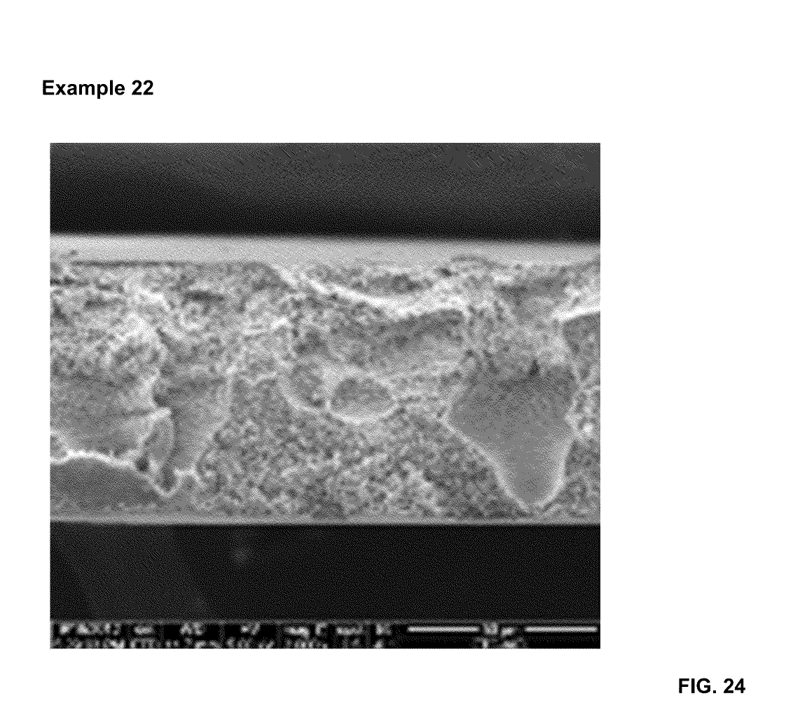

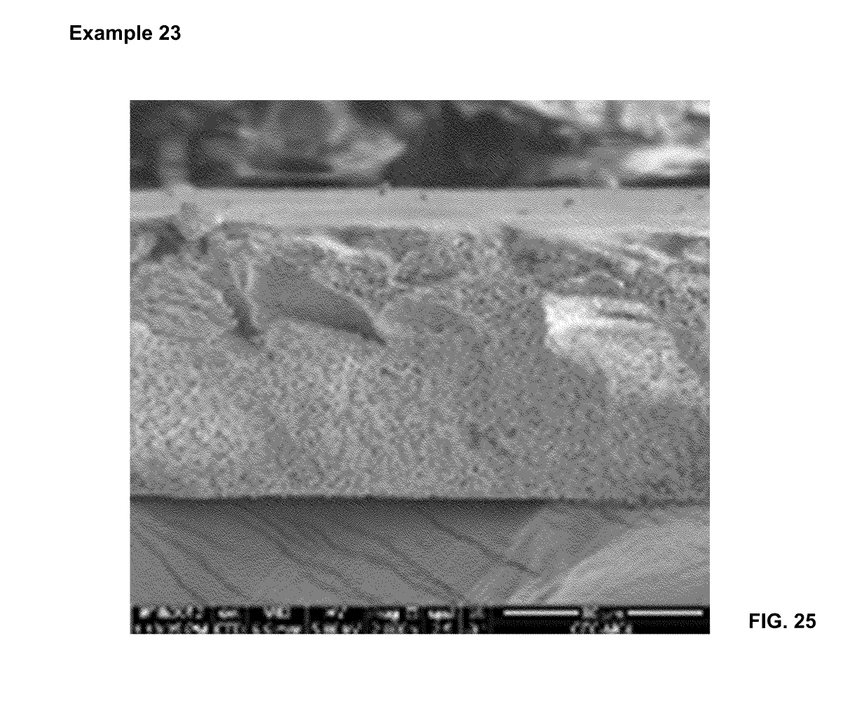

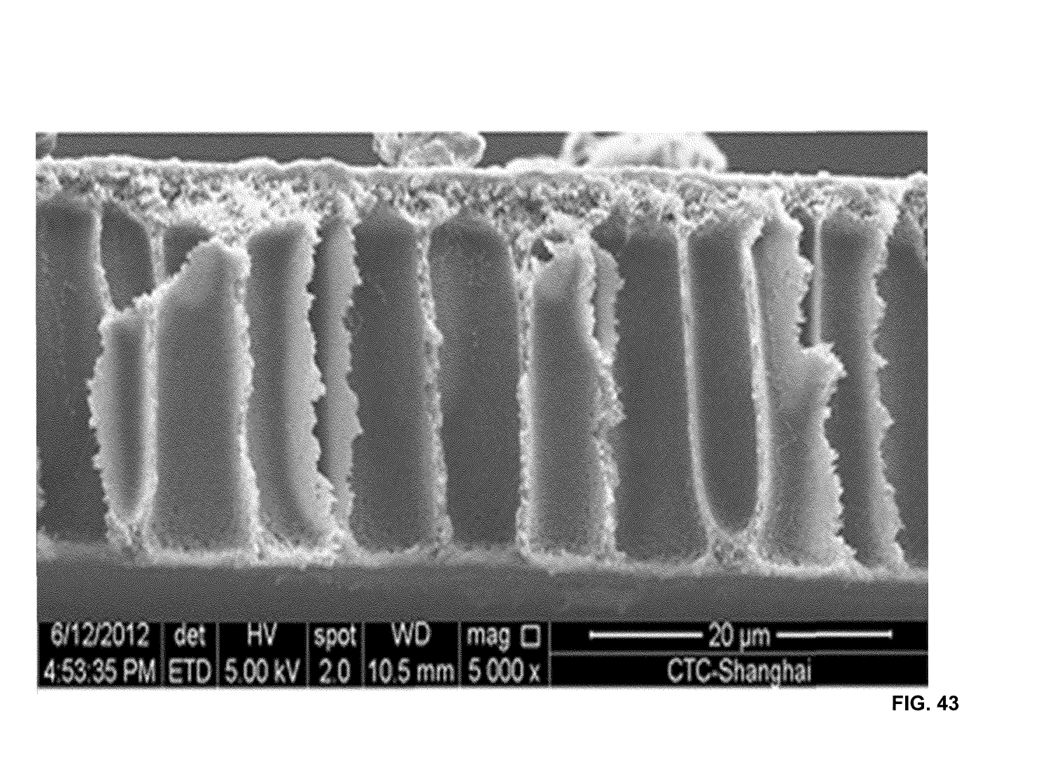

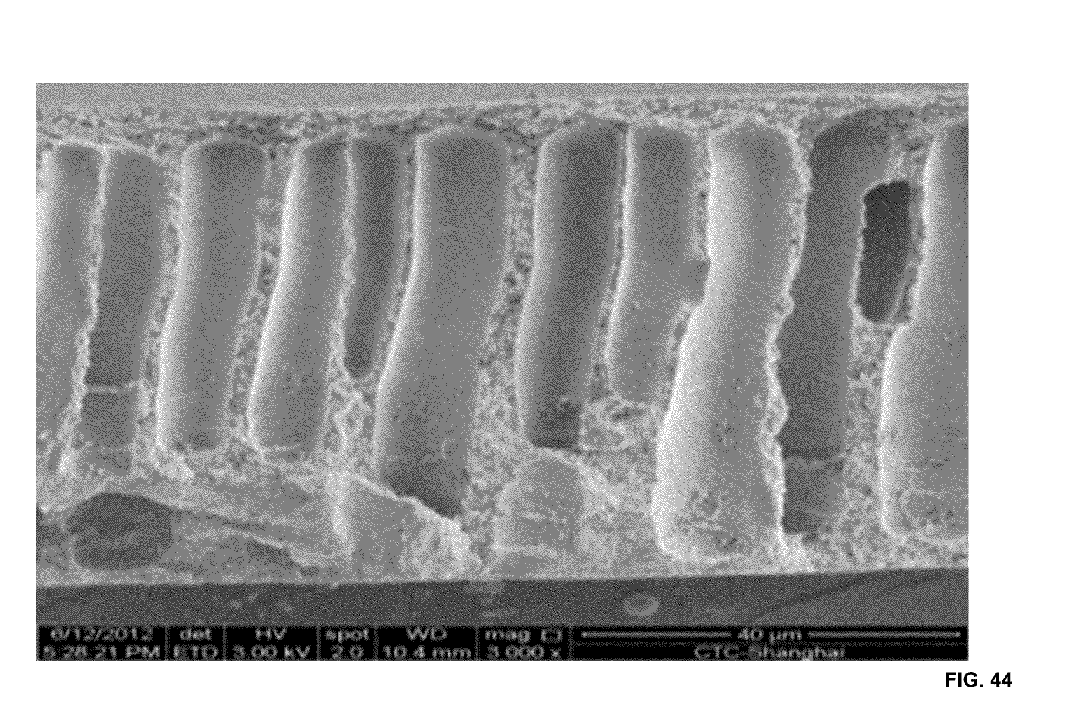

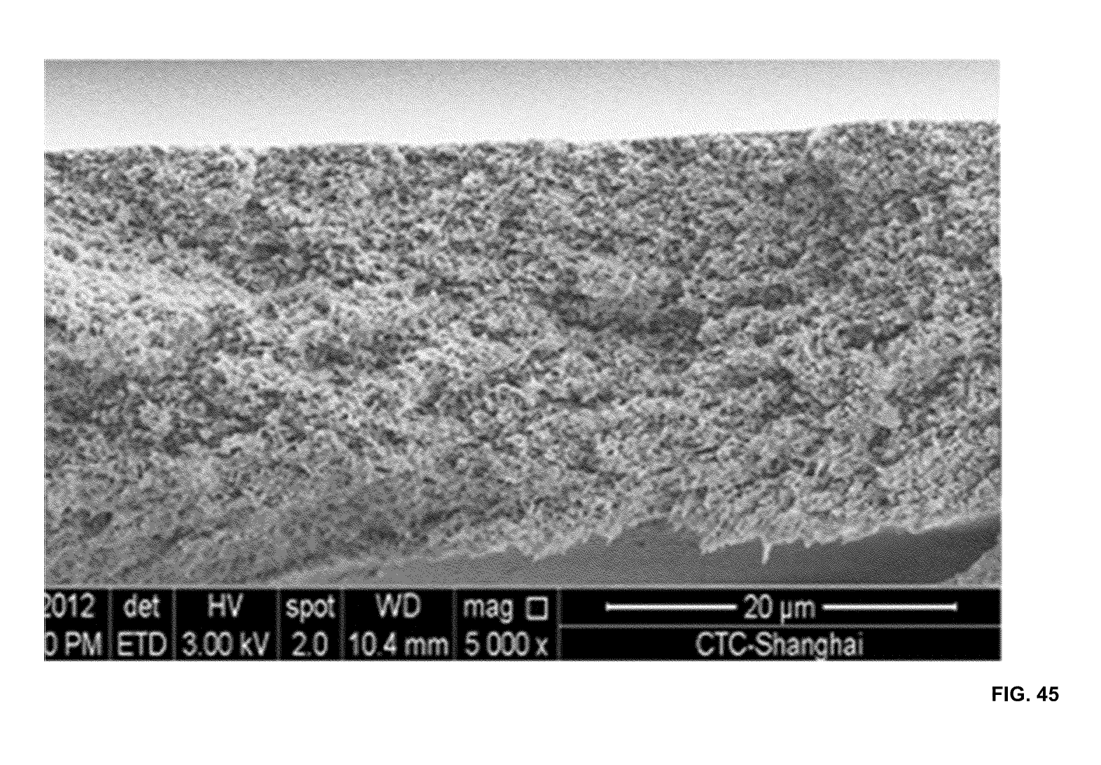

FIGS. 4-25 illustrate scanning electron microscope (SEM) images representing cross-section morphologies of the prepared porous separator films of Examples, 1-14 and 16-23, respectively. In particular, when the casted film was immersed in NMP (Ex. 15), ULTEM™ CRS 5001 formed a transparent, dense film, so it was not included in the further analysis. FIGS. 43-45 illustrate scanning electron microscope (SEM) images representing cross-section morphologies of the prepared porous separator films (ULTEM™ CRS 5001 part only) of Examples 24-26.

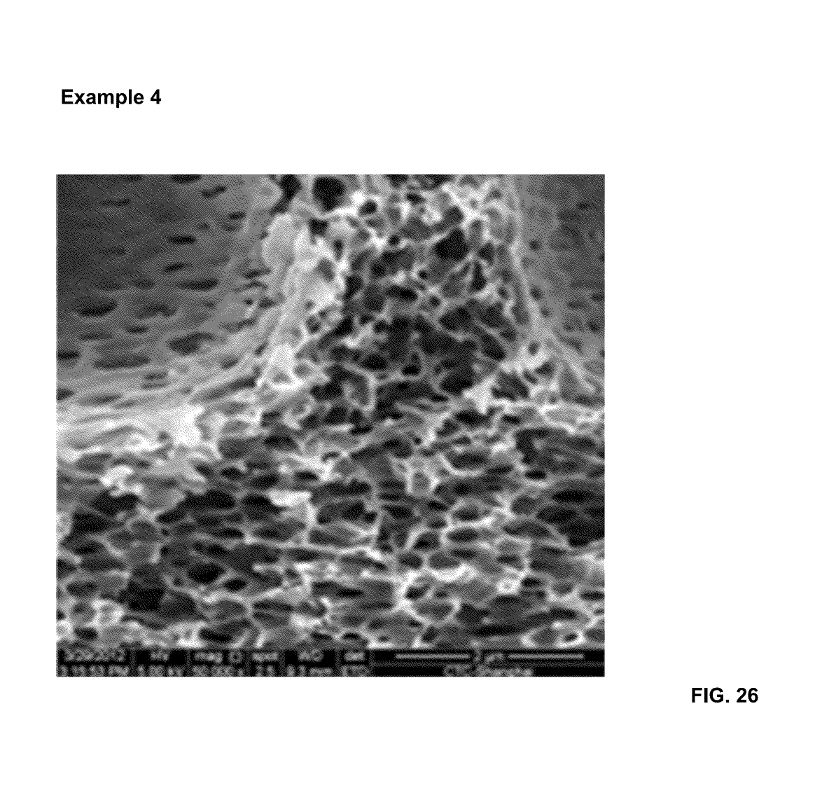

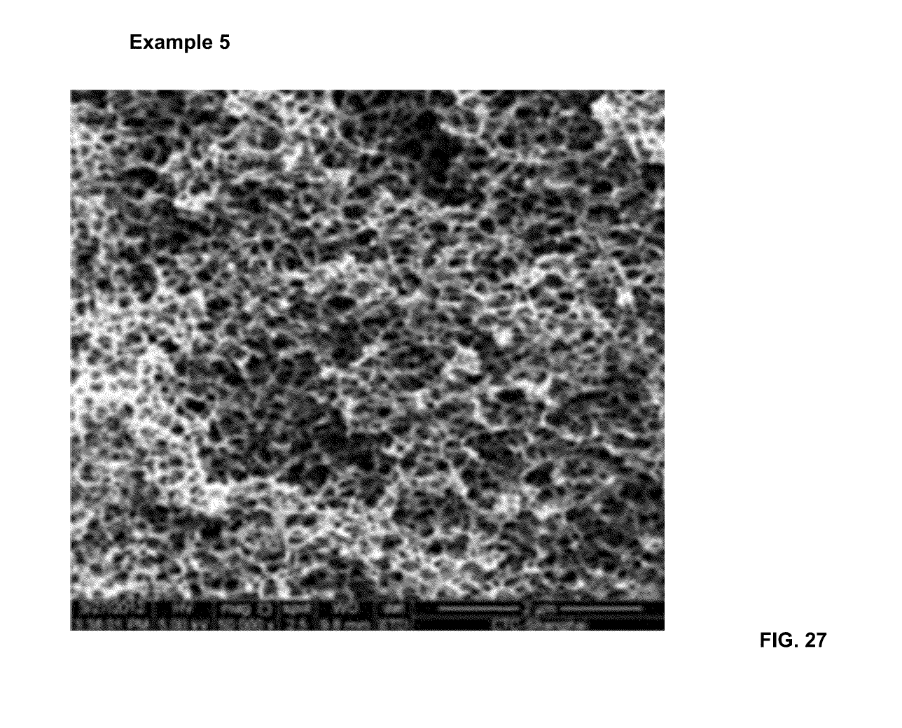

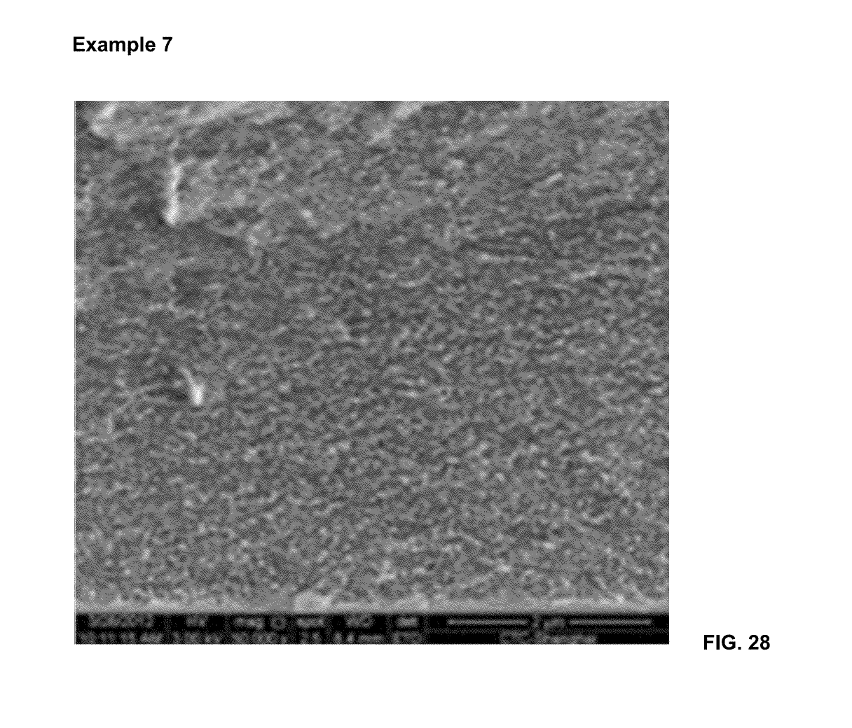

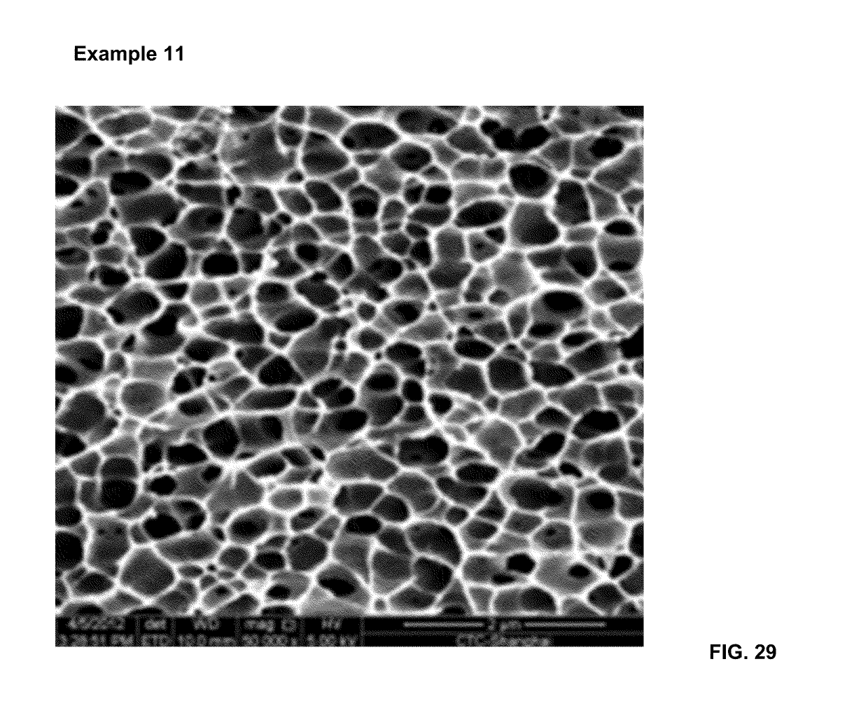

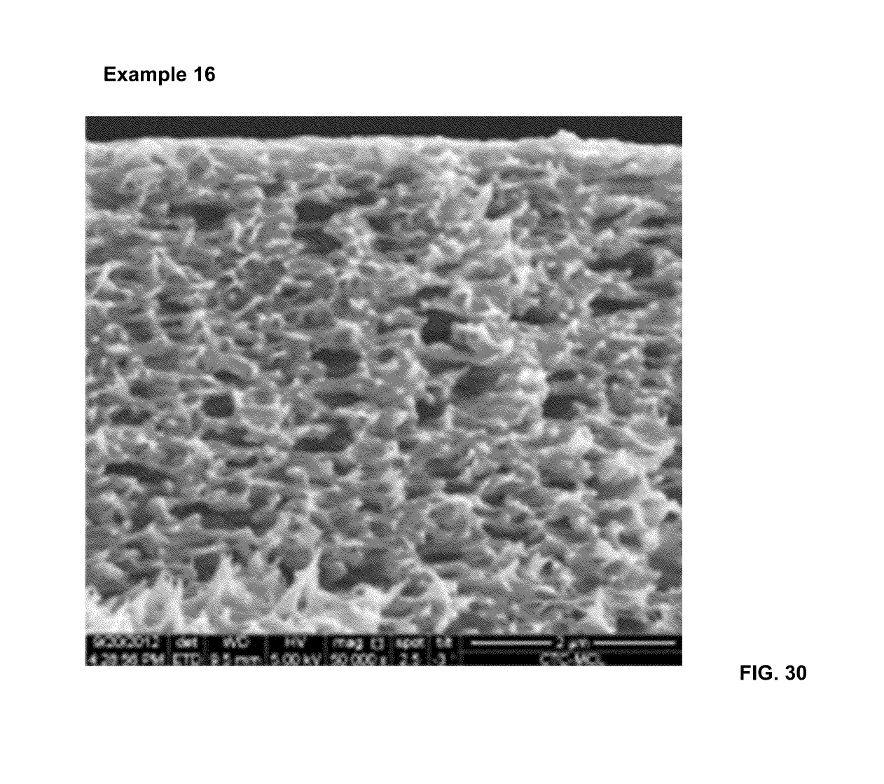

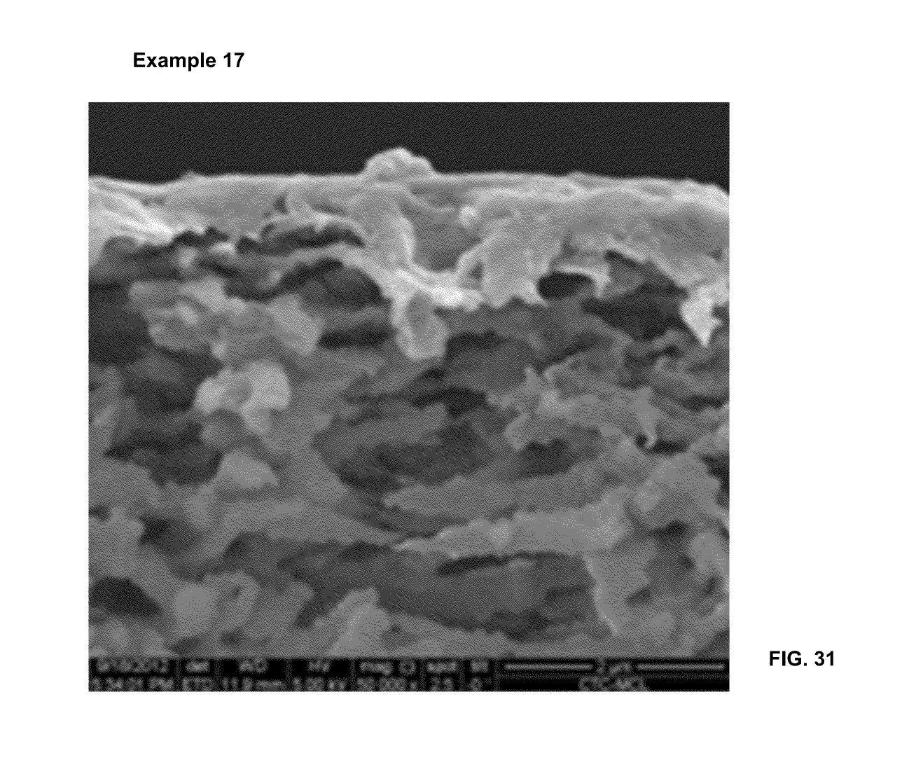

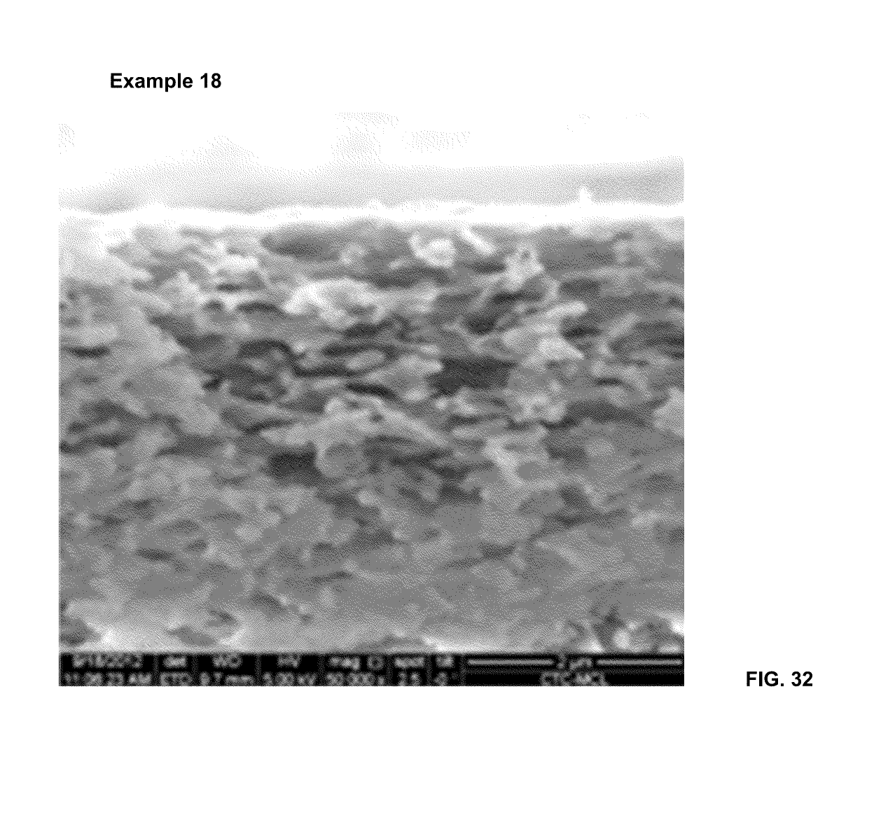

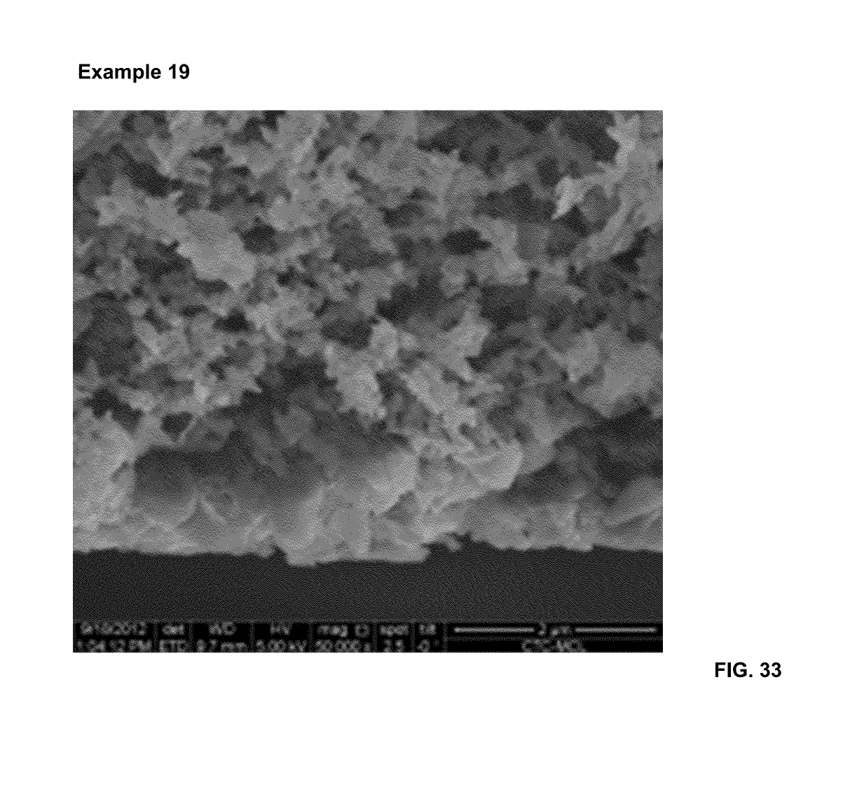

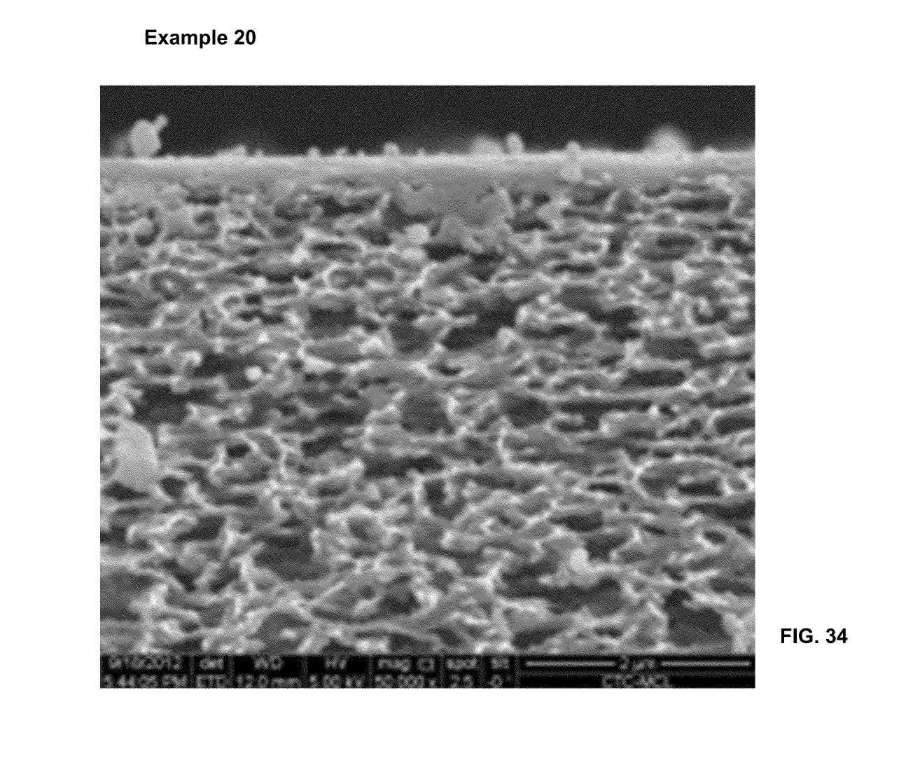

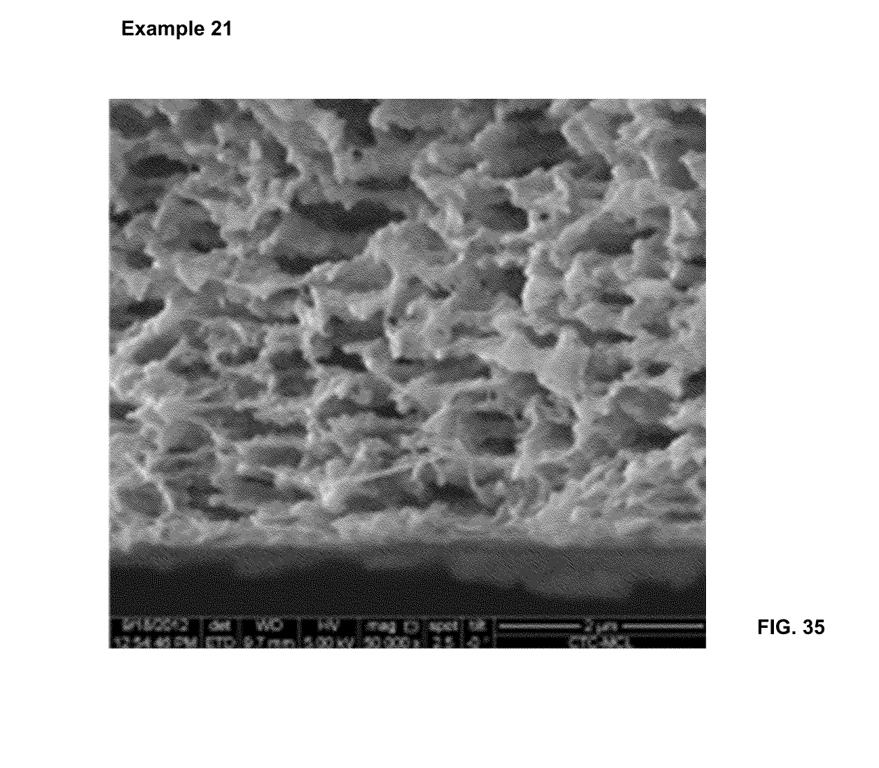

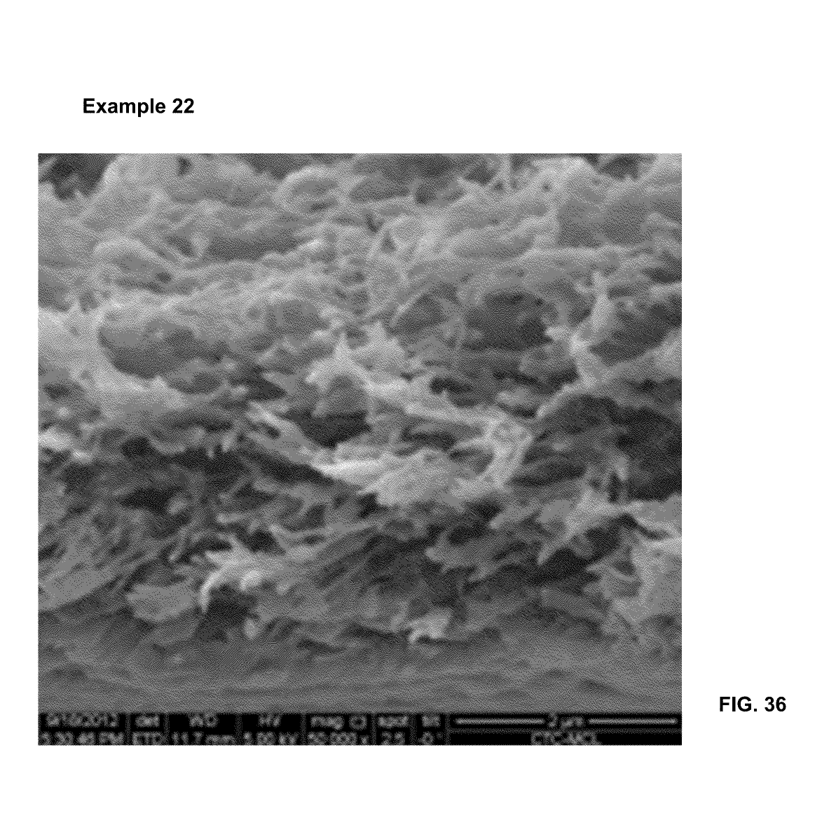

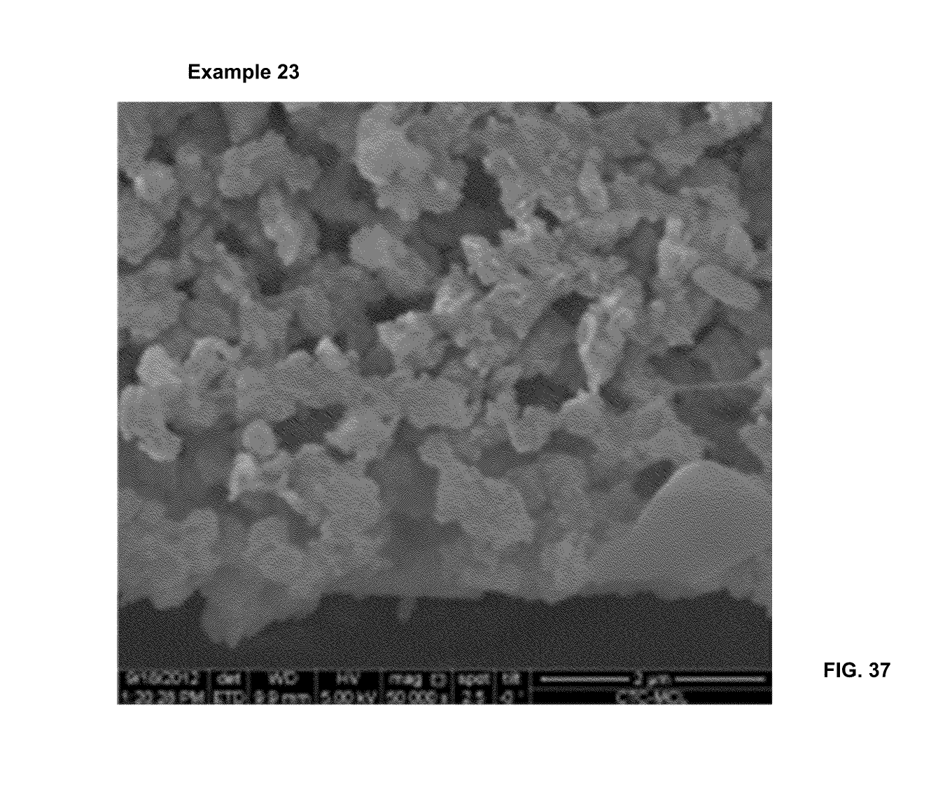

The SEM images demonstrate that the process is versatile and that the process conditions are very critical for the separator micro-structure control. The process conditions as used for examples 1 to 11 are similar to those disclosed in U.S. Pat. No. 7,439,291, i.e. they all use alcohol-based coagulation baths, although U.S. Pat. No. 7,439,291 deals with polymer resins that are at least partially crystalline. The morphologies of examples 1 to 11 typically contain two distinct regions: the top region contains finger-like macro-voids (>5 micron) (See FIGS. 4-14 illustrating scanning electron microscope (SEM) images of Examples 1-11), and the bottom region contains very fine, sponge-like micro-voids (<1 micron) (See FIGS. 26-37 illustrating higher magnification scanning electron microscope (SEM) images of Examples, 4-5, 7, 11, and 16-23, respectively). Sponge-like micro-voids are typically desired; as such a structure combines a continuous, porous path through the separator film combined with stiffness. However, macro-voids provide a very open pore structure, i.e. a very low resistance to ionic flow through the separator, which has the distinct advantage of increasing the ionic conductivity. In practice, one would seek a proper balance between the two depending on the targeted performance of the separator film.

Examples 4, 6, 8 and 10 all used the same coagulation bath (isopropanol at 22° C.), but different dope solution compositions (solvent and polymer concentration). The corresponding microscopy images show that the pore structure changes, but none of these separators are free of macro-voids. A similar conclusion is drawn for Examples 5, 7, 9 and 11; also these separators all contain macro-voids, although the fraction of macro-voids varies significantly. For the LIPS process, a higher polymer concentration is usually able to slow down the phase separation kinetics and can, therefore, be used to decrease the amount of macro-voids. Also for the compositions described herein, increasing the polymer concentration in the dope solution led to a reduction of the fraction of macro-voids, i.e. compare Examples 6, 7, 10 and 11 to Examples 4, 5, 8 and 9, respectively. Note that even a polymer concentration as high as 20 wt % did not fully eliminate the presence of macro-voids. Additionally, the high polymer concentration leads to a reduction of the micro-void pore size, leading to a very dense pore structure (e.g. Example 7).

As discussed, a macro-void free separator might be desired in certain applications, as the presence of macro-voids will have an influence on the mechanical performance of the film. For example, the presence of macro-voids typically leads to a very high overall porosity, which will lead to a relatively low stiffness of the separator. Additionally, macro-voids might induce brittleness to porous films. However, as presented above, the alcohol-based coagulation baths could not produce structures essentially free of macro-voids. Examples 10 to 16 used the same dope solution but different coagulation baths. It is evident that the coagulation bath is a very effective method to change the separator morphology. Using ethyl acetate (Example 12) or acetone (Example 13) as the coagulation bath did not lead to a reduction of macro-voids. Using heptane as the coagulation bath (Example 14) did not lead to finger-like cavities, but produced separated macro-pores. Using NMP as the coagulation bath (Example 15) led to a very dense film without any noticeable porosity and was, therefore, not taken along in further analyses.

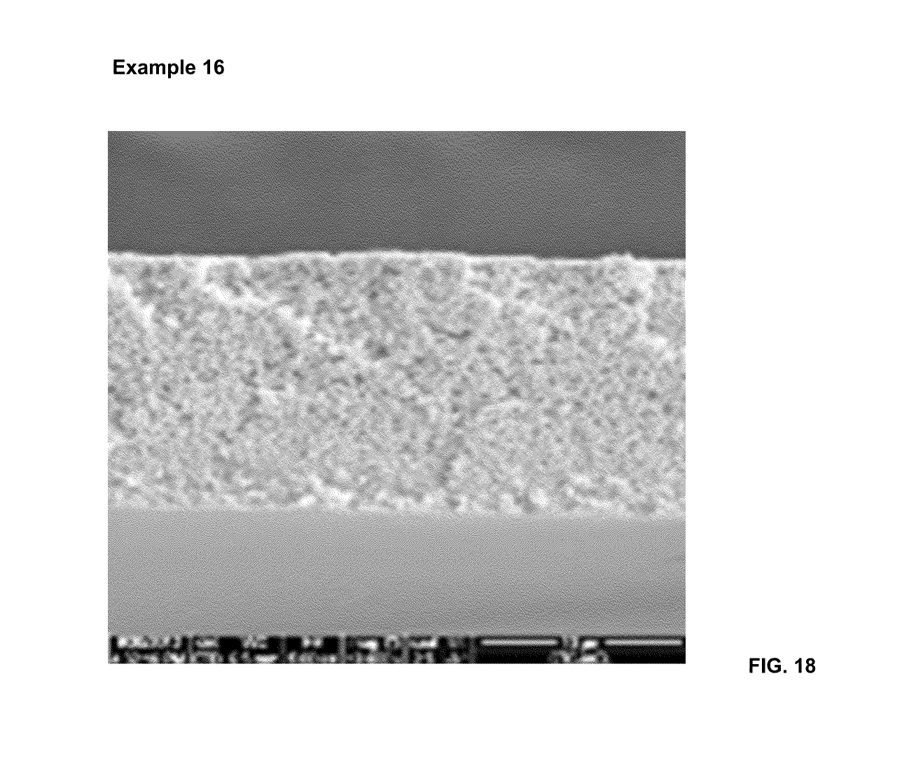

Examples 16 to 23 used tetrahydrofuran (THF) as the basis for the coagulation bath. It can be seen from FIGS. 18-25 and 30-37 that a separator essentially free of macro-voids was successfully produced using THF as the basis for the coagulation bath. Example 17, using a low polymer concentration and a temperature of 40° C., is the only sample that shows macro-voids. Comparing the micro-void structures in FIGS. 18-25 and 30-37, the separators prepared with THF as the coagulation bath solvent are very different from the separators of Examples 1 to 14. It appears that a higher temperature of the coagulation bath (Examples 17, 19, 21, 23) leads to a more filamentary type of structure, while a low temperature coagulation bath (Examples 16, 18, 20, 22) leads to a more flake-like structure. This obviously has a distinct effect on the interconnection between pores and the pore tortuosity.

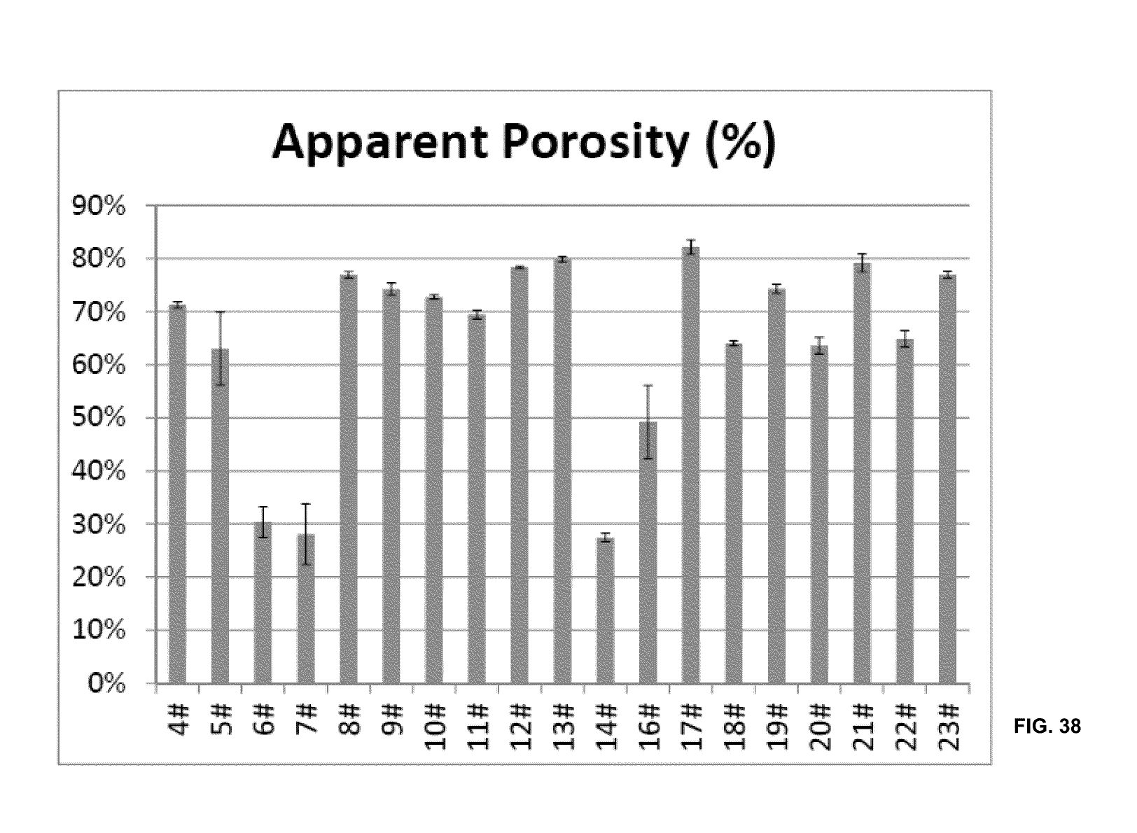

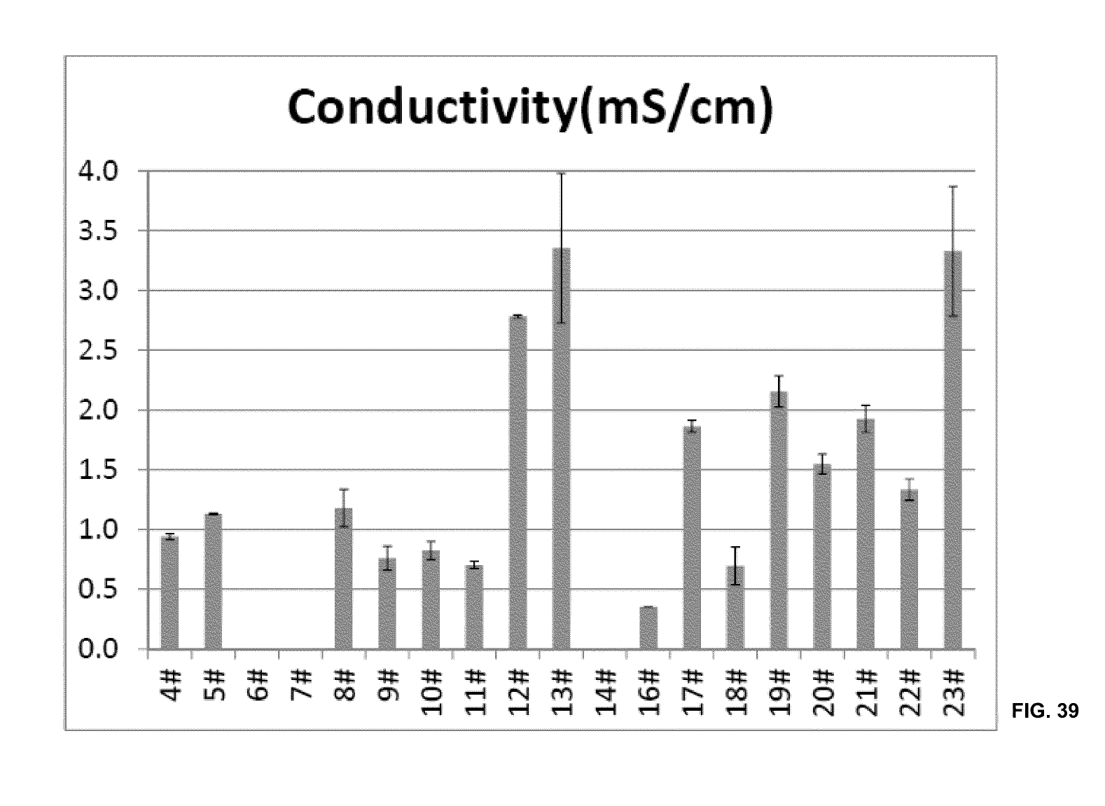

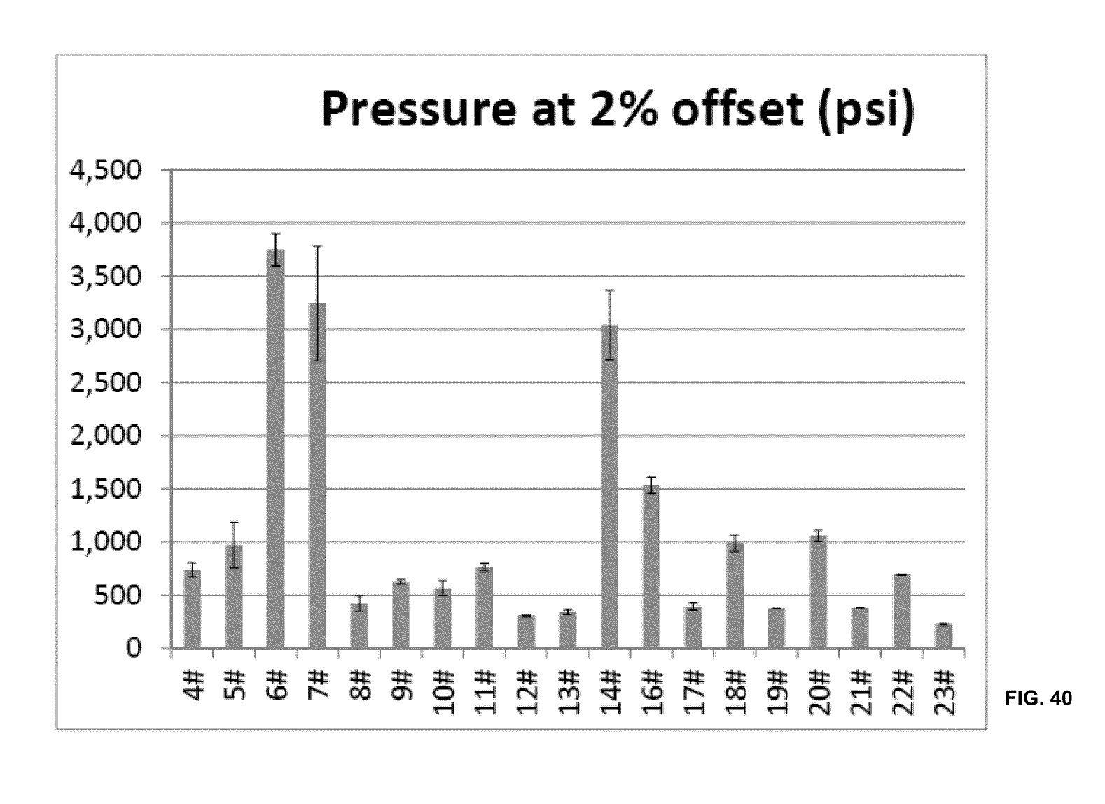

The apparent porosity, ionic conductivity and mechanical stiffness of the prepared separators were characterized according to the procedure described above, and the results are presented in FIGS. 38-40.

TABLE BB

| | Apparent | Pressure at | | |
|---|---|---|---|---|
| | porosity | 2% offset | Conductivity | |
| Example | (%) | (psi) | (mS/cm) | MacMullin |
| 4 | 71% | 738 | 0.94 | 9 |
| 5 | 63% | 971 | 1.13 | 8 |
| 6 | 30% | 3746 | 0.00 | |
| 7 | 28% | 3245 | 0.00 | |
| 8 | 77% | 423 | 1.18 | 7 |
| 9 | 74% | 622 | 0.76 | 11 |
| 10 | 73% | 566 | 0.82 | 10 |
| 11 | 69% | 762 | 0.70 | 12 |
| 12 | 78% | 306 | 2.78 | 3 |
| 13 | 80% | 341 | 3.35 | 3 |
| 14 | 27% | 3041 | 0.00 | |
| 16 | 49% | 1531 | 0.35 | 24 |
| 17 | 82% | 396 | 1.86 | 5 |
| 18 | 64% | 989 | 0.70 | 12 |
| 19 | 74% | 375 | 2.15 | 4 |
| 20 | 64% | 1058 | 1.55 | 5 |
| 21 | 79% | 383 | 1.92 | 4 |
| 22 | 65% | 694 | 1.33 | 6 |
| 23 | 77% | 226 | 3.33 | 3 |
| 24 | 77% | 746 | 0.95 | 9 |
| 25 | 79% | 783 | 1.46 | 6 |
| 26 | 50% | 1842 | 0.68 | 12 |

Table BB summarizes the data and also shows MacMullin numbers for these separators. The MacMullin number, based on the work of MacMullin and Muccini (R. B. MacMullin and G. A. Muccini, AIChE J., 2, 393, 1956), is defined as N_{M}=C/C₀, where is the conductivity of the porous media saturated with the electrolyte and C₀ is the bulk conductivity of the same electrolyte. The obvious advantage of describing separator conductivities in MacMullin numbers is the fact that MacMullin numbers are largely independent of the electrolyte used. The bulk conductivity of the electrolyte (C₀) was given to be 8.5±0.5 mS/cm.

The apparent porosity of all separators ranges from 27% to 82%. Example 6 and 7 and Example 14 show a very high stiffness, but have a low porosity (<30%) and are ionically insulating because the pores are not connected from the top to bottom (no or few through-pores present). The large amount of macro-voids in e.g. Examples 12 and 13 lead to a very high apparent porosity (>75%) and a very high ionic conductivity (>2.5 mS/cm) and a very low MacMullin number (N_{M}=3), but also to a rather low stiffness (<400 psi at 2% offset).

The apparent porosity of the separators prepared with THF as the coagulation bath (Examples 16 to 23) ranges from 50 to 82%. A higher temperature of the coagulation bath induced higher porosity, resulting in a higher ionic conductivity and lower MacMullin numbers, but also to a lower mechanical stiffness. With the exception of Example 17, the Examples 16 to 23 using THF as the coagulation bath all led to separators essentially free of macro-voids. It can clearly be seen that the separator performance in terms of ionic conductivity, MacMullin number and stiffness can be controlled by changing the membrane preparation conditions.

For example, Example 20 has a high apparent porosity (64%), a high stiffness (>1000 psi) and a good ionic conductivity (1.5 mS/cm) with a very low MacMullin number of N_{M}=5, which provides an excellent property profile for separator applications in many types of battery and supercapacitor systems.

The stress at 2% offset of the separators consisting of ULTEM™ CRS 5001 porous films on a porous PE substrate show a significant improvement, shown by comparison of Examples 24, 25 and 26 to Examples 12, 13 and 20, which show an increase in stress at 2% offset from 306, 341 and 1058 to 746, 783 and 1842, respectively. The presence of the porous PE substrate does lead to an increase in MacMullin number from 3, 3 and 5 to 9, 6 and 12, respectively. These results show that the balance between stress at 2% offset and ionic conductivity can be modified by casting the ULTEM™ CRS 5001 membrane on top of a porous polyethylene substrate.

Table CC shows the contact angle of Example 20 versus time, measured with an electrolyte solution. Even after the short contact time of 10 seconds, the contact angle is already below 20°, which indicated an almost instantaneous wetting of the separator by the electrolyte solution, which is highly beneficial for the battery cell manufacturing process as well as the battery cell operation.

TABLE CC
Electrolyte contact angle of example 20.

| Time since droplet | Contact Angle and |
|---|---|
| dispensed (s) | standard deviation (°) |
| 2 | 24.2 ± 1.2 |
| 5 | 22.9 ± 1.0 |
| 10 | 17.1 ± 1.4 |
| 15 | 16.1 ± 1.0 |
| 20 | 14.7 ± 0.6 |
| 25 | 12.2 ± 1.0 |
| 30 | 10.7 ± 0.8 |
| 60 | 8.6 ± 0.7 |

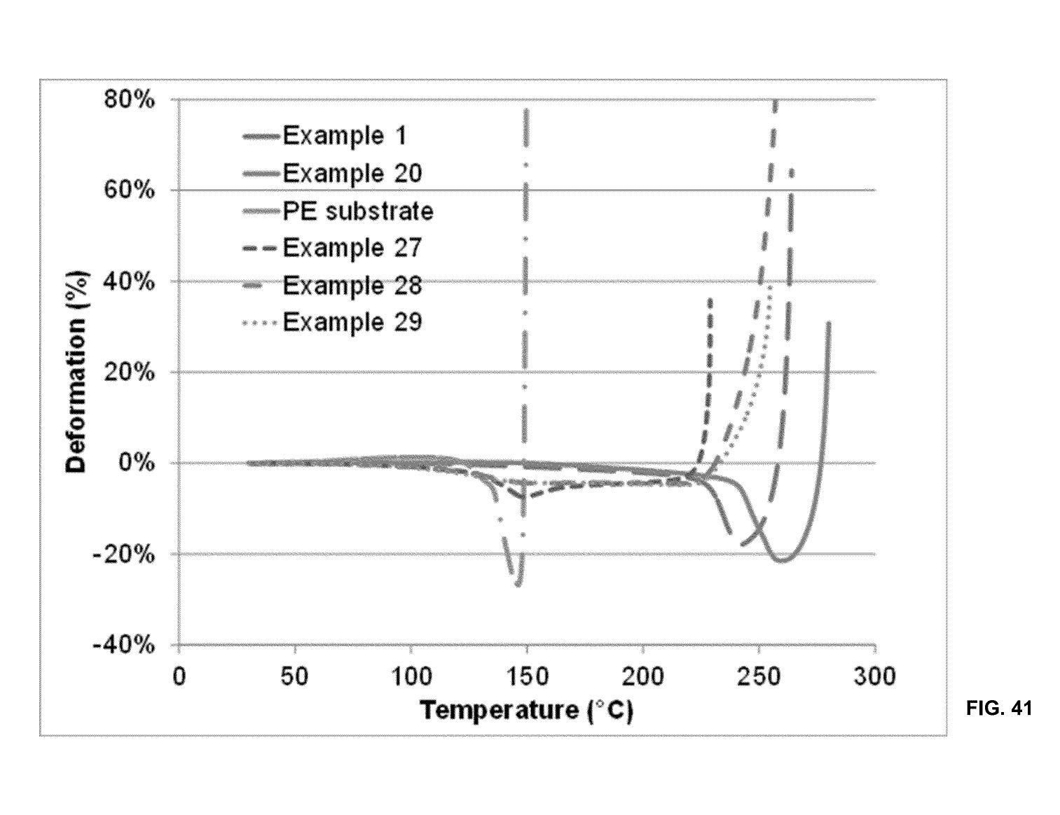

FIG. 41 illustrates the high temperature melt integrity (HTMI) of Examples 1 (many macro-voids) and 20 (free of macro-voids) and the PE substrate and the ULTEM™ CRS 5001/PE multilayer separators. The results show that macro-void free separators are beneficial for HTMI performance. Table DD summarizes the shrinkage temperature (at 2% deformation) and the deformation temperature (5% deformation), according to the NASA/TM—2010-216099 Test Method. These results show that the ULTEM™ CRS 5001 separators achieve a deformation temperature far exceeding 200° C., which is the HTMI requirement for advanced lithium ion battery separators with improved safety performance, and have a rupture temperature of 240° C. or higher. Note that the conventional, commercial polyolefin-based separators, such as Celgard® 2340, Celgard® 2500 and Tonen V25CGD separators, have a significantly inferior HTMI, with a typical deformation temperature of 160° C. or lower (Table I). This is also reflected by the low deformation temperature of the PE substrate (134° C.) and the low rupture temperature (149° C.). The results show that the ULTEM™ CRS 5001/PE multilayer separators show a rupture temperature exceeding 229° C. The values of the deformation temperature show that at low ULTEM™ CRS 5001 thicknesses, the PE substrate deformation dominates, leading to a deformation temperature of 140° C. (Example 27). Similarly, at higher ULTEM™ CRS 5001 thicknesses (casting gap thickness 50 or 75 micron, Examples 28 and 29), the ULTEM™ CRS 5001 deformation dominates, leading to a deformation temperature of 235° C. or higher. The shrinkage temperature of the ULTEM™ CRS 5001/PE multilayer separators is constant at about 120-130° C., which is equal to the shrinkage temperature of the PE substrate. This indicates that melting of the PE occurs at a similar temperature for the PE substrate and the ULTEM™ CRS 5001/PE multilayer separators, indicating that a shutdown mechanism (which relies on PE melting and, consequently, pore closing) is present in the ULTEM™ CRS 5001/PE multilayer separators.

TABLE DD
HTMI performance of Examples 1, 20,
27, 28, 29 and the PE substrate.

| | Shrinkage | Deformation | Rupture |
|---|---|---|---|
| | temperature | temperature | temperature |
| Example | (° C.) | (° C.) | (° C.) |
| 1 | 197 | 228 | 240 |
| 20 | 211 | 241 | 258 |
| PE substrate | 128 | 134 | 149 |
| 27 | 124 | 140 | 229 |
| 28 | 122 | 235 | 257 |
| 29 | 119 | 240 | 255 |

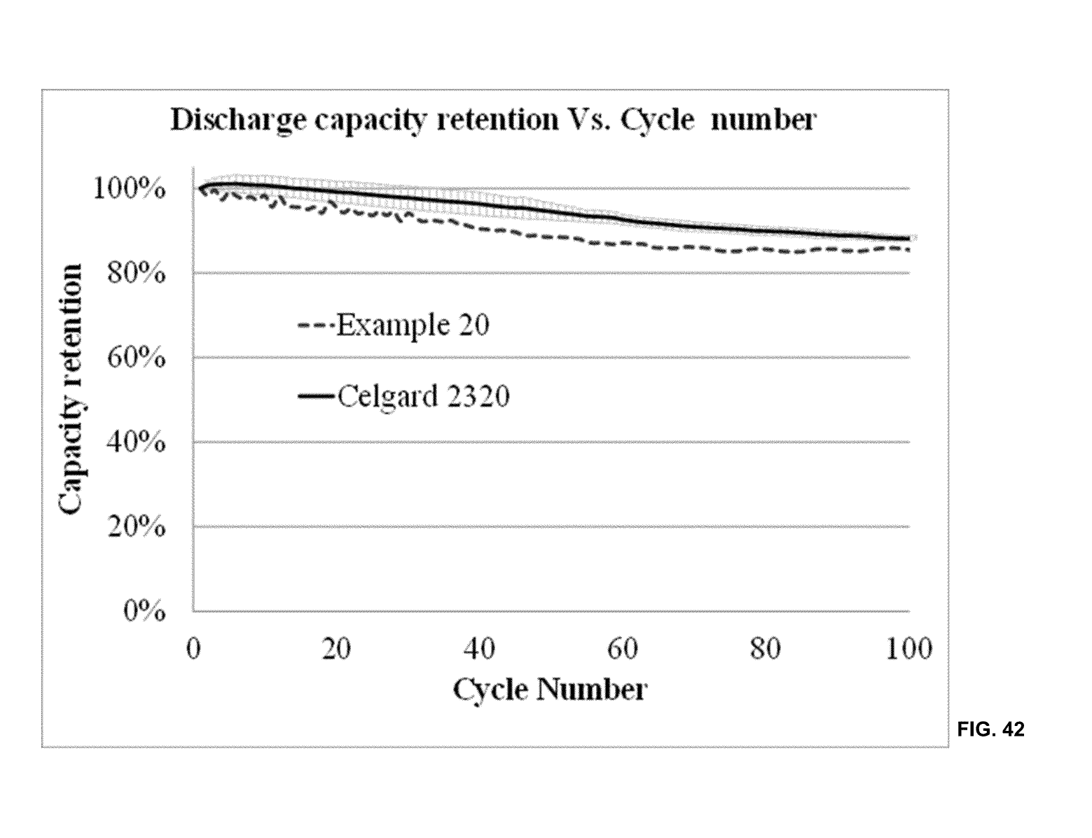

FIG. 42 illustrates the discharge capacity retention of Example 20 as compared to a commercial separator (Celgard® 2320). 1200 cycles were completed with the ULTEM™ CRS 5001 based separator, showing that the degradation rate is much slower as compared to the commercial Celgard® 2320 separator, which means that the battery using the ULTEM™ CRS 5001 separator has a significantly better life time as compared to the battery using the commercial polyolefin separators.

### Preparation Using N-Methylpyrrolidone (NMP)

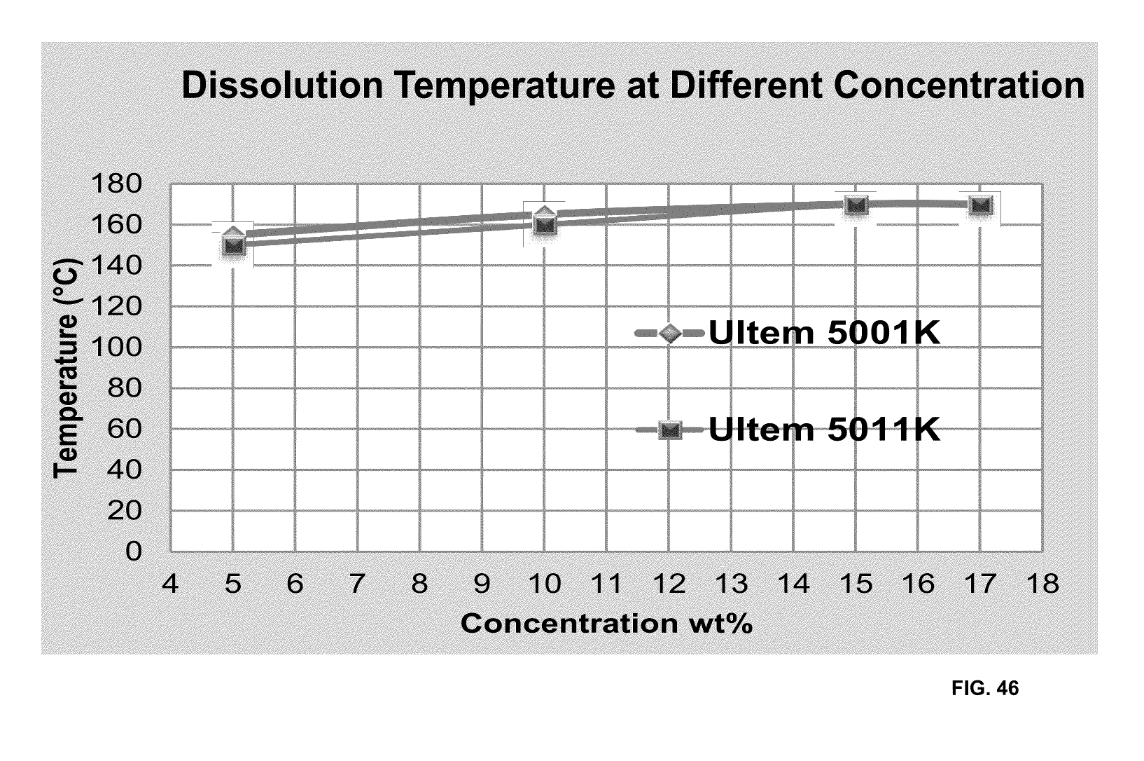

In an aspect, the separator can be prepared by dissolving solvent-resistant polyetherimides (e.g. polyetherimides based on pare-phenylene diamines) in N-methylpyrrolidone (NMP) at elevated temperatures (e.g. 140-202° C., see FIG. 46) in a closed system (i.e. no direct contact between the solution and the air atmosphere) or open system, followed by casting at reduced temperature (30-140° C.) and coagulating in a water or other material bath. As an example, membranes can be prepared using the materials and processes disclosed herein for environments such as battery cells and/or capacitor cells, electrolytic energy storage devices, a dialysis membrane, a water filtration membrane, a desalination membrane, a gas separation membrane, and the like.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, pressure is at or near atmospheric and the coagulation solvent is in the liquid phase.

### Materials

In an aspect, a plurality of materials can be used in preparation of a solvent resistant polymeric membrane, as described herein and as illustrated below:

| Component | CHEMICAL DESCRIPTION | SOURCE |
|---|---|---|
| ULTEM ™ | Polyetherimide based on para- | SABIC |
| CRS 5001 | phenylenediamine, high molar mass, | |
| | phthalic anhydride capped | |
| ULTEM ™ | Polyetherimide based on para- | SABIC |
| CRS 5011 | phenylenediamine, lower molar mass, | |
| | phthalic anhydride capped | |
| ULTEM ™ | Polyetherimide based on para- | SABIC |
| CRS 5001K | phenylenediamine, high molar mass, | |
| | aniline capped | |
| ULTEM ™ | Polyetherimide based on para- | SABIC |
| CRS 5011K | phenylenediamine, lower molar mass, | |
| | aniline capped | |
| NMP | N-methyl Pyrrolidone (HPLC grade, | Spectrochem |
| | water content 500 ppm) | Pvt Ltd. |
| | | Mumbai |
| | | (India) |
| DCM | Dichloromethane, HPLC grade | Merck |
| EDC | 1,2-Dichloroethane, GR grade | Merck |
| THF | Tetrahydrofuran, HPLC grade | Merck |
| DMAc | Dimethylacetamide, Anhydrous grade | Sigma Aldrich |
| DMSO | Dimethyl sulfoxide, Anhydrous grade | Sigma Aldrich |
| Anisole | Anisole, Anhydrous grade | Sigma Aldrich |
| ODCB | 1,2-Dichlorobenzene, HPLC grade | Spectrochem |
| Acetone | Acetone, HPLC grade | Merck |
| Isopropanol | Isopropanol, HPLC grade | Merck |
| Hexane | Hexane, LR grade | Merck |
| TiO₂ | TRONOX CR-834 | TRONOX |
| MgO | Maglite DE | Promecome |

### Examples

As shown and described herein, polyetherimides (PEI) based on para-phenylene diamines (SABIC'S ULTEM™ CRS 5000 series) are excellent materials for solvent resistant membranes. As an example, membranes can be prepared using the materials and processes disclosed herein for environments such as battery cells and/or capacitor cells, electrolytic energy storage devices, a dialysis membrane, a water filtration membrane, a desalination membrane, a gas separation membrane, and the like.

In an aspect, dissolving chemical resistant ULTEM™ CRS 5000 grades in a solvent having a Health Rating of 2 or lower on the NFPA fire diamond and maintaining a stable solution at low temperature or at room temperature to enable producing porous membranes via a liquid induced phase separation (LIPS) or vapor induced phase separation (VIPS) approach is not obvious, as chemical resistant ULTEM™ CRS 5000 grades are generally considered to be insoluble in common solvents (see U.S. Pat. No. 7,439,291). However, surprisingly, we have found that N-methylpyrrolidone (NMP) is able to dissolve chemical resistant ULTEM™ grades (e.g. SABIC's ULTEM™ CRS 5000 series) at elevated temperatures and are useful for casting of battery separators close to or at room temperature, as summarized in Table AAA and Table BBB. NMP is a beneficial solvent for casting of battery separators, as it has a Health Rating of 2 or lower on the NFPA fire diamond (i.e. reduced toxicity versus most phenol and cresol-based solvents) and is fully miscible with water, which enables the use of a coagulation bath comprising water.

TABLE AAA
Solubility of ULTEM ™ CRS 5011K in common solvents

| | ULTEM ™ | | | Phase |
|---|---|---|---|---|
| | CRS 5011K | | | separation |
| | Concentration | Dissolution | Solu- | Temp upon |
| Solvent | (wt %) | Temp (° C.) | bility | cooling (° C.) |
| DCM | 5 | RT | Insoluble | — |
| DCE | 5 | RT | Insoluble | — |
| THF | 1 | RT | Insoluble | — |
| DMAc | 1 | RT | Insoluble | — |
| Anisole | 1 | RT | Insoluble | — |
| ODCB | 10 | Boiling point | Insoluble | — |
| DMAc | 10 | Boiling point | Insoluble | — |
| Anisole | 10 | Boiling point | Insoluble | — |
| NMP | 5 | RT | Insoluble | — |
| DMSO | 1 | RT | Insoluble | — |
| NMP | 10 | Boiling point | Soluble | Room |
| | | | | temperature |
| DMSO | 10 | Boiling point | Soluble | 120 |

TABLE BBB
Solubility of ULTEM ™ CRS 5011K in phenol and cresol-based solvents
(Health Rating of 3 or higher on the NFPA fire diamond)

| | ULTEM ™ | | | |
|---|---|---|---|---|
| | CRS 5011K | | | Phase |
| | Concentration | Dissolution | Solu- | separation |
| Solvent | (wt %) | Temp (° C.) | bility | Temp (° C.) |
| 2-Cl- | 13 | 120 | Soluble | None |
| phenol | | | | |
| 1:1 (w/w) of 4- | 17 | 120 | Soluble | None |
| Cl-cresol/ | | | | |
| p-cresol | | | | |
| 5:1 (w/w) of 4- | 20 | 120 | Soluble | None |
| chloro-2-methyl- | | | | |
| phenol/p-cresol | | | | |

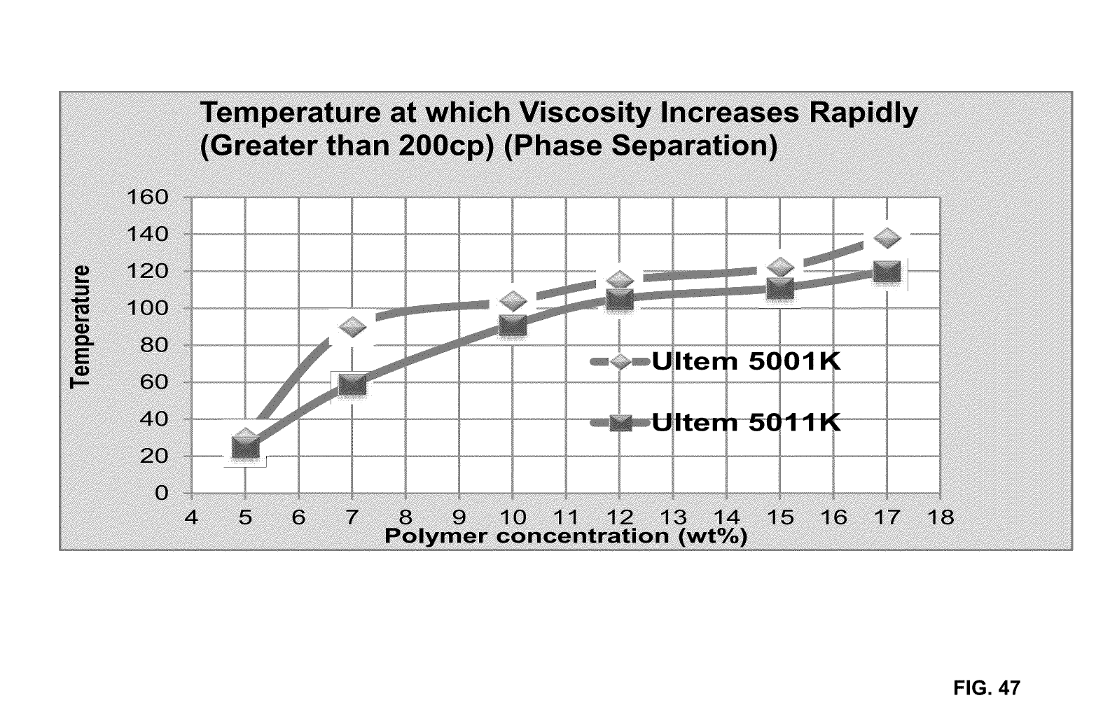

In an aspect, chemical resistant, porous membranes can be prepared by dissolving solvent-resistant polyetherimides in N-methyl-2-pyrrolidone (NMP) at elevated temperatures (140-202° C., see FIG. 46) in an open system (i.e. direct contact between the solution and the air atmosphere), followed by casting at reduced temperature (30-140° C.) and coagulating in a water bath. The dissolution temperature in FIG. 46 was determined by visual observation of the polymer dissolving in the solvent and the complete solution turning transparent. FIG. 47 shows the steady-state phase separation temperature as a function of concentration, measured by determining the temperature at which the solution shows a sudden significant increase in viscosity upon slowly cooling down from 170° C., which is an indication for gelation (early stage of phase separation).

In an aspect, the temperature of dissolution is a critical parameter when dissolving the chemical resistant ULTEM™ CRS 5000 grades in NMP. Dissolution of a 12 wt % ULTEM™ CRS 5001K in NMP in an open system can be achieved within 12 minutes at an average temperature of 200° C. while it takes 28 minutes at an average temperature of 190° C. Additionally, the dissolution time depends on the physical shape of the ULTEM™ CRS 5001K (e.g. pellet vs powder) and the stirring mechanism.

In an aspect, an unexpected result was obtained when heating up the ULTEM™ CRS 5000 in NMP mixtures in an open system (i.e. the solvent is in contact with the air atmosphere under atmospheric pressure conditions), being that the polyetherimide fully dissolves and the solutions are stable at room temperature (i.e. no phase separation occurs) for up to 2 hrs (depending on the composition), described in Table CCC, below:

TABLE CCC

| | | Onset of visual | | |
|---|---|---|---|---|
| | | phase separation | | |
| ULTEM ™ | | (turbidity) | | |
| CRS | Concentration | Temp | Time | Comments and |
| Grade | (wt %) | (° C.) | (h) | visual observations |
| 5011K | 9 | Room | >1 h | Clear solution at |
| | | temperature | | room temp, stable |
| | | | | for an hour |
| | 13 | Room | <1 h | Little amount |
| | | temperature | | crushed out at room |
| | | | | temperature within 1 |
| | | | | hr |
| | 17 | >Room | — | Resin crushed out at |
| | | Temperature | | room temperature |
| 5001K | 9 | Room | >2 h | Clear solution at |
| | | temperature | | room temp, stable |
| | | | | for two hrs |
| | 13 | Room | <2 h | Little amount |
| | | temperature | | crushed out at room |
| | | | | temperature within 2 |
| | | | | hrs |
| | 17 | >Room | — | Resin crushed out at |
| | | Temperature | | room temperature |

A more detailed solubility analysis demonstrated the influence of ULTEM™ CRS 5001K concentration on the stability of the solution at room temperature (Table DDD). Solutions were dissolved at high temperature in an open system and cooled down in a closed system using a water bath. These results show that 15 wt % ULTEM™ CRS 5001K/NMP is still transparent at room temperature for several minutes.

TABLE DDD

| | | Onset of phase | | | |
|---|---|---|---|---|---|
| ULTEM ™ | | separation | | | |
| CRS | Concentration | Temp | Time | | |
| Grade | (wt %) | (° C.) | (h) | | Comments |
| 5001K | 8 | Room | <2 | h | Clear solution at |
| | | temperature | | | room temp, stable |
| | | | | | for over two hrs |
| | 10 | Room | <2 | h | Solution becomes |
| | | temperature | | | turbid at room |
| | | | | | temperature |
| | | | | | within 2 hrs |
| | 12 | Room | <2 | h | Solution becomes |
| | | temperature | | | turbid at room |
| | | | | | temperature |
| | | | | | within 2 hrs |
| | 14 | Room | <30 | min | Mixture becomes |
| | | temperature | | | opaque within |
| | | | | | 30 minutes |
| | 15 | Room | <5 | min | Mixture becomes |
| | | temperature | | | opaque within |
| | | | | | 5 minutes |

| | | | |
|---|---|---|---|
| 16 | >50° C. | — | Mixture becomes |
| | | | opaque before it |
| | | | cools down to |
| | | | room temperature |

In an aspect, a significant difference is observed between cooling down these solutions of solvent-resistant polyetherimides in hot NMP in a water bath at room temperature as compared to cooling down the same solution in a water bath at 50° C. or by cooling down the same solution through contact with air at room temperature. As an example, the ULTEM™ CRS 5000 resins separate out at relatively high temperature when cooled down very slowly, i.e. the phase separation approaches a steady-state situation (as shown in FIG. 47). As a further example, the solutions are stable at room temperature (i.e. no phase separation occurs) for a significant time (depending on the composition) as described in Table DDD.

In an aspect, solutions can be prepared by placing the resin in the NMP and boiling the NMP solution for a period of time (e.g. 3-5 mins) under continuous shaking or stirring. Moisture analysis of NMP using Karl Fischer titrator shows that there is a drastic reduction in moisture content in the open system, which is explained by the fact that NMP and water do not form an azeotrope (reference Raginskaya L. M.: N-Methyl-2-Pyrrolidon—Wasser. Prom. Sint. Kaucuka (1975) 1-3) and, therefore, most of the water evaporates from the boiling NMP. No significant changes of the molecular weight of the ULTEM™ during the dissolution process were observed. GPC analyses on the ULTEM™ CRS 5000 before and after the dissolution process confirmed that the molecular weight remained constant, i.e. no polymer degradation or other polymer chain modifications took place.

In an aspect, chemical resistant, porous membranes can be prepared by dissolving 10 wt % of a solvent-resistant polyetherimides (e.g. ULTEM™ CRS 5001K) in N-methyl-2-pyrrolidone (NMP) at 200° C. in an open system followed by casting at room temperature and coagulating in a water bath. N-methyl-2-pyrrolidone (NMP) has a Health Rating of only 2 on the NFPA fire diamond (according to the Centers for Disease Control and Prevention—http://www.cdc.gov) and is, therefore, considered to be much more environmentally friendly as compared to the previously described phenol and cresol solvent systems. Additionally, as NMP is fully miscible with water, and water is a poor solvent for polyetherimides, the coagulation bath used for the phase inversion process can be based on water, optionally in combination with NMP or other solvents.

In an aspect, chemical resistant, porous membranes can be prepared by dissolving 10 wt % of a solvent-resistant polyetherimides (e.g. ULTEM™ CRS 5001K) and 10 wt % of inorganic particles in N-methyl-2-pyrrolidone (NMP) at 200° C. in an open system followed by casting at room temperature and coagulating in a water bath.

In an aspect, chemical resistant, porous membranes can be prepared by dissolving 12 wt % of a solvent-resistant polyetherimide (e.g. ULTEM™ CRS 5001K) in N-methyl-2-pyrrolidone (NMP) at 200° C. in an open system followed by casting at room temperature on top of a 8 μm thick polyethylene film and coagulating in a water bath.

### Example 30

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 15 | wt % |
| Dissolution temperature | 170° | C. |
| Casting temperature | 130° | C. |
| Wet film casting thickness | 200 | micron |
| Coagulation solvent | Water | |
| Health Rating on the NFPA fire diamond | 0 | |
| Coagulation temperature | 60° | C. |

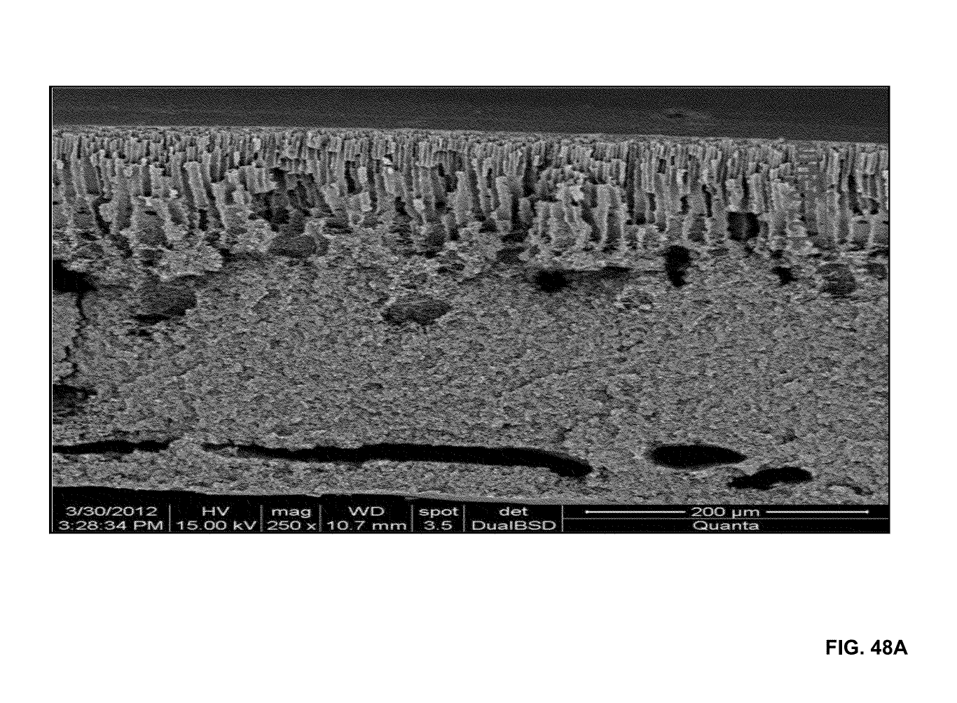

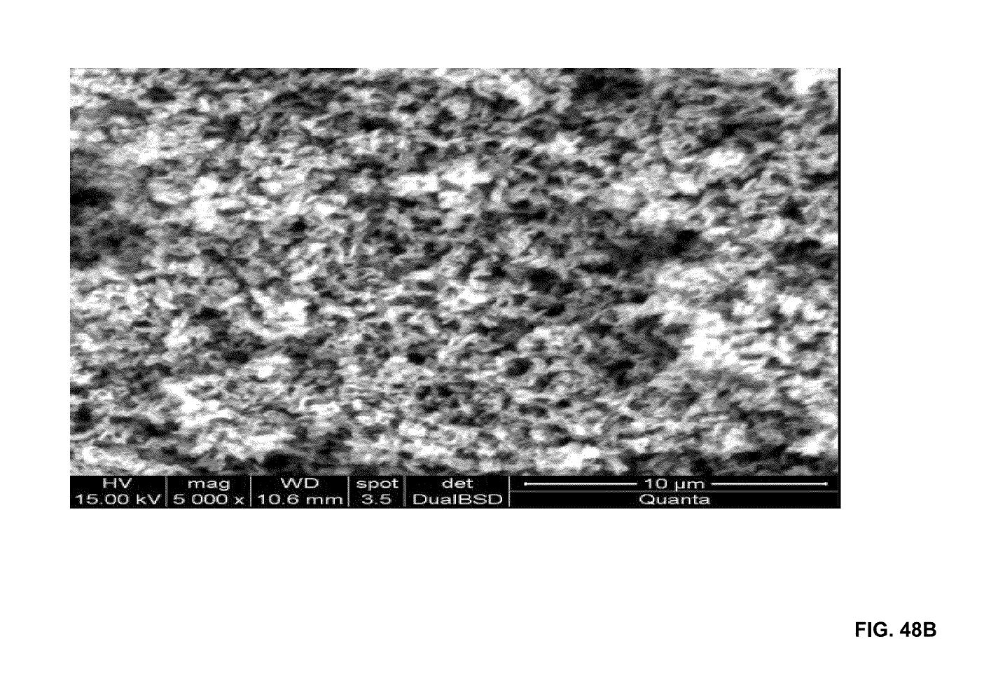

FIG. 48A is a representation of a typical morphology obtained when casting according to Example 30. FIG. 48B is a magnified representation of a typical morphology obtained when casting according to Example 30.

### Example 31

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 15 | wt % |
| Dissolution temperature | 170° | C. |
| Casting temperature | 130° | C. |
| Wet film casting thickness | 20 | micron |
| Coagulation solvent | Water | |
| Health Rating on the NFPA fire diamond | 0 | |
| Coagulation temperature | 20° | C. |

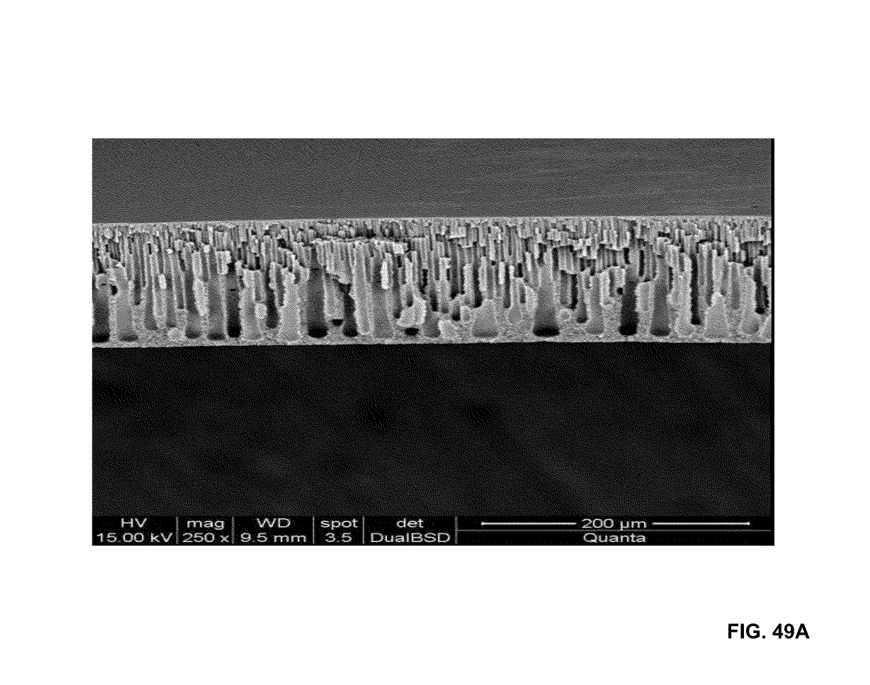

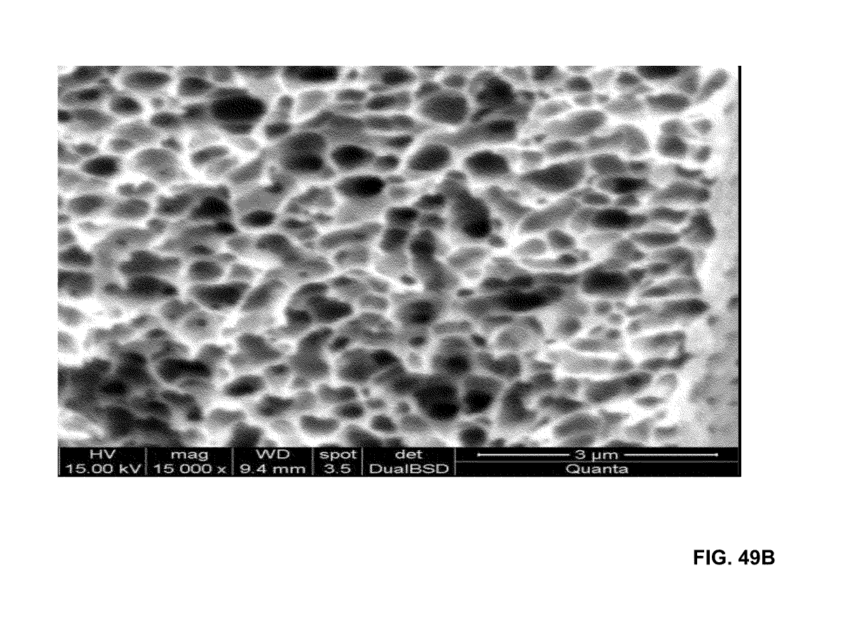

FIG. 49A is a representation of a typical morphology obtained when casting according to Example 31. FIG. 49B is a magnified representation of a typical morphology obtained when casting according to Example 31.

### Example 32

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 22 | wt % |
| Dissolution temperature | 170° | C. |
| Casting temperature | 150° | C. |
| Wet film casting thickness | 200 | micron |
| 1^{st} Coagulation solvent | Water/NMP (50/50) | |
| 1^{st} Coagulation temperature | 80° | C. |
| 1^{st} Coagulation time | 20 | min |
| 2^{nd} Coagulation solvent | Water | |
| Health Rating on the NFPA fire diamond | 0 | |
| 2^{nd} Coagulation temperature | 30° | C. |
| 2^{nd} Coagulation time | 1 | week |

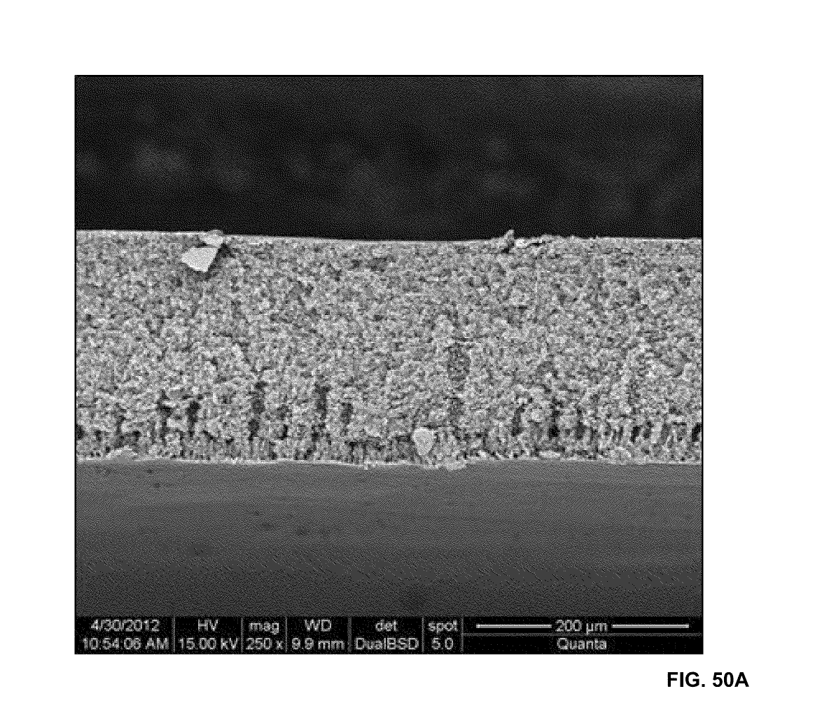

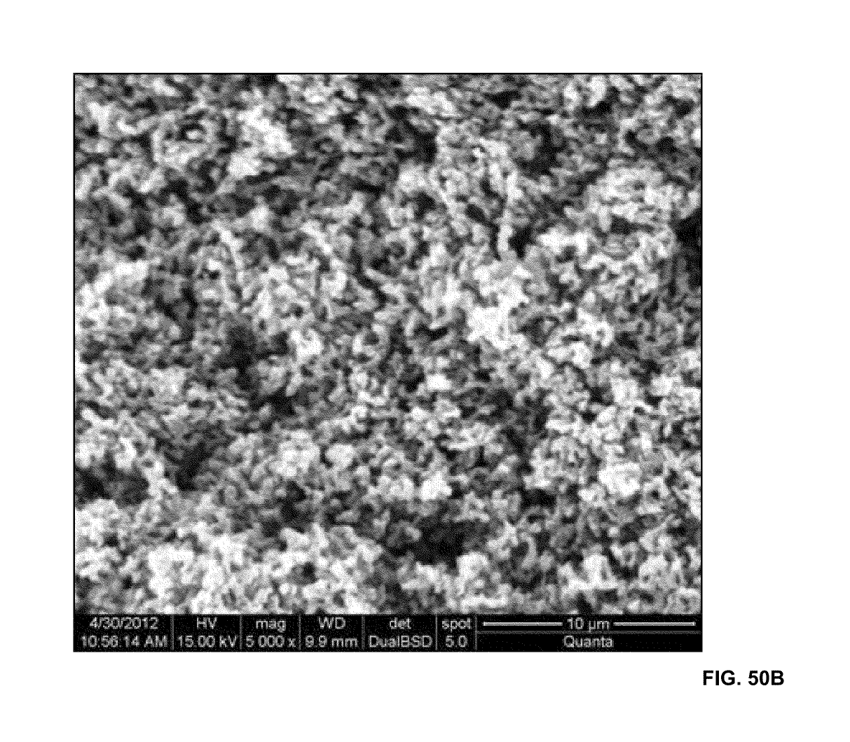

FIG. 50A is a representation of a typical morphology obtained when casting according to Example 32. FIG. 50B is a magnified representation of a typical morphology obtained when casting according to Example 32.

### Example 33

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 20 | wt % |
| Dissolution temperature | 170° | C. |
| Casting temperature | 150° | C. |
| Wet film casting thickness | 200 | micron |
| Coagulation solvent | Water/NMP (50/50) | |
| Health Rating on the NFPA fire diamond | 2 | |
| Coagulation temperature | 150° C. at onset of | |
| | coagulation, subsequent | |
| | slow cooling to 30° C. | |
| Coagulation time | 1 | week |

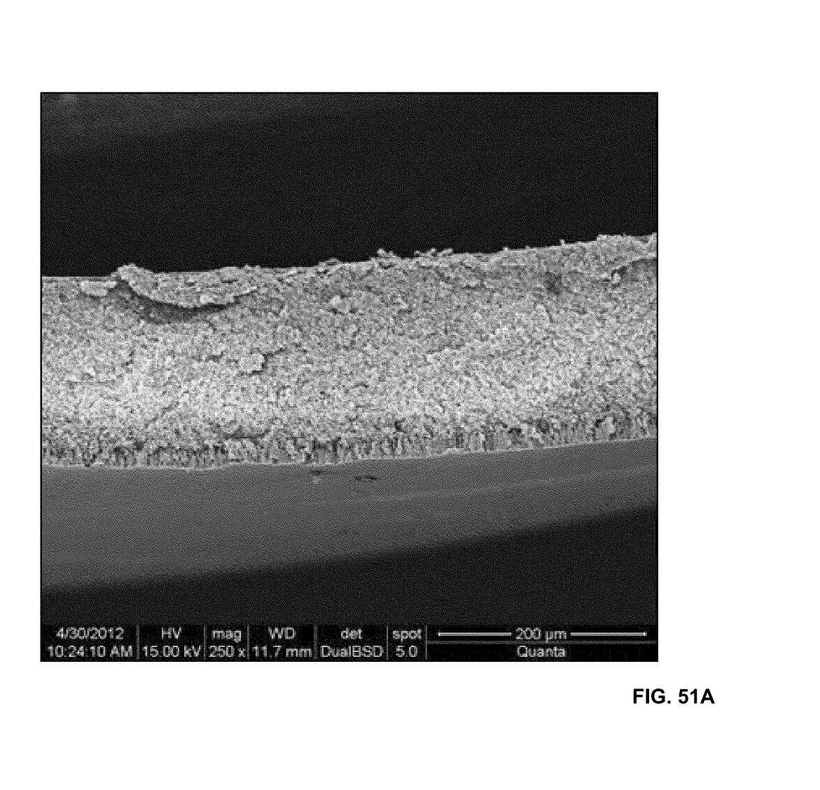

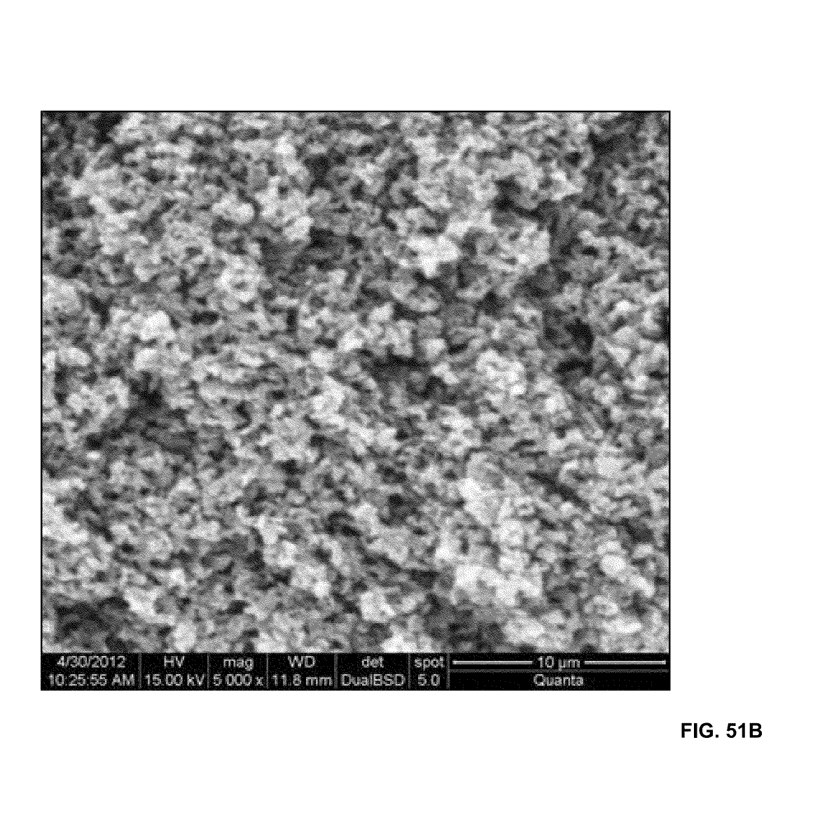

FIG. 51A is a representation of a typical morphology obtained when casting according to Example 33. FIG. 51B is a magnified representation of a typical morphology obtained when casting according to Example 33.

### Example 34

### Membrane Casting Conditions

| Polymer | ULTEM ™ CRS 5011K | |
|---|---|---|
| Solvent | N-methylpyrrolidone | |
| Health Rating on the NFPA fire diamond | 2 | |
| Polymer concentration | 15 | wt % |
| Dissolution temperature | 202° | C. |
| Casting temperature | 30° | C. |
| Wet film casting thickness | 100 | micron |
| Coagulation solvent | Water | |
| Health Rating on the NFPA fire diamond | 0 | |
| Coagulation temperature | 30° | C. |
| Coagulation time | 1 | week |

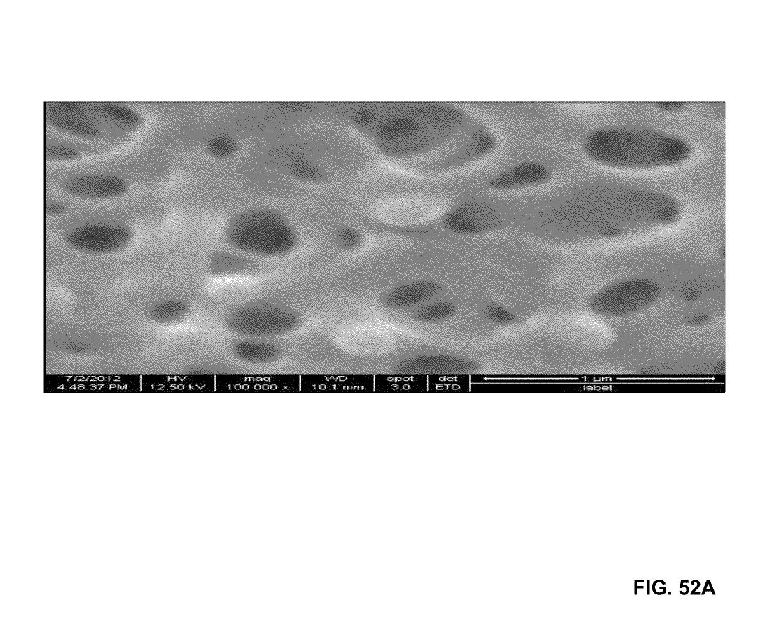

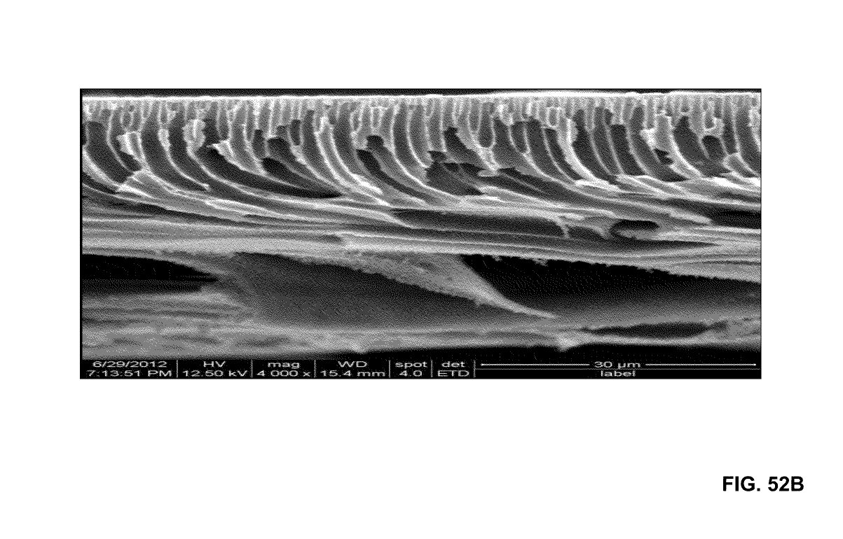

FIG. 52A is a bottom side representation of a typical morphology obtained when casting according to Example 34. FIG. 52B is a cross-sectional representation of a typical morphology obtained when casting according to Example 34.

### Example 35

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 15 | wt % |
| Dissolution temperature | 202° | C. |
| Casting temperature | 30° | C. |
| Wet film casting thickness | 250 | micron |
| Coagulation solvent | Water | |
| Health Rating on the NFPA fire diamond | 0 | |
| Coagulation temperature | 30° | C. |
| Coagulation time | 1 | week |

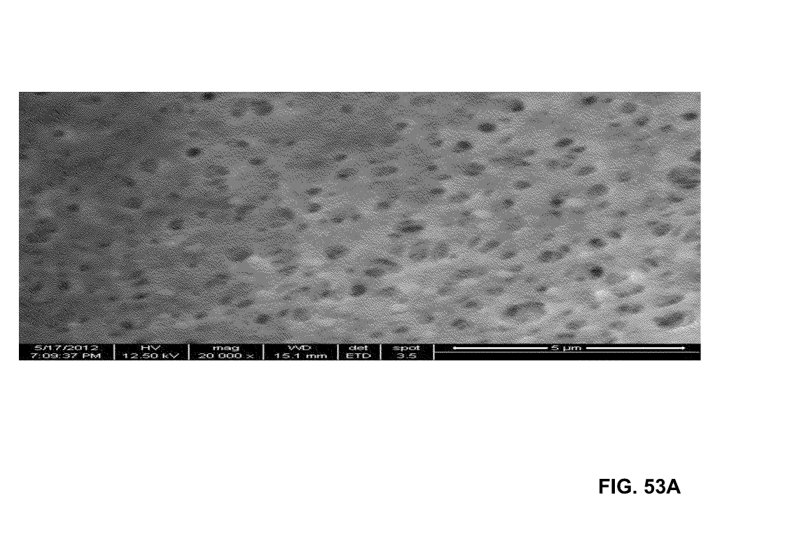

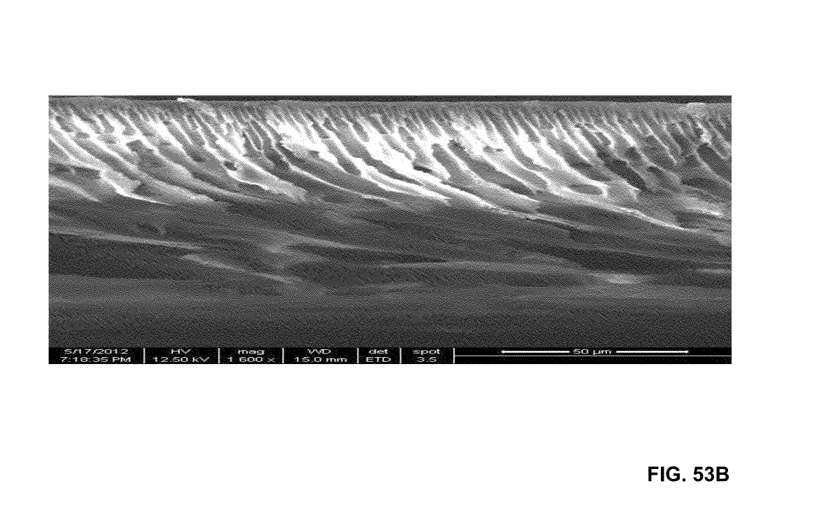

FIG. 53A is a bottom side representation of a typical morphology obtained when casting according to Example 35. FIG. 53B is a cross-sectional representation of a typical morphology obtained when casting according to Example 35.

### Example 36

### Membrane Casting Conditions

| Polymer | ULTEM ™ CRS 5011K | |
|---|---|---|
| Solvent | N-methylpyrrolidone | |
| Health Rating on the NFPA fire diamond | 2 | |
| Polymer concentration | 13 | wt % |
| Dissolution temperature | 202° | C. |
| Casting temperature | 30° | C. |
| Wet film casting thickness | 100 | micron |
| Coagulation solvent | Isopropanol | |
| Health Rating on the NFPA fire diamond | 1 | |
| Coagulation temperature | 30° | C. |
| Coagulation time | 24 | hrs |

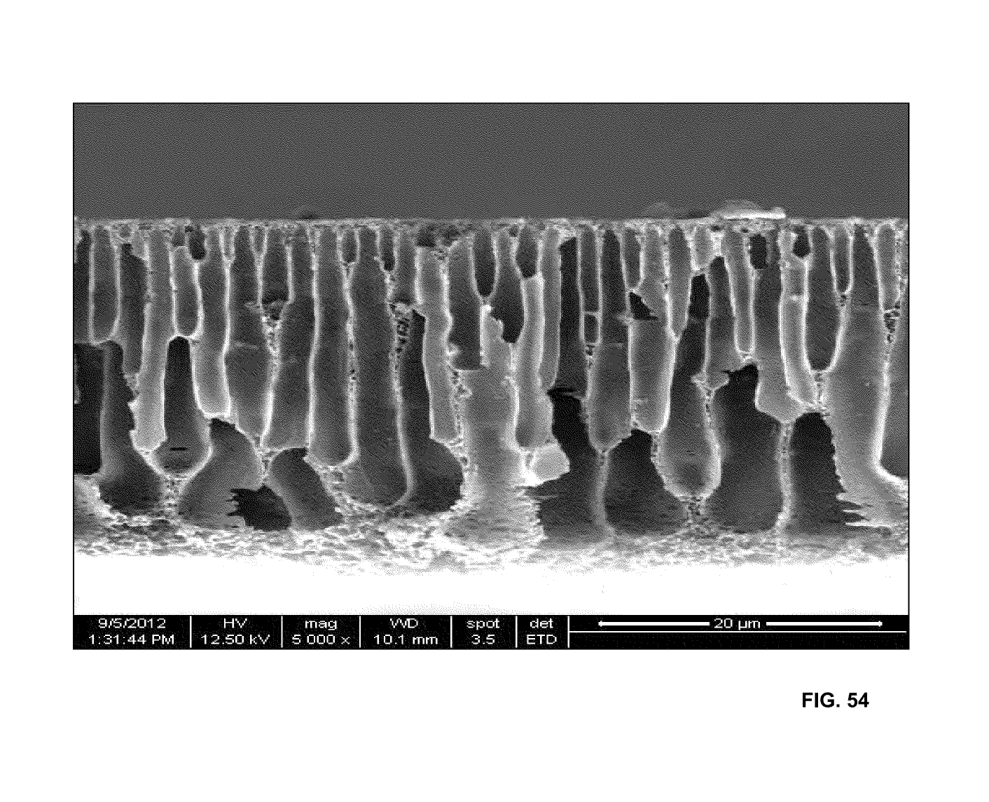

FIG. 54 is a cross-sectional representation of a typical morphology obtained when casting according to Example 36.

### Example 37

### Membrane Casting Conditions

| Polymer | ULTEM ™ CRS 5011K | |
|---|---|---|
| Solvent | N-methylpyrrolidone | |
| Health Rating on the NFPA fire diamond | 2 | |
| Polymer concentration | 13 | wt % |
| Dissolution temperature | 202° | C. |
| Casting temperature | 30° | C. |
| Wet film casting thickness | 100 | micron |
| Coagulation solvent | NMP/water (75/25) | |
| Health Rating on the NFPA fire diamond | 2 | |
| Coagulation temperature | 30° | C. |
| Coagulation time | 24 | hrs |

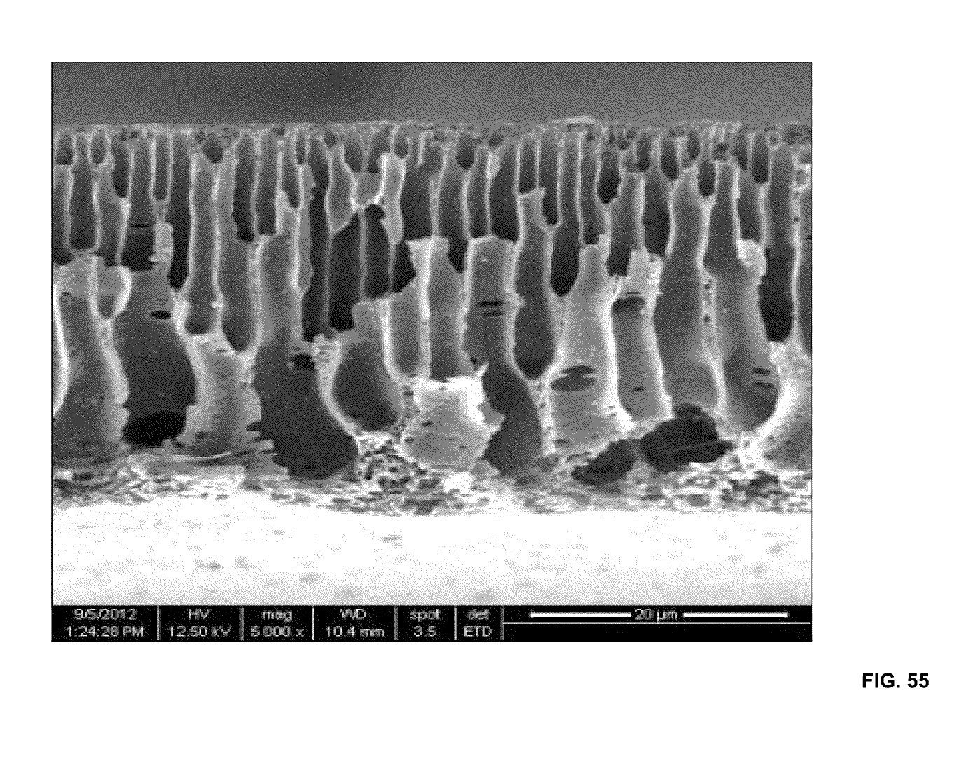

FIG. 55 is a cross-sectional representation of a typical morphology obtained when casting according to Example 37.

### Example 38

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 16 | wt % |
| Dissolution temperature | 202° | C. |
| Casting temperature | 150° | C. |
| Wet film casting thickness | 150 | micron |
| Coagulation solvent | Water | |
| Health Rating on the NFPA fire diamond | 0 | |
| Coagulation temperature | 20° | C. |

| | |
|---|---|
| Rinsing bath | Methanol |

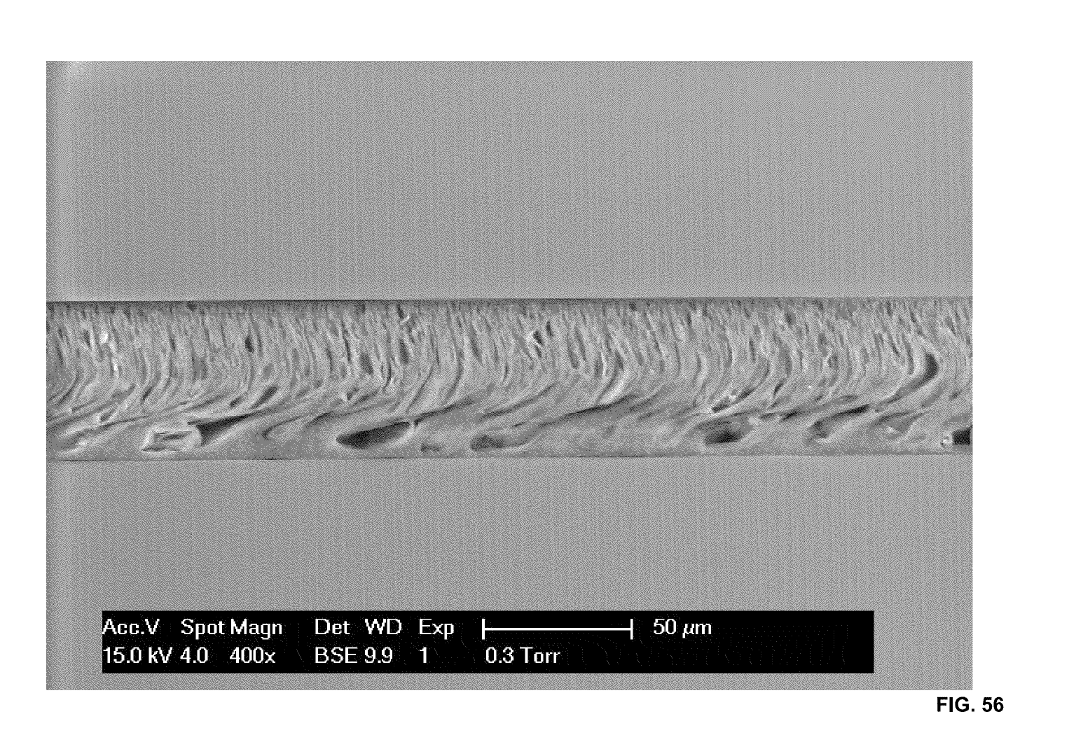

FIG. 56 is a representation of a typical morphology obtained when casting according to Example 38.

### Example 39

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 16 | wt % |
| Dissolution temperature | 202° | C. |
| Casting temperature | 30° | C. |
| Wet film casting thickness | 150 | micron |
| Coagulation solvent | Water | |
| Health Rating on the NFPA fire diamond | 0 | |
| Coagulation temperature | 20° | C. |

| | |
|---|---|
| Rinsing bath | Methanol |

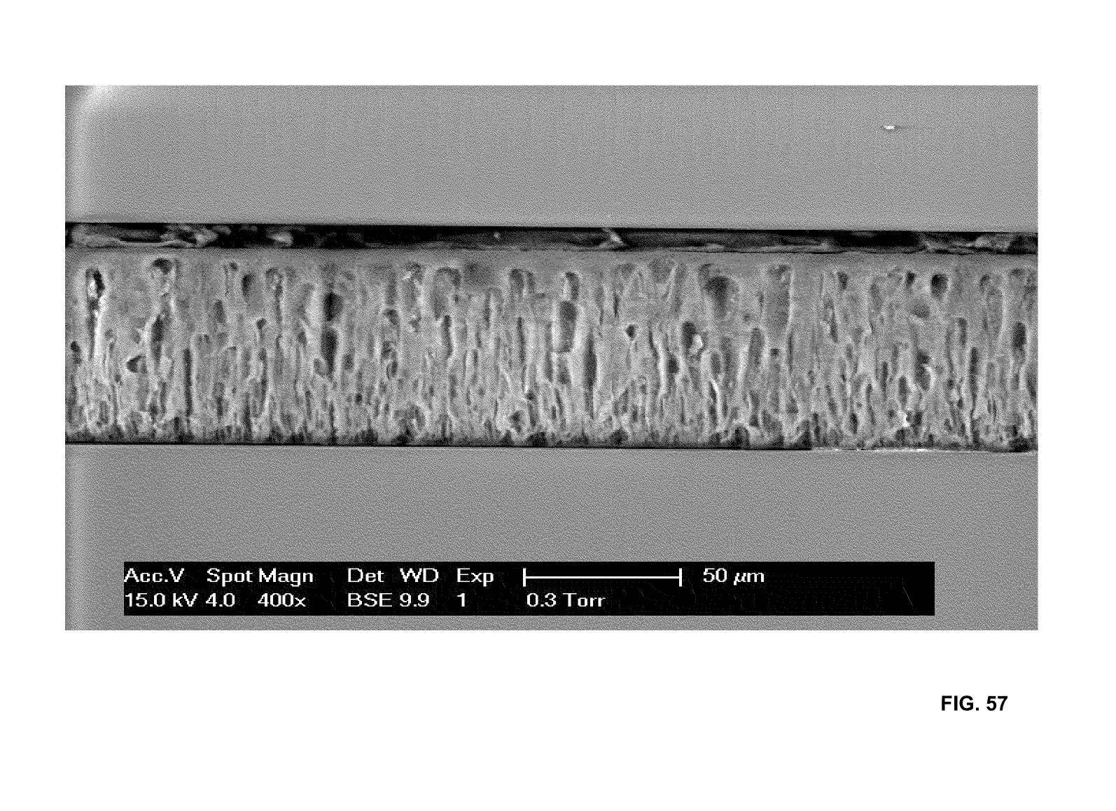

FIG. 57 is a representation of a typical morphology obtained when casting according to Example 39.

### Example 40

### Membrane Casting Conditions

| Polymer | ULTEM ™ CRS 5001K | |
|---|---|---|
| Solvent | N-methylpyrrolidone | |
| Substrate | Micro-porous polyethylene | |
| | (8 micron thick) | |
| Health Rating on the NFPA fire diamond | 2 | |
| Polymer concentration | 12 | wt % |
| Dissolution temperature | 202° | C. |
| Casting temperature | 25° | C. |
| Wet film casting thickness | 150 | micron |
| Coagulation solvent | Water | |
| Health Rating on the NFPA fire diamond | 0 | |
| Coagulation temperature | 20° | C. |

| | |
|---|---|
| Rinsing bath | Methanol |

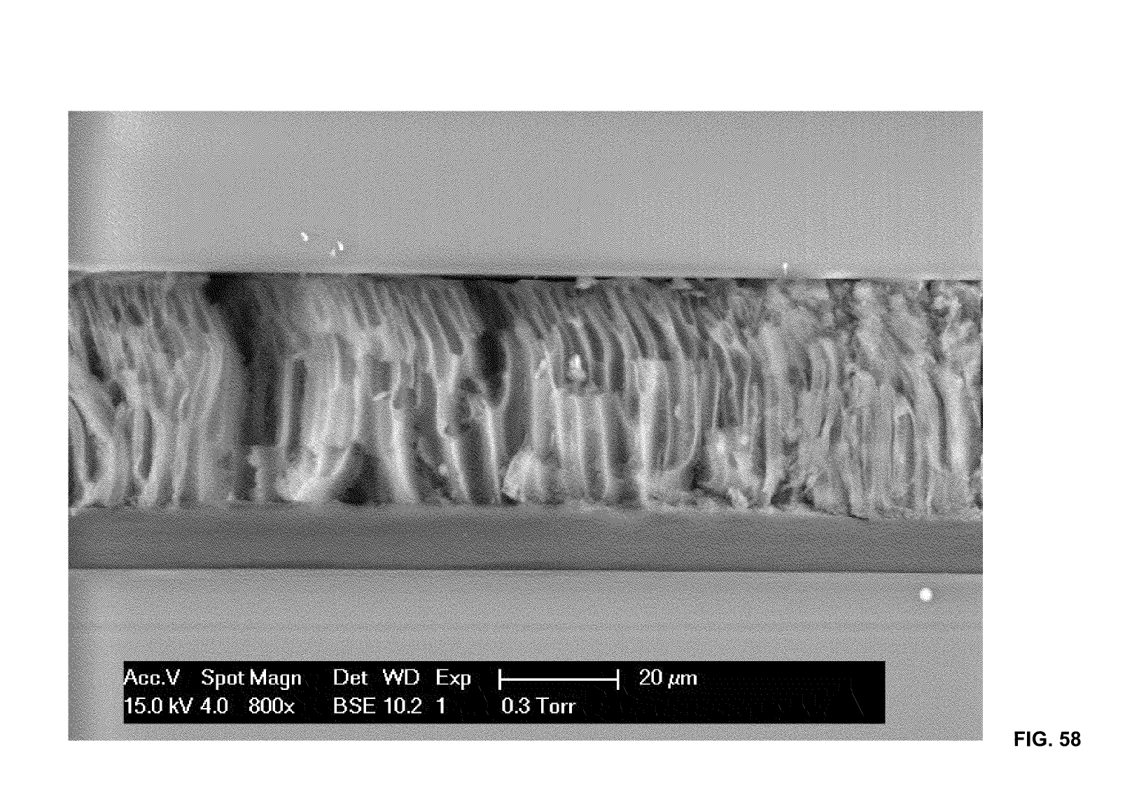

FIG. 58 is a representation of a typical morphology obtained when casting according to Example 40.

### Example 42

### Membrane Casting Conditions

| Polymer | ULTEM ™ CRS 5001K | |
|---|---|---|
| Inorganic Particles | Magnesium Oxide (MgO) | |
| Solvent | N-methylpyrrolidone | |
| Health Rating on the NFPA fire diamond | 2 | |
| Polymer concentration | 10 | wt % |
| Inorganic Particles concentration | 10 | wt % |
| Dissolution temperature | 202° | C. |
| Casting temperature | 25° | C. |
| Wet film casting thickness | 150 | micron |
| Coagulation solvent | Water | |
| Health Rating on the NFPA fire diamond | 0 | |
| Coagulation temperature | 20° | C. |

| | |
|---|---|
| Rinsing bath | Methanol |

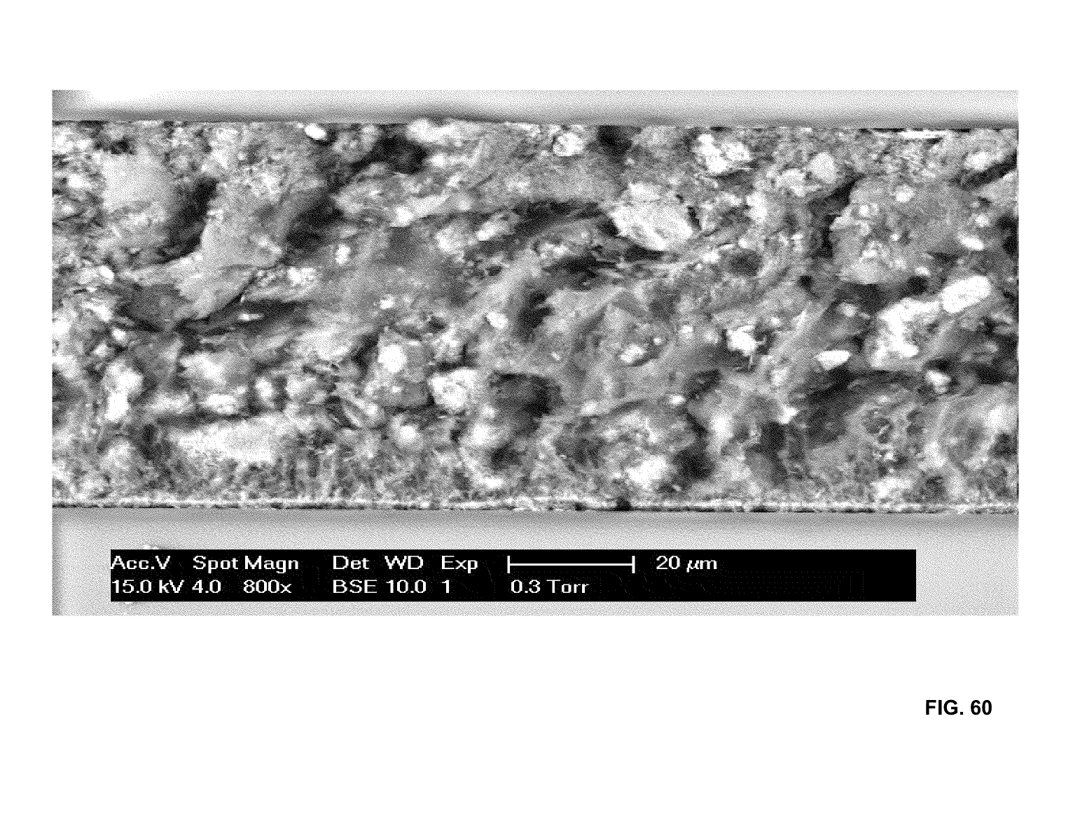

FIG. 60 is a representation of a typical morphology obtained when casting according to Example 42.

### Example 43

### Membrane Casting Conditions

| Polymer | ULTEM ™ CRS 5001K | |
|---|---|---|
| Inorganic Particles | Titanium oxide (TiO2) | |
| Solvent | N-methylpyrrolidone | |
| Health Rating on the NFPA fire diamond | 2 | |
| Polymer concentration | 10 | wt % |
| Inorganic Particles concentration | 10 | wt % |
| Dissolution temperature | 202° | C. |
| Casting temperature | 25° | C. |
| Wet film casting thickness | 150 | micron |
| Coagulation solvent | Water | |
| Health Rating on the NFPA fire diamond | 0 | |
| Coagulation temperature | 20° | C. |

| | |
|---|---|
| Rinsing bath | Methanol |

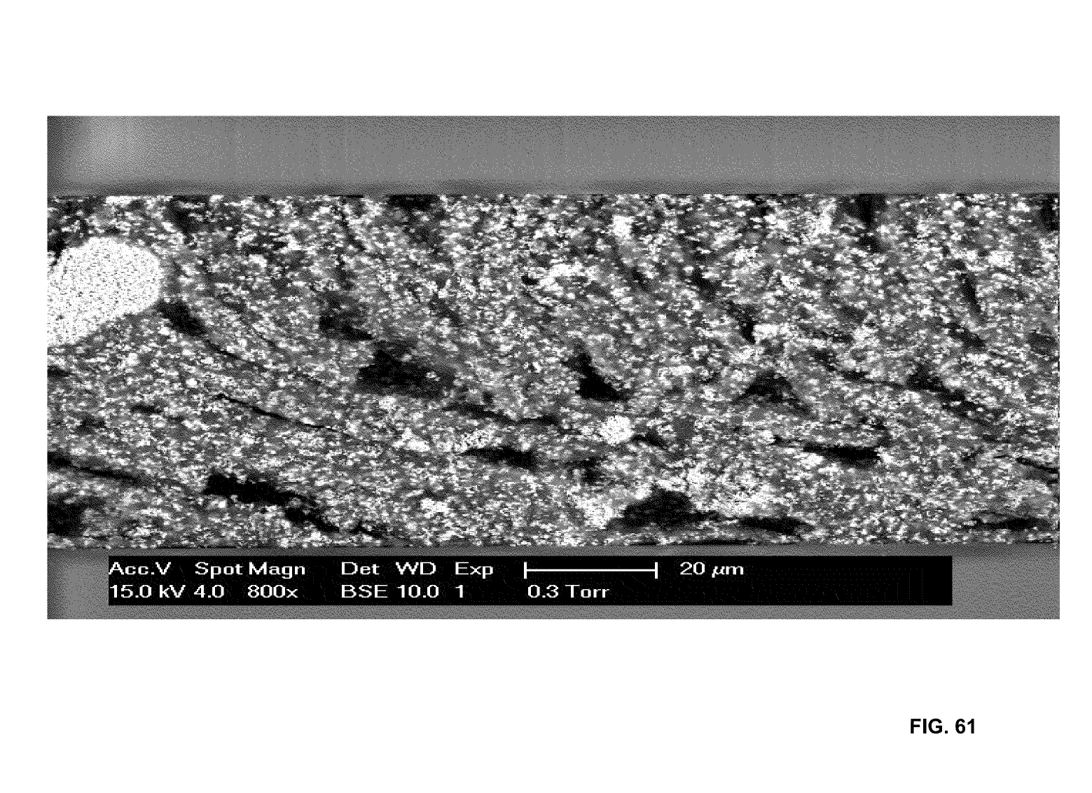

FIG. 61 is a representation of a typical morphology obtained when casting according to Example 43.

### Example 44

### Membrane Casting Conditions

| Polymer | ULTEM ™ CRS 5001K | |
|---|---|---|
| Solvent | N-methylpyrrolidone | |
| Health Rating on the NFPA fire diamond | 2 | |
| Polymer concentration | 8 | wt % |
| Dissolution temperature | 202° | C. |
| Casting temperature | 25° | C. |
| Wet film casting thickness | 150 | micron |
| 1^{st} Coagulation solvent | Water (vapor) | |
| 1^{st} Coagulation temperature | 100° | C. |
| 1^{st} Coagulation time | 90 | mins |
| Health Rating on the NFPA fire diamond | 0 | |
| 2^{nd} Coagulation solvent | Water (liquid) | |
| 2^{nd} Coagulation temperature | Room temperature | |
| 2^{nd} Coagulation time | 24 | hrs |

| | |
|---|---|
| Rinsing bath | Methanol |

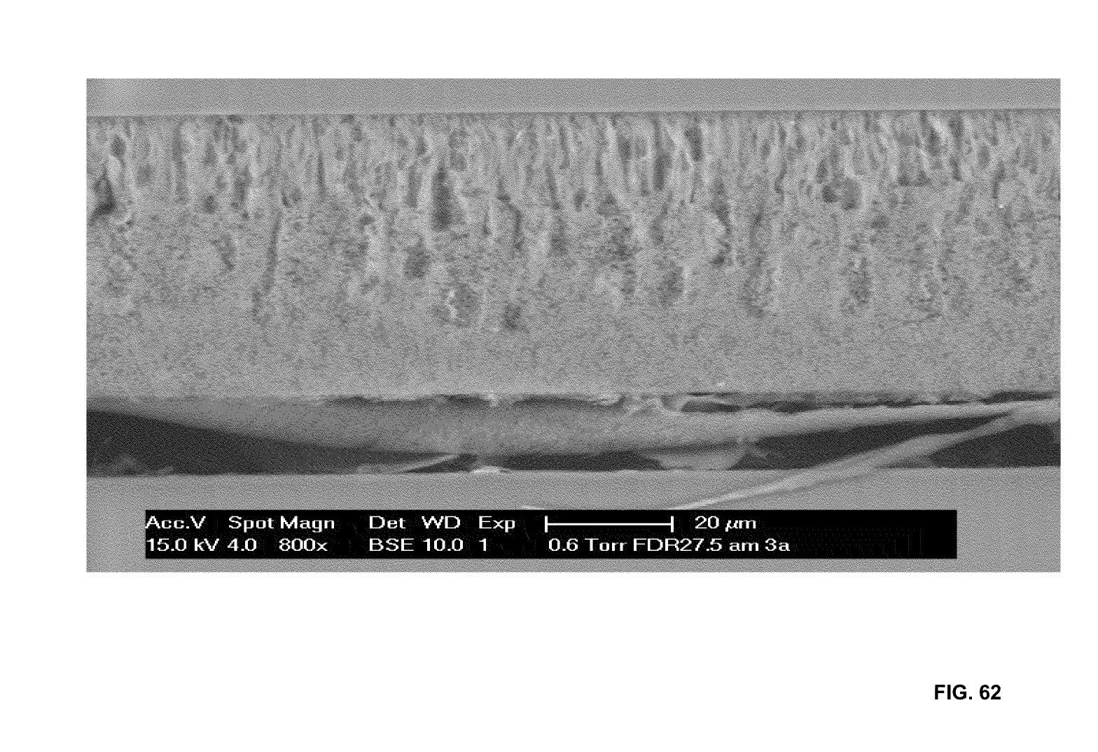

FIG. 62 is a representation of a typical morphology obtained when casting according to Example 44.

### Example 45

### Membrane Casting Conditions

| Polymer | ULTEM ™ CRS 5011K | |
|---|---|---|
| Solvent | N-methylpyrrolidone | |
| Health Rating on the NFPA fire diamond | 2 | |
| Polymer concentration | 13 | wt % |
| Dissolution temperature | 202° | C. |
| Casting temperature | 30° | C. |
| Wet film casting thickness | 100 | micron |
| Coagulation solvent | NMP/water (50/50) | |
| Health Rating on the NFPA fire diamond | 2 | |
| Coagulation temperature | 30° | C. |
| Coagulation time | 24 | hrs |

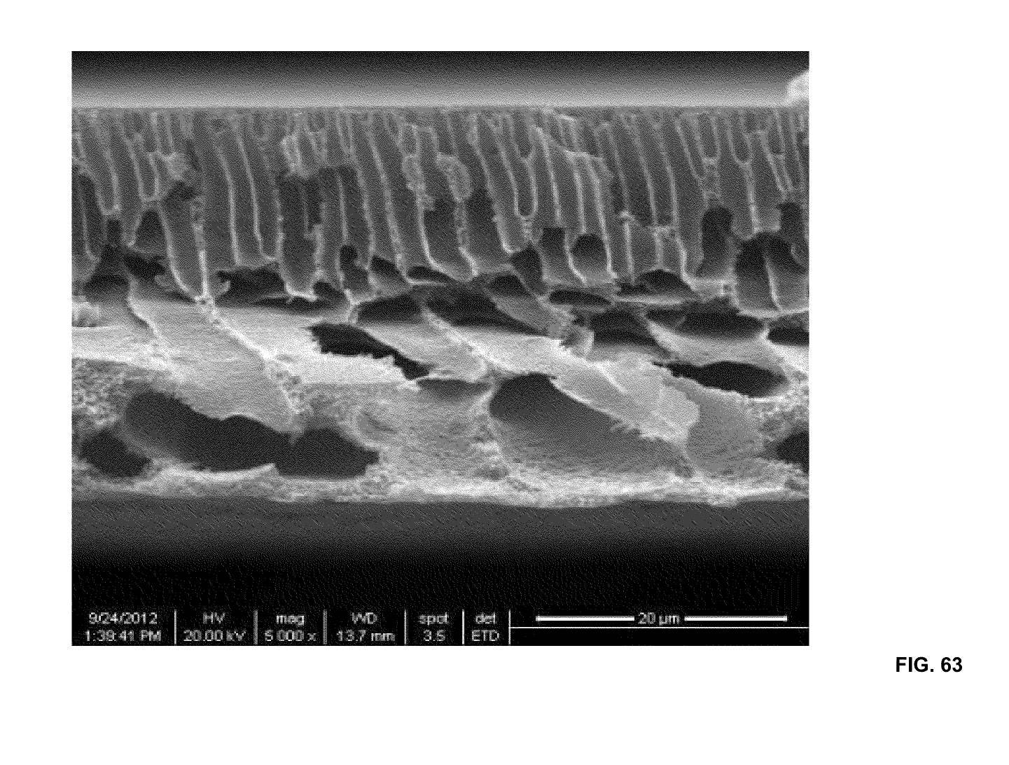

FIG. 63 is a cross-sectional representation of a typical morphology obtained when casting according to Example 45.

### Example 46

### Membrane Casting Conditions

| Polymer | ULTEM ™ CRS 5011K | |
|---|---|---|
| Solvent | N-methylpyrrolidone | |
| Health Rating on the NFPA fire diamond | 2 | |
| Polymer concentration | 13 | wt % |
| Dissolution temperature | 202° | C. |
| Casting temperature | 30° | C. |
| Wet film casting thickness | 100 | micron |
| Coagulation solvent | NMP/water (25/75) | |
| Health Rating on the NFPA fire diamond | 2 | |
| Coagulation temperature | 30° | C. |
| Coagulation time | 24 | hrs |

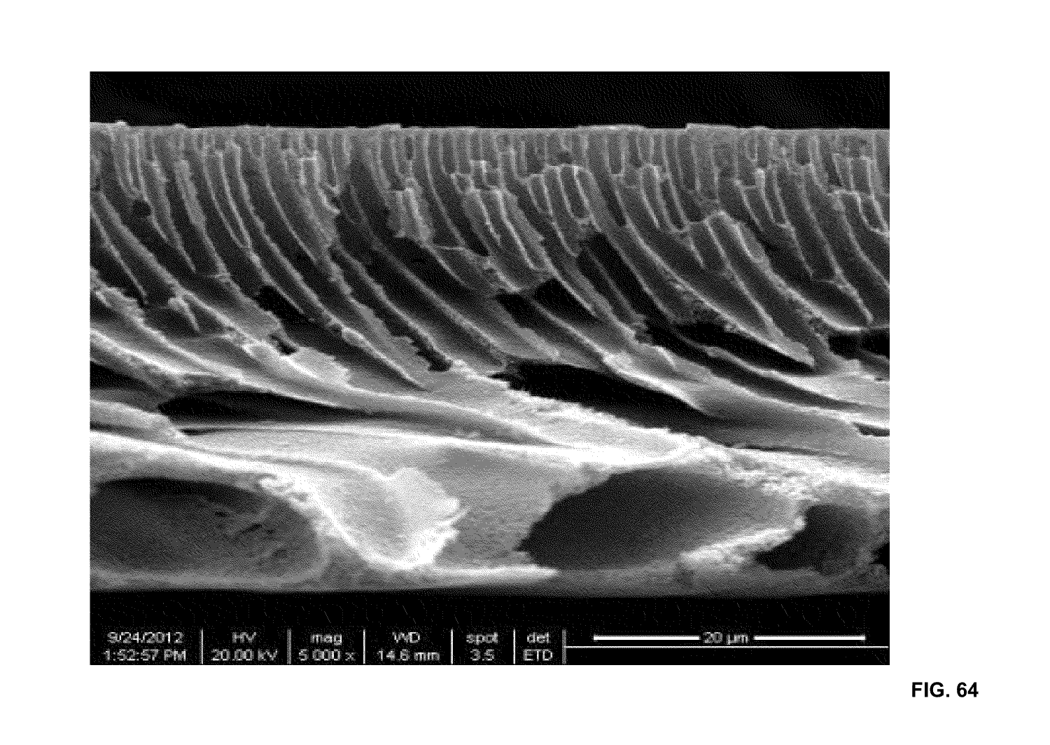

FIG. 64 is a cross-sectional representation of a typical morphology obtained when casting according to Example 46.

Air permeability measurements (Gurley densometer, JIPS 8117 (2009) —Determination of air Permeance and air resistance (medium large) —Gurley Method) were performed on ULTEM™ CRS 5011K separators coagulated in various water/NMP liquid mixtures, as well as water vapor. Air permeability is measured in Gurley seconds and is generally accepted to be directly linked to ionic conductivity of separators in an electrochemical cell environment. High Gurley values indicate a low air transport through the membrane, which typically translate into a low ionic conductivity. As an example, the measured ULTEM™ CRS 5011K separators made by using a liquid water/NMP coagulation bath showed Gurley numbers ranging from 12 to 544 seconds, which indicates that the ionic conductivity of the membranes can be widely varied depending on the casting conditions. Similarly, the ULTEM™ CRS 5001K separator made by using vapor water coagulation showed a Gurley number of 38 seconds. These results show that these novel materials have Gurley numbers similar to or better than commercial polyolefin separators such as Celgard® 2320, 2400, 2340 and 2500 as well as Tonen V25CGD and V25EKD, which have Gurley numbers of 586, 620, 846, 217, 191 and 293, respectively.

TABLE DDD
Air permeability (Gurley) values of ULTEM ™ CRS
5011K separators prepared under various conditions.

| | | Dope | Coagulation bath | | Thick- |
|---|---|---|---|---|---|
| | Dope | Concen- | composition | Gurley | ness |
| Example | solution | tration | NMP/water | (s) | (μm) |
| Example | ULTEM ™ | 8 wt % | 0/100 (vapor) | 38 | 38 |
| 44 | CRS | | | | |
| | 5001K/NMP | | | | |
| Example | ULTEM ™ | 13 wt % | 75/25 | 12 | 27 |
| 37 | CRS | | | | |
| Example | 5011K/NMP | | 50/50 | 82 | 42 |
| 45 | | | | | |
| Example | | | 25/75 | 544 | 42 |
| 46 | | | | | |

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
an anode;
a cathode;
a separator disposed between the anode and the cathode, the separator formed from a thermoplastic polymer having a glass transition temperature equal to or higher than about 180° C.; and
an electrolyte solution disposed adjacent the separator, wherein the thermoplastic polymer does not significantly dissolve in an electrolyte solution and the thermoplastic has an electrolyte contact angle equal to or lower than about 30°.

2. The system of claim 1, wherein the electrolyte comprises one of about 0 wt % to about 50 wt % ethyl carbonate of the total solvent composition; about 0 wt % to about 80 wt % dimethyl carbonate of the total solvent composition; and about 0 wt % to about 80 wt % ethyl methyl carbonate of the total solvent composition.

3. The system of claim 1, wherein the separator has an electrolyte contact angle equal to or lower than 20°.

4. The system of claim 1, wherein the separator has a deformation temperature exceeding 180° C.

5. The system of claim 1, wherein the separator is formed from polyetherimides (PEI) comprising structural units derived from at least one diamine selected from 1,3-diaminobenzene, 1,4-diaminobenzene, 4,4′-diaminodiphenyl sulfone, oxydianiline, 1,3-bis(4-aminophenoxy)benzene, or combinations thereof.

6. A method for preparing a porous film, the method comprising:
providing a pourable, polymer solution comprising a thermoplastic polymer in a solvent wherein the polymer is chemically resistant to the electrolyte solution, the polymer having a normalized dry weight equal to or higher than 90%; and
forming a porous film from the polymer solution.

7. The method of claim 6, wherein the chemical resistant polymer has a weight to volume concentration from 5% to about 30% in the solvent.

8. The method of claim 6, wherein the polymer solution comprises inorganic particles.

9. The method of claim 6, wherein the polymer comprises a polyetherimide, polyketone, polyester, poly(4-methyl pentene), polyphenylene ether or a polyphenylene sulfide, or a combination thereof.

10. The method of claim 6, wherein the solvent comprises a phenolic solvent, 4-chloro-3-methyl-phenol, 4-chloro-2-methyl-phenol, 2,4-dichloro-6-methyl-phenol, 2,4-dichloro-phenol, 2,6-dichloro-phenol, 4-chloro-phenol, 2-chloro-phenol, o-cresol, m-cresol, p-cresol, 4-methoxy-phenol, catechol, benzoquinone, 2,3-xylenol, 2,6-xylenol or resorcinol, or a combination thereof.

11. The method of claim 6, wherein forming a porous film from the polymer solution comprises casting a wet, thin film from the polymer solution and immersing the wet, thin film in a coagulation bath comprising a non-solvent to the polymer to provide a coagulated polymer film, followed by removing the solvents from the coagulated polymer film; or exposing the wet, shaped polymer solution to a vapor of the non-solvent to the polymer, followed by removing the solvents from the coagulated polymer film.

12. The method of claim 6, further comprising forming a multilayer structure comprising the porous film disposed as a substrate of the multilayer structure.

13. A method for preparing a solvent resistant polymeric membrane, the method comprising:
providing a pourable, polymer solution comprising a polymer in a solvent, wherein the polymer is chemically resistant to the electrolyte solution, the polymer having a normalized dry weight equal to or higher than 90%; and wherein the solvent has a Health Rating of 2 or lower on the NFPA fire diamond; and
forming a membrane from the polymer solution.

14. The method of claim 13, wherein the polymer comprises a polyetherimide or a polyphenylene ether, or a combination thereof.

15. The method of claim 14, wherein the polyetherimide comprises structural units derived from at least one diamine selected from 1,3-diaminobenzene, 1,4-diaminobenzene, 4,4′-diaminodiphenyl sulfone, oxydianiline, 1,3-bis(4-aminophenoxy)benzene, or combinations thereof.

16. The method of claim 13, wherein the polymer solution comprises inorganic particles.

17. The method of claim 13, wherein the solvent comprises a pyrrolidone-based solvent including one or more of 2-pyrrolidone, 1-ethyl-2-pyrrolidone, 1-cyclohexyl-2-pyrrolidone, 1-(2-hydroxyethyl)-2-pyrrolidone, 1-octyl-2-pyrrolidone, 1-N-ethoxycarbonyl-3-pyrrolidone, N-methyl-2-pyrrolidone, and 1-vinyl-2-pyrrolidone.

18. The method of claim 13, wherein forming a membrane from the polymer solution comprises one or more of casting a wet, thin film from the polymer solution; and immersing the wet, shaped polymer solution in a coagulation bath comprising a non-solvent to the polymer to provide a coagulated polymer film, followed by removing the solvents from the coagulated polymer film; or exposing the wet, shaped polymer solution to a vapor of the non-solvent to the polymer, followed by removing the solvents from the coagulated polymer film.

19. The method of claim 18, wherein the non-solvent comprises water, a pyrrolidone-based solvent, a phenolic-based solvent, acetone, methanol, ethanol, butanol, isopropanol, tetrahydrofuran, dichloromethane, ethyl acetate, methyl acetate, toluene, hexane, cyclohexane, pentane, cyclopentane, benzene, chloroform, diethyl ether, dimethyl acetate, ethylene dichloride, dimethyl sulfoxide, acetonitrile, propylene carbonate, anisole, 1,2-dichlorobenzene, xylene, hexafluorisopropanol, dichloromethane, tetrafluoroacetate, tetrachloroethane, 1,3-dimethyl-2-imidazolidinone, or a combination thereof.

20. The method of claim 13, wherein providing a pourable, polymer solution comprises dissolving the polyphenylene ether or polyetherimide in N-methylpyrrolidone (NMP) at elevated temperatures in one of an open system or a closed system.
